(19) United States
(12) Patent Application Publication
(10) Pub. No.: US 2025/0031268 A1
(43) Pub. Date: Jan. 23, 2025

(54) INACTIVE USER EQUIPMENT OPERATIONS FOR NON-TERRESTRIAL NETWORKS

(71) Applicant: QUALCOMM Incorporated, San Diego, CA (US)

(72) Inventors: Toru UCHINO, Zushi-shi (JP); Bharat SHRESTHA, San Diego, CA (US); Umesh PHUYAL, San Diego, CA (US); Masato KITAZOE, Hachiouji-shi (JP); Alberto RICO ALVARINO, San Diego, CA (US); Prasad Reddy KADIRI, San Diego, CA (US); Geetha Priya RAJENDRAN, Bangalore (IN)

(21) Appl. No.: 18/356,952

(22) Filed: Jul. 21, 2023

(51) Int. Cl. H04W 76/27; H04W 40/34

(52) U.S. Cl. CPC H04W 76/27; H04W 40/34; H04W 84/06

(57) ABSTRACT

Various aspects of the present disclosure generally relate to wireless communication. In some aspects, an apparatus may communicate with a user equipment (UE) during an active state of the UE in accordance with a first UE configuration. The apparatus may perform, associated with a second network node and based on a determination to switch the UE to an inactive state, an access stratum (AS) context relocation operation and a path switch operation associated with the second network node. Numerous other aspects are described.

### INTRODUCTION

Aspects of the present disclosure generally relate to wireless communication and to techniques and apparatuses for non-terrestrial network operations.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus at a first network node. The method may include communicating with a user equipment (UE) during an active state of the UE in accordance with a first UE configuration. The method may include performing, associated with a second network node and based on a determination to switch the UE to an inactive state, an access stratum (AS) context relocation operation and a path switch operation associated with the second network node.

Some aspects described herein relate to a method of wireless communication performed by an apparatus at a second network node. The method may include performing, associated with a first network node and based on a determination to switch a connected UE to an inactive state, an AS context relocation operation and a path switch operation associated with the second network node. The method may include communicating with the UE based on the AS context relocation operation and the path switch operation.

Some aspects described herein relate to a method of wireless communication performed by an apparatus at a UE. The method may include communicating with a first network node during an active state of the UE in accordance with a first UE configuration. The method may include performing, associated with a second network node and based on an AS context relocation operation and a path switch operation associated with a second network node, a UE resume operation to connect to the second network node.

Some aspects described herein relate to a method of wireless communication performed by an apparatus at a core network. The method may include obtaining, from a first network node and associated with a UE, a path switch request message associated with a path switch operation. The method may include performing, based on the path switch request message, the path switch operation in association with a second network node.

Some aspects described herein relate to a method of wireless communication performed by an apparatus at a first network node. The method may include communicating with a UE during an active state of the UE in accordance with a first UE configuration, wherein the first network node comprises a first non-terrestrial network (NTN) network node. The method may include performing, associated with a second NTN network node and based on a determination that the first NTN is moving out of a radio access network (RAN) notification area (RNA), an AS context relocation operation associated with the second NTN network node.

Some aspects described herein relate to a method of wireless communication performed by an apparatus at a second network node. The method may include performing, associated with a first NTN network node and based on a determination that the first NTN is moving out of an RNA, an AS context relocation operation associated with the second network node, the second network node comprising a second NTN network node. The method may include communicating, based on the AS context relocation operation, with at least one of a UE or a third NTN network node.

Some aspects described herein relate to an apparatus for wireless communication at first network node. The apparatus may include one or more memories and one or more processors coupled to the one or more memories. The one or more processors may be individually or collectively configured to cause the first network node to communicate with a UE during an active state of the UE in accordance with a first UE configuration. The one or more processors may be individually or collectively configured to cause the first network node to perform, associated with a second network node and based on a determination to switch the UE to an inactive state, an AS context relocation operation and a path switch operation associated with the second network node.

Some aspects described herein relate to an apparatus for wireless communication at a second network node. The apparatus may include one or more memories and one or more processors coupled to the one or more memories. The one or more processors may be individually or collectively configured to cause the second network node to perform, associated with a first network node and based on a determination to switch a connected UE to an inactive state, an AS context relocation operation and a path switch operation associated with the second network node. The one or more processors may be individually or collectively configured to cause the second network node to communicate with the UE based on the AS context relocation operation and the path switch operation.

Some aspects described herein relate to an apparatus for wireless communication at a UE. The apparatus may include one or more memories and one or more processors coupled to the one or more memories. The one or more processors may be individually or collectively configured to cause the UE to communicate with a first network node during an active state of the UE in accordance with a first UE configuration. The one or more processors may be individually or collectively configured to cause the UE to perform, associated with a second network node and based on an AS context relocation operation and a path switch operation associated with a second network node, a UE resume operation to connect to the second network node.

Some aspects described herein relate to an apparatus for wireless communication at a core network. The apparatus may include one or more memories and one or more processors coupled to the one or more memories. The one or more processors may be individually or collectively configured to cause the core network to obtain, from a first network node and associated with a UE, a path switch request message associated with a path switch operation. The one or more processors may be individually or collectively configured to cause the core network to perform, based on the path switch request message, the path switch operation in association with a second network node.

Some aspects described herein relate to an apparatus for wireless communication at a first network node. The apparatus may include one or more memories and one or more processors coupled to the one or more memories. The one or more processors may be individually or collectively configured to cause the first network node to communicate with a UE during an active state of the UE in accordance with a first UE configuration, wherein the first network node comprises a first NTN network node. The one or more processors may be individually or collectively configured to cause the first network node to perform, associated with a second NTN network node and based on a determination that the first NTN is moving out of an RNA, an AS context relocation operation associated with the second NTN network node.

Some aspects described herein relate to an apparatus for wireless communication at a second network node. The apparatus may include one or more memories and one or more processors coupled to the one or more memories. The one or more processors may be individually or collectively configured to cause the second network node to perform, associated with a first NTN network node and based on a determination that the first NTN is moving out of an RNA, an AS context relocation operation associated with the second network node, the second network node comprising a second NTN network node. The one or more processors may be individually or collectively configured to cause the second network node to communicate, based on the AS context relocation operation, with at least one of a UE or a third NTN network node.

Some aspects described herein relate to a non-transitory computer-readable medium that stores a set of instructions for wireless communication by a one or more instructions that, when executed by one or more processors of an apparatus at a first network node. The set of instructions, when executed by one or more processors of the one or more instructions that, when executed by one or more processors of an apparatus at a first network node, may cause the one or more instructions that, when executed by one or more processors of an apparatus at a first network node to communicate with a UE during an active state of the UE in accordance with a first UE configuration. The set of instructions, when executed by one or more processors of the one or more instructions that, when executed by one or more processors of an apparatus at a first network node, may cause the one or more instructions that, when executed by one or more processors of an apparatus at a first network node to perform, associated with a second network node and based on a determination to switch the UE to an inactive state, an AS context relocation operation and a path switch operation associated with the second network node.

Some aspects described herein relate to a non-transitory computer-readable medium that stores a set of instructions for wireless communication by a one or more instructions that, when executed by one or more processors of an apparatus at a second network node. The set of instructions, when executed by one or more processors of the one or more instructions that, when executed by one or more processors of an apparatus at a second network node, may cause the one or more instructions that, when executed by one or more processors of an apparatus at a second network node to perform, associated with a first network node and based on a determination to switch a connected UE to an inactive state, an AS context relocation operation and a path switch operation associated with the second network node. The set of instructions, when executed by one or more processors of the one or more instructions that, when executed by one or more processors of an apparatus at a second network node, may cause the one or more instructions that, when executed by one or more processors of an apparatus at a second network node to communicate with the UE based on the AS context relocation operation and the path switch operation.

Some aspects described herein relate to a non-transitory computer-readable medium that stores a set of instructions for wireless communication by a one or more instructions that, when executed by one or more processors of an apparatus at a UE. The set of instructions, when executed by one or more processors of the one or more instructions that, when executed by one or more processors of an apparatus at a UE, may cause the one or more instructions that, when executed by one or more processors of an apparatus at a UE to communicate with a first network node during an active state of the UE in accordance with a first UE configuration. The set of instructions, when executed by one or more processors of the one or more instructions that, when executed by one or more processors of an apparatus at a UE, may cause the one or more instructions that, when executed by one or more processors of an apparatus at a UE to perform, associated with a second network node and based on an AS context relocation operation and a path switch operation associated with a second network node, a UE resume operation to connect to the second network node.

Some aspects described herein relate to a non-transitory computer-readable medium that stores a set of instructions for wireless communication by a one or more instructions that, when executed by one or more processors of an apparatus at a core network. The set of instructions, when executed by one or more processors of the one or more instructions that, when executed by one or more processors of an apparatus at a core network, may cause the one or more instructions that, when executed by one or more processors of an apparatus at a core network to obtain, from a first network node and associated with a UE, a path switch request message associated with a path switch operation. The set of instructions, when executed by one or more processors of the one or more instructions that, when executed by one or more processors of an apparatus at a core network, may cause the one or more instructions that, when executed by one or more processors of an apparatus at a core network to perform, based on the path switch request message, the path switch operation in association with a second network node.

Some aspects described herein relate to a non-transitory computer-readable medium that stores a set of instructions for wireless communication by a one or more instructions that, when executed by one or more processors of an apparatus at a first network node. The set of instructions, when executed by one or more processors of the one or more instructions that, when executed by one or more processors of an apparatus at a first network node, may cause the one or more instructions that, when executed by one or more processors of an apparatus at a first network node to communicate with a UE during an active state of the UE in accordance with a first UE configuration, wherein the first network node comprises a first NTN network node. The set of instructions, when executed by one or more processors of the one or more instructions that, when executed by one or more processors of an apparatus at a first network node, may cause the one or more instructions that, when executed by one or more processors of an apparatus at a first network node to perform, associated with a second NTN network node and based on a determination that the first NTN is moving out of an RNA, an AS context relocation operation associated with the second NTN network node.

Some aspects described herein relate to a non-transitory computer-readable medium that stores a set of instructions for wireless communication by a one or more instructions that, when executed by one or more processors of an apparatus at a second network node. The set of instructions, when executed by one or more processors of the one or more instructions that, when executed by one or more processors of an apparatus at a second network node, may cause the one or more instructions that, when executed by one or more processors of an apparatus at a second network node to perform, associated with a first NTN network node and based on a determination that the first NTN is moving out of an RNA, an AS context relocation operation associated with the second network node, the second network node comprising a second NTN network node. The set of instructions, when executed by one or more processors of the one or more instructions that, when executed by one or more processors of an apparatus at a second network node, may cause the one or more instructions that, when executed by one or more processors of an apparatus at a second network node to communicate, based on the AS context relocation operation, with at least one of a UE or a third NTN network node.

Some aspects described herein relate to an apparatus for wireless communication. The apparatus may include means for communicating with a UE during an active state of the UE in accordance with a first UE configuration. The apparatus may include means for performing, associated with a second network node and based on a determination to switch the UE to an inactive state, an AS context relocation operation and a path switch operation associated with the second network node.

Some aspects described herein relate to an apparatus for wireless communication. The apparatus may include means for performing, associated with a first network node and based on a determination to switch a connected UE to an inactive state, an AS context relocation operation and a path switch operation associated with the apparatus. The apparatus may include means for communicating with the UE based on the AS context relocation operation and the path switch operation.

Some aspects described herein relate to an apparatus for wireless communication. The apparatus may include means for communicating with a first network node during an active state of the apparatus in accordance with a first UE configuration. The apparatus may include means for performing, associated with a second network node and based on an AS context relocation operation and a path switch operation associated with a second network node, a UE resume operation to connect to the second network node.

Some aspects described herein relate to an apparatus for wireless communication. The apparatus may include means for obtaining, from a first network node and associated with a UE, a path switch request message associated with a path switch operation. The apparatus may include means for performing, based on the path switch request message, the path switch operation in association with a second network node.

Some aspects described herein relate to an apparatus for wireless communication. The apparatus may include means for communicating with a UE during an active state of the UE in accordance with a first UE configuration, wherein apparatus comprises a first NTN network node. The apparatus may include means for performing, associated with a second NTN network node and based on a determination that the first NTN is moving out of an RNA, an AS context relocation operation associated with the second NTN network node.

Some aspects described herein relate to an apparatus for wireless communication. The apparatus may include means for performing, associated with a first NTN network node and based on a determination that the first NTN is moving out of an RNA, an AS context relocation operation associated with the apparatus, the second network node comprising a second NTN network node. The apparatus may include means for communicating, based on the AS context relocation operation, with at least one of a UE or a third NTN network node.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4A illustrates an example of a wireless network (e.g., wireless network) in which a UE (e.g., a UE) may support radio resource control (RRC) communication modes, in accordance with the present disclosure.

FIG. 4B is a diagram illustrating an example of non-terrestrial network (NTN) operations in accordance with the present disclosure.

FIGS. 5A-5J are diagrams illustrating examples associated with inactive UE operations for non-terrestrial networks in accordance with the present disclosure.

FIGS. 6A-6H illustrate examples associated with radio access network (RAN) notification area (RNA) handling for NTN network nodes, in accordance with the present disclosure.

FIG. 7 is a diagram illustrating an example process performed, for example, by a first network node, in accordance with the present disclosure.

FIG. 8 is a diagram illustrating an example process performed, for example, by a second network node, in accordance with the present disclosure.

FIG. 9 is a diagram illustrating an example process performed, for example, by a UE, in accordance with the present disclosure.

FIG. 10 is a diagram illustrating an example process performed, for example, by a core network implemented as one or more network nodes, in accordance with the present disclosure.

FIG. 11 is a diagram illustrating an example process performed, for example, by a first network node, in accordance with the present disclosure.

FIG. 12 is a diagram illustrating an example process performed, for example, by a second network node, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of an implementation of code and circuitry for an apparatus, in accordance with the present disclosure.

FIG. 16 is a diagram of an example apparatus for wireless communication, in accordance with the present disclosure.

FIG. 17 is a diagram illustrating an example of a hardware implementation for an apparatus employing a processing system, in accordance with the present disclosure.

FIG. 18 is a diagram illustrating an example of an implementation of code and circuitry for an apparatus, in accordance with the present disclosure.

### DETAILED DESCRIPTION

A user equipment (UE) may operate in a connected state (e.g., a radio resource control (RRC) connected mode, which may be referred to as an “active state,” an “active mode,” a “connected state,” “an RRC connected mode,” and/or a “connected mode”), an idle state (e.g., an RRC idle mode), or an inactive state (e.g., RRC inactive mode), with respect to one or more cells provided by one or more network nodes. The UE may transition between different connection modes (e.g., the connection states listed above) based at least in part on various commands and/or communications (referred to herein, interchangeably as “messages”) received from the one or more network nodes. When the UE is powered-on, the UE may be in the idle state, and the UE can transition to the connected state (e.g., with an initial attachment to the network and/or with establishment of a network connection). For example, in an active state (e.g., an RRC connected state) with respect to a serving cell provided by a network node, an RRC connection may exist between the UE and the serving cell (sometimes referred to as a “source cell,” e.g., in the context of mobility operations in which the UE switches connection from the source cell to another cell, referred to as a “target cell”). In the active state (e.g., RRC connected state), data communications may be sent between the UE and the serving cell.

In some cases, the UE may transition from the active state to a non-connected mode such as an RRC inactive state or an RRC idle state. For example, if there is no activity from the UE for a threshold amount of time, the serving cell of the UE can suspend the UE session and trigger the UE to transition to the inactive state. In an RRC inactive mode, data communications are not actively being sent, but the UE and/or the network node that provides the serving cell may maintain information for efficiently re-establishing the connection. In an RRC idle mode, that information is generally not maintained at either the UE or the network node for a reconnection to RRC active mode with the serving cell and the UE may perform an access procedure (e.g., a random access procedure) to re-establish connection to the serving cell or a target cell.

For example, as part of the transition to the inactive state, both the UE and the network (e.g., a network node associated with the serving cell) may store an access stratum (AS) context associated with the UE. The AS context (which may be referred to as “UE AS context”) may include, for example, a current RRC configuration, a current security context, a packet data convergence protocol (PDCP) state (including a robust header compression (ROHC) state), a service data adaptation protocol (SDAP) configuration, a cell radio network temporary identifier (C-RNTI) used in a primary cell, a cell identity, and/or a physical cell identity of a primary cell, among other examples. The storing of the AS context may eliminate a need for such information to be re-provided to the UE when the UE transitions back to the connected state from the inactive state.

While in the inactive state, the UE may handle mobility (e.g., such that the UE may be reselected to another serving cell while in the inactive state). Thus, the serving cell of the UE may change while the UE is in the inactive state. The UE may detect a trigger, associated with resuming the session, when, for example, the UE needs to transmit an uplink transmission and/or when the UE detects a paging message for the UE, among other examples. The UE may trigger a resume procedure, associated with resuming the session, by sending a resume request (e.g., an RRC resume request) to the current serving cell of the UE. In a case in which the UE switches to (e.g., is reselected to and/or moves to) another serving cell while in the inactive state, the resume request may be transmitted using a serving cell common configuration associated with the new serving cell, which may be read from a system information block (SIB) (e.g., SIB1) of the new serving cell as a result of the reselection to the new serving cell.

The UE may receive a resume message (e.g., an RRC resume message) associated with resuming the session, which may trigger the UE to transition from the inactive state to the connected state. Based on this trigger, the UE may restore the AS context using the AS context stored on the UE. Restoration of the AS context may reduce an amount of time needed to transition to the connected state and may reduce signaling overhead (e.g., as compared to transitioning to the connected state from the idle state since AS context is not maintained when the UE is transitioned to RRC idle mode) since information included in the AS context need not be re-provided by the network.

In some cases, deployment of non-terrestrial network (NTN) cells can facilitate providing improved cellular coverage area. As used herein, “NTN” may refer to a network for which access is facilitated by a non-terrestrial UE and/or a non-terrestrial network node (which may be referred to as an “NTN network node”). Similarly, a terrestrial network (TN) may refer to a network for which access is facilitated by a terrestrial UE and/or a terrestrial network node (which may be referred to as a “TN network node”). In some cases, an NTN network node may provide an NTN cell having a large coverage area and, thus, AS context associated with the NTN cell may be valid in a wide area. As such, the latency and signalling reduction gains achievable from utilizing a UE inactive state (as opposed to a UE idle state) can be larger in an NTN than in a TN. In sparse TN deployment overlapping with NTN coverage, even if a UE moves outside of a TN cell, the UE may still be within the NTN cell and, as a result, an RRC resume procedure may be performed in association with the NTN cell when TN cell coverage is unavailable. Some aspects of the techniques described herein may include various techniques for handling UE AS context, configuration information, and/or other information to support more efficient and reliable communications in environments including NTN cell coverage areas.

A number of different examples of scenarios involving NTNs are described herein. In a first scenario (referred to herein as “Scenario 1”), a UE may be moving in and out of TN cell coverage areas while staying within an NTN cell coverage area. In a second scenario (referred to herein as “Scenario 2”), a UE may be located on earth within a radio access network (RAN) notification area (RNA), which may be an area containing one or more cell coverage areas associated with one or more cells that a UE may be configured to select and/or reselect.

In some examples of Scenario 1, a UE may move from a first location associated with a TN cell coverage area to a second location associated with another TN cell coverage area, and during some portion of the UE's travel between the first location and the second location, the UE may be in a third location associated with no TN cell coverage area. When the UE is in the third location, if the UE is within an NTN cell coverage area, the UE may resume to an NTN network node and the NTN node can trigger a UE context retrieve procedure to the last TN network node that the UE was connected to for obtaining the stored UE AS context. Thus, a path switch operation, which provides the user plane path to the core network that facilitates UE data communications, can be provided after retrieving the UE AS context from the last connected network node. More efficient communications may be achieved by utilizing techniques that enable the NTN node to obtain the UE AS context, and/or to perform a path switch operation, prior to receiving an RRC resume request from the UE.

Some aspects of the techniques described herein may include UE operations for inactive state associated with NTNs (e.g., to facilitate mitigation of data transmission and/or reception delay as a UE moves between TN coverage areas). In some aspects, for example, when a UE transitions to a UE inactive state, a network node may perform a UE inactive AS context relocation operation and a path switch operation to another network node to which the UE may connect. In an example of Scenario 1, in which a UE is moving out of a TN cell coverage area associated with a TN cell (with which the UE is in an active state) provided by a TN network node, while also moving within an NTN cell coverage area associated with an NTN cell provided by an NTN network node (e.g., where the TN cell coverage area at least partially overlaps the NTN cell coverage are), the TN node may relocate the UE AS context to the NTN node when the UE transitions to the inactive state. In some aspects, when the UE transitions to the inactive state, the TN network node may perform a path switch operation to establish a user-plane (“U-plane”) path between the core network and the NTN network node. If the UE resumes to the TN network node, the TN network node may perform a UE context retrieve operation to retrieve the relocated UE AS context from the NTN network node. In examples in which the UE resumes to the NTN network node, due to performing the AS context relocation operation and path switch operation, the NTN network node does not need to perform a UE inactive AS context retrieve operation and path switch operation from the TN network node subsequent to receiving the RRC resume request. In this way, the UE may be transitioned to an active state in association with the NTN cell in response to requesting to resume to the NTN cell (e.g., as opposed to having to wait for the UE AS context to be relocated and the path switched) and, consequently, some aspects may facilitate mitigating data transmission and/or reception delay. In some aspects, the UE AS context relocation operation and/or path switch operation may be performed between any two or more network nodes, including, for example, TN network nodes and/or NTN network nodes, among other examples.

Some wireless communication standards can require a UE to receive an RRC resume message that includes configuration information to be applied by the UE to resume U-plane data transmission in TNs and/or NTNs. In some aspects of the techniques described herein, a UE may be provided with a set of dedicated configurations for multiple cells when the UE transitions to an inactive state, each dedicated configuration corresponding to a respective cell of the multiple cells. When the UE resumes to an active state, the UE may apply the corresponding configuration for the cell to which the UE is resuming to the active state. In this way, U-plane data transmissions may be resumed even prior to the UE receiving an RRC resume message, thereby making travel between different cells more efficient and mitigating the risk of lost communications and unnecessary gaps in connectivity. In some aspects, the UE may identify the corresponding configuration based on the linkage of a cell identifier and the configuration. In some aspects, a restriction may be placed on a length of a list, stored at the UE, of cells for which corresponding dedicated configurations may be stored in the UE. In some other aspects, the restriction may be placed on the number of dedicated configurations that may be stored in the UE. For example, in some aspects, the restriction may restrict the number of cells and/or corresponding dedicated configurations to 4, 8, 16, or 64, among other examples. In some aspects, the restriction and/or the number of dedicated configurations stored in the UE may be based on a UE capability. In some aspects, one or more aspects of techniques described herein for storing multiple dedicated configurations may be combined with one or more aspects of techniques described herein for performing UE AS context relocation operations and/or path switch operations.

In some cases, even after a first network node performs a UE AS context relocation to relocate the UE AS context to a second network node, a situation can arise in which a network node performs a UE context retrieve operation subsequent to receiving an RRC resume request from the UE. For example, in some cases, the UE might attempt to resume connection to the cell provided by the first network node, in which case the first network node can perform a UE context retrieve procedure to retrieve the relocated UE AS context from the second network node. In some other cases, while the UE AS context is relocated from a first network node to a second network node during transition of the UE to the RRC inactive state, the UE may be located within another network node's coverage area (e.g., the first network node or a third network node).

Some aspects of the techniques described herein may include storing the UE AS context at multiple network nodes, thereby mitigating the need for the UE retrieve operation. For example, in some aspects, the first network node may maintain a UE AS context associated with the UE subsequent to performing the UE AS context relocation operation. In this way, if the UE attempts to resume active connection to the first network node instead of the second network node, the first network node is already prepared and does not need to introduce additional delay by performing a UE context retrieve operation. Similarly, if the first network node relocates the UE AS context to a third network node in addition to the second network node, the third network may not need to perform a UE context retrieve operation if the UE attempts to resume active connection to the third network node. In some aspects, a user and/or control-plane interface may be maintained only in the last network node to which the UE was connected or in multiple network nodes.

In some cases, a UE may be configured with a radio access network (RAN) notification area (RNA) for inactive state. For example, an RRC Release message can include RNA information as a list of cells or a list of RAN area codes. The UE can trigger an RNA update periodically or when a selected cell is not in the list of configured RNA. In cases of sparse TN coverage, including an NTN cell in the RNA information may expand connectivity options for UEs, which may result in more consistent connectivity. Since NTN cell coverage may be large, a UE may not need to trigger RNA updates frequently, even if the UE is moving around. In some cases, however, a network may not be configured to include an NTN cell explicitly in RNA information in cases in which the RNA information may include a RAN area code (RA code) list due to the coarse granularity of the RA code list. In some cases, as a UE moves in and out of TN cell coverage areas that are within an NTN cell coverage area, the UE may trigger RNA updates due to reselection of TN cells that are not listed in current RNA information. In some other cases, the UE may trigger RNA updates due to a periodical update configuration. Some aspects of the techniques described herein may include signalling RNA as a combination of an RA code list and a cell list. In this way, an NTN network node may be indicated in the cell list and, therefore, in the RNA information, enhancing the options for cell reselection available to the UE.

In one or more examples of Scenario 1, a UE may be associated with a train (or other moving device such as a piloted vehicle and/or an unpiloted vehicle, among other examples) that moves from a first location (e.g., a first train station, a first town, a first roadside unit (RSU), and/or a first docking station, among other examples) associated with a first TN cell to a second location associated with a second TN cell and from the second location to a third location associated with a third TN cell. All three TN cells may be within an NTN cell coverage area. However, the cells deployed in each location may not be within the same RNA. In one or more examples, because TN frequencies may be prioritized over NTN frequencies for cell re-selection, when the UE comes to a new location (e.g., with new TN cell coverage), the UE may trigger an RNA information update even while the NTN cell is still available.

Each time the UE begins to move out of a TN cell coverage area, the UE can receive a suspend configuration RNA communication that includes RNA information associated with the current TN cell and an NTN cell. As the UE leaves the location, the UE can reselect to the NTN cell. In this case, no RNA update is needed, as the UE has already stored RNA information associated with the NTN cell. However, each time the UE approaches a new location associated with a new TN cell coverage area, the UE can reselect to the TN cell associated therewith and can receive RNA update information associated with the new TN cell. In some aspects, a rule may be established in a wireless communication standard and/or via configuration that limits the cells that a UE may reselect. For example, in some aspects, the rule may cause the UE to not reselect a cell not included in current RNA information if the UE camps on a cell included in the RNA information, thereby potentially reducing the number of times that the UE triggers RNA information updates. In some aspects, RNA information updates may be triggered per cell, per cell type, or per-orbit type, thereby enabling less frequent RNA information update triggering in cases in which a UE is moving within an NTN coverage area. In some aspects, for example, the rule may establish a list of prohibited cells, which may be cells that the UE may be prohibited from reselecting (e.g., a first cell that is not indicated in current RNA information if the UE camps on a second cell that is indicated in the current RNA information). If the UE detects that the re-selected cell is a prohibited cell, then the UE may re-select to the previous cell. In some aspects, the prohibition may apply to a limited set of combinations of the first cell and the second cell. For example, the prohibition may apply only when the first cell is a TN cell and the second cell is an NTN cell, when the first cell is any cell and the second cell is an NTN cell, and/or when the first cell is any cell and the second cell is indicated by the network. The indication from the network may be provided with RNA information (e.g., in an explicit list of cell identities, an explicit list of RA codes, or a bitmap). In some aspects, the prohibition may be a hard prohibition or a soft prohibition. A hard prohibition refers to an explicit prohibition that the UE must follow and the soft prohibition refers to a prohibition that causes the UE to adjust cell reselection parameters such that the UE is not likely to re-select the prohibited cell.

In some cases, when a UE is in an inactive state (e.g., an RRC inactive state), the UE can periodically trigger RNA information updates based on a timer configured by the network (e.g., referred to as a “t380 timer”). In some cases, there can be a trade-off between UE battery consumption (and/or network signalling) and UE location precision. In some wireless communication standards, the t380 timer may be a per-UE timer and the same value can be applied regardless of cell type (e.g., regardless of whether the cell is a TN cell, an NTN cell, a geostationary equatorial orbit (GSO), or a non-geostationary orbit (NGSO)). Given that NTN coverage is large, if the UE is in an NTN cell, the UE may not need to trigger RNA update frequently. If the UE does trigger RNA information updates frequently, the UE may consume unnecessary amounts of battery resources and signalling resources.

In some aspects, to reduce resource consumption, t380 timer signalling may be configured to be per-cell signalling and/or per-orbit type signalling. For example, a network node may provide configuration information to the UE that is indicative of a per-cell radio access network (RAN) notification area (RNA) timer, a per-cell-type RNA timer, or a per-orbit-type RNA timer. In this way, for example, a timer associated with an NTN cell may be longer than a timer associated with a TN cell, since the UE will not need RNA information updates as frequently when moving within an NTN cell. As a result, the timer may enable mitigation of battery and signalling resource consumption.

In some cases of Scenario 2, a UE may be located on earth within an RNA. The UE initially may be RRC connected to a first NTN network node, while the first NTN network node is in a first position in its orbit around the earth. In some cases, associated with network node processed payload for electromagnetic compatibility (EMC) standards, a last NTN network node to which a UE was connected may be located far from the RNA and may not store the UE AS context as it has moved out of RNA. Thus, when the UE resumes an active connection (e.g., transition to an active state), the network node to which the UE resumes connection may not be able to retrieve the UE AS context from the last NTN network node. For example, the NTN network node may orbit the earth in an orbital direction and when it moves into a position other than the first position, the first NTN network node may no longer be within the RNA and thus may no longer store the UE AS context. Thus, for example, when the UE attempts to resume to a second NTN network node, the second NTN network node may not be able to retrieve the UE AS context from the first NTN network node, thereby causing the UE to not be able to transition to an active state.

Some aspects of the techniques described herein may provide RNA handling for NTN networks. In some aspects, a first NTN network node may forward UE AS context to a neighboring NTN network node based on the satellite movement (e.g., as part of RNA information). In some aspects, for example, the techniques described above for UE context relocation may be used to forward the UE AS context. In some aspects, the first NTN network node may forward the UE AS context to an anchor node. In some aspects, the anchor node may be an NTN gateway or a gNB implemented on a satellite having a geostationary orbit (sometimes referred to as a geosynchronous equatorial orbit (GEO)). The second NTN network node may retrieve the UE AS context from the anchor node. In some aspects, the first NTN network node may maintain the UE AS context even outside of the RNA.

In some aspects, the last network node to be connected with the UE may retain the UE AS context even if the last network node moves out of the RNA. In this way, when the UE AS resumes to a next network node, the next network node may retrieve the UE AS context from the last network node. In some aspects, for example, the second NTN network node may retrieve the UE AS context from the first NTN network node via an inter-satellite link (ISL). In this way, some aspects of the techniques described herein may facilitate maintaining UE connection to a network as NTN network nodes move in and out of an RNA.

The techniques described herein may be applicable to any type of radio access technology (e.g., long term evolution (LTE), 5G, and/or 6G, among other aspects), any network type (e.g., TN and/or NTN), any core network (CN) type (evolved packet core (EPC), 5G core (5GC), and/or 6G core (6GC), among other examples, including any future examples), and/or any orbit type (e.g., geosynchronous orbit (GSO) and/or non-geostationary orbit (NGSO)).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

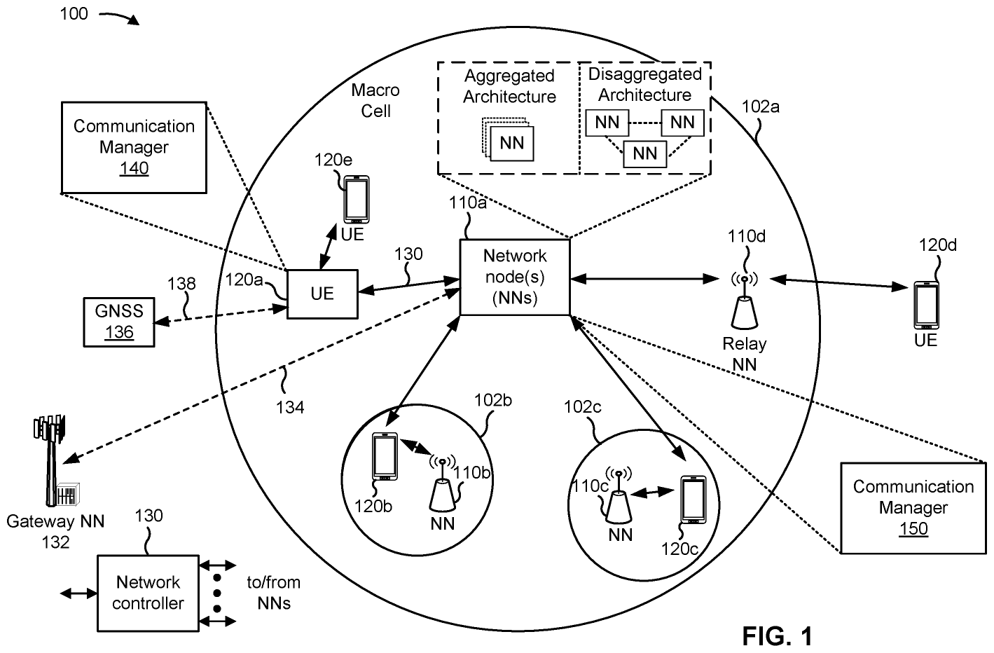

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

In some aspects, the wireless network 100 may include one or more non-terrestrial network (NTN) deployments in which a non-terrestrial wireless communication device may include a UE (referred to herein, interchangeably, as a “non-terrestrial UE”) and/or another network node (referred to herein, interchangeably, as a “non-terrestrial network node”). A non-terrestrial network node may include, for example, a base station (referred to herein, interchangeably, as a “non-terrestrial base station”) and/or a relay station (referred to herein, interchangeably, as a “non-terrestrial relay station”), among other examples. As used herein, “NTN” may refer to a network for which access is facilitated by a non-terrestrial UE 120 and/or a non-terrestrial network node 110. Similarly, a terrestrial network (TN) may refer to a network for which access is facilitate by a terrestrial UE 120 and/or a terrestrial network node 110.

The wireless network 100 may include any number of non-terrestrial wireless communication devices, which may be, include, or be included in, one or more NTN nodes. A non-terrestrial wireless communication device may include a satellite, a crewed aircraft system, an uncrewed aircraft system (UAS) platform, and/or the like. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, helicopter, and/or a dirigible, among other examples. A UAS platform may include a high-altitude platform station (HAPS), and may include a balloon, a dirigible, and/or an airplane, among other examples. A non-terrestrial wireless communication device may be part of an NTN that is separate from the wireless network 100. Alternatively, an NTN may be part of the wireless network 100. Satellites may communicate directly and/or indirectly with other entities in wireless network 100 using satellite communication. The other entities may include UEs (e.g., terrestrial UEs and/or non-terrestrial UEs), other satellites in the one or more NTN deployments, other types of network nodes (e.g., stationary and/or ground-based network nodes), relay stations, and/or one or more components and/or devices included in a core network of wireless network 100, among other examples.

For example, in some aspects, an NTN node may be part of a regenerative NTN node deployment (e.g., a regenerative satellite deployment) and/or a transparent NTN node deployment (e.g., a transparent satellite deployment). In the example of the regenerative NTN node deployment, the UE 120a may be served by the NN 110a, which may be an NTN node (e.g., a satellite), via a service link 130. In some aspects, the NN 110a may be associated with, and/or referred to as, a non-terrestrial base station, a regenerative repeater, or an on-board processing repeater. In some aspects, the NN 110a may demodulate an uplink radio frequency signal and may modulate a baseband signal derived from the uplink radio signal to produce a downlink radio frequency transmission. The NN 110a may transmit the downlink radio frequency signal on the service link 130. The NN 110a may provide a cell (e.g., the macro cell 102a that covers the UE 120e.

In an example of a transparent NTN node deployment, which may include, for example, a bent-pipe satellite deployment, the UE 120a may be served by the NN 110a which may be a transparent satellite, via the service link 130. The NN 110a may relay a signal received from a gateway NN 132 (sometimes referred to as a “gateway”) via a feeder link 134. For example, the NN 110a may receive an uplink radio frequency transmission and may transmit a downlink radio frequency transmission without demodulating the uplink radio frequency transmission. In some aspects, the NN 110a may frequency convert the uplink radio frequency transmission received on the service link 130 to a frequency of the uplink radio frequency transmission on the feeder link 134, and may amplify and/or filter the uplink radio frequency transmission. In some aspects, the UE 120a may communicate with a Global Navigation Satellite System (GNSS) 136 via a positioning link 138. The NN 110A may provide a cell that covers the UE 120e in a transparent NTN node deployment as well. The service link 130 may include a link between the NN 110a and the UE 102e, and may include one or more of an uplink or a downlink. The feeder link 134 may include a link between the NN 110a and the gateway NN 136, and may include one or more of an uplink (e.g., from the UE 120a to the gateway NN 136) or a downlink (e.g., from the gateway NN 136 to the UE 120a).

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 138 may couple to or communicate with a set of network nodes 110 and may provide coordination and control for these network nodes 110. The network controller 138 may communicate with the network nodes 110 via a backhaul communication link or a midhaul communication link. The network nodes 110 may communicate with one another directly or indirectly via a wireless or wireline backhaul communication link. In some aspects, the network controller 138 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first network node (e.g., the network node 110) may include a communication manager 150. As described in more detail elsewhere herein, the communication manager 150 may communicate with a UE during an active state of the UE in accordance with a first UE configuration; and perform, associated with a second network node and based on a determination to switch the UE to an inactive state, an AS context relocation operation and a path switch operation associated with the second network node. Additionally, or alternatively, the communication manager 150 may perform one or more other operations described herein.

In some aspects, the network node 110 may include a communication manager 150. As described in more detail elsewhere herein, the communication manager 150 may perform, associated with a first network node and based on a determination to switch a connected UE to an inactive state, an AS context relocation operation and a path switch operation associated with the second network node; and communicate with the UE based on the AS context relocation operation and the path switch operation. Additionally, or alternatively, the communication manager 150 may perform one or more other operations described herein.

In some aspects, the UE 120 may include a communication manager 140. As described in more detail elsewhere herein, the communication manager 140 may communicate with a first network node during an active state of the UE in accordance with a first UE configuration; and perform, associated with a second network node and based on an AS context relocation operation and a path switch operation associated with a second network node, a UE resume operation to connect to the second network node. Additionally, or alternatively, the communication manager 140 may perform one or more other operations described herein.

In some aspects, a core network (e.g., the network node 110) may include a communication manager 150. As described in more detail elsewhere herein, the communication manager 150 may obtain, from a first network node and associated with a UE, a path switch request message associated with a path switch operation; and perform, based on the path switch request message, the path switch operation in association with a second network node. Additionally, or alternatively, the communication manager 150 may perform one or more other operations described herein.

In some aspects, a first network node (e.g., the network node 110) may include a communication manager 150. As described in more detail elsewhere herein, the communication manager 150 may communicate with a UE during an active state of the UE in accordance with a first UE configuration, wherein the first network node comprises a first NTN network node; and perform, associated with a second NTN network node and based on a determination that the first NTN is moving out of an RNA, an AS context relocation operation associated with the second NTN network node. Additionally, or alternatively, the communication manager 150 may perform one or more other operations described herein.

In some aspects, the network node 110 may include a communication manager 150. As described in more detail elsewhere herein, the communication manager 150 may perform, associated with a first NTN network node and based on a determination that the first NTN is moving out of an RNA, an AS context relocation operation associated with the second network node, the second network node comprising a second NTN network node; and communicate, based on the AS context relocation operation, with at least one of a UE or a third NTN network node. Additionally, or alternatively, the communication manager 150 may perform one or more other operations described herein.

As indicated above, FIG. 1 is provided as an example. Other examples may differ from what is described with regard to FIG. 1.

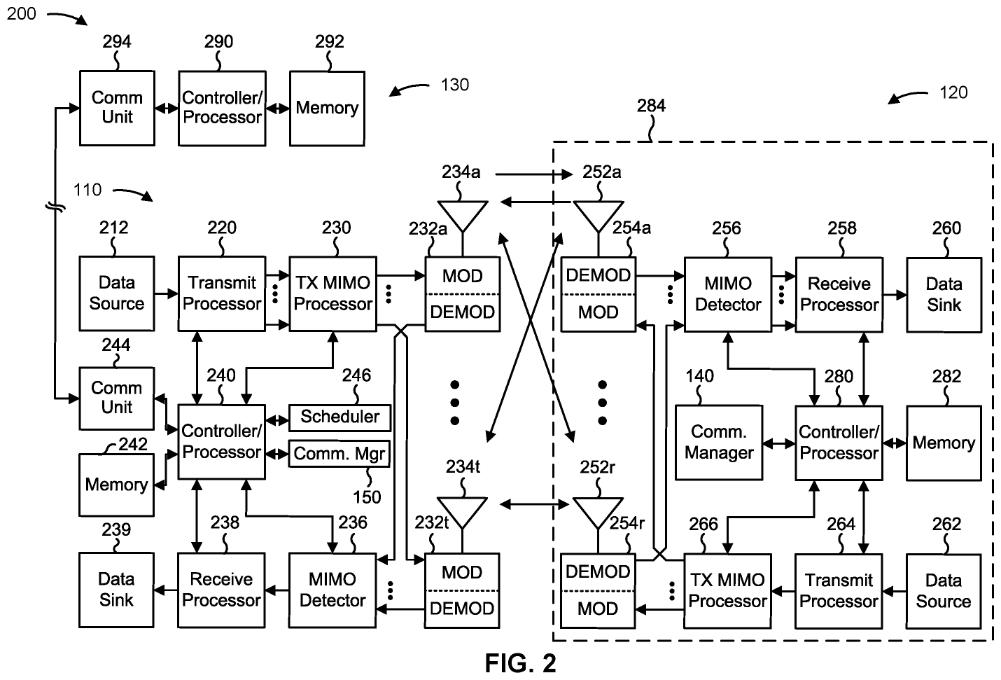

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

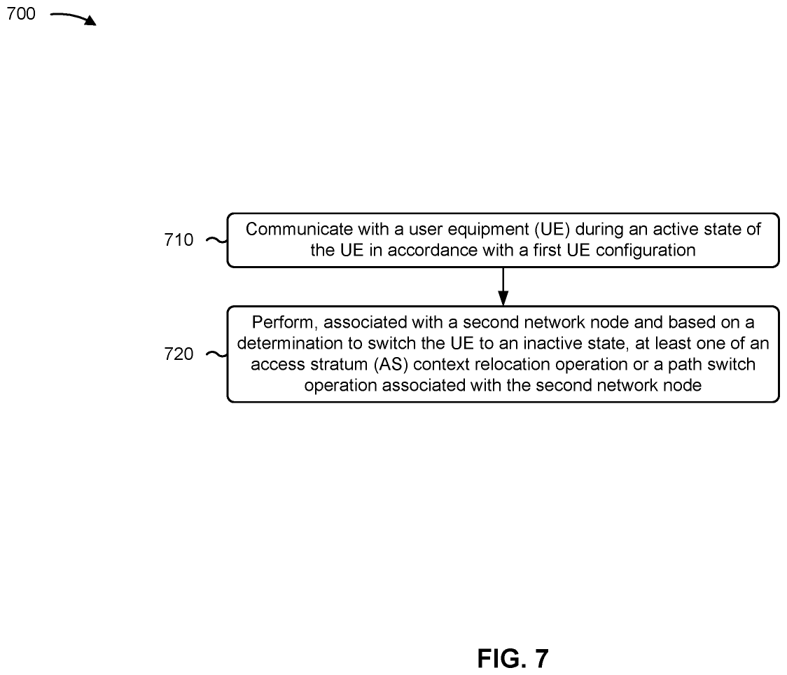

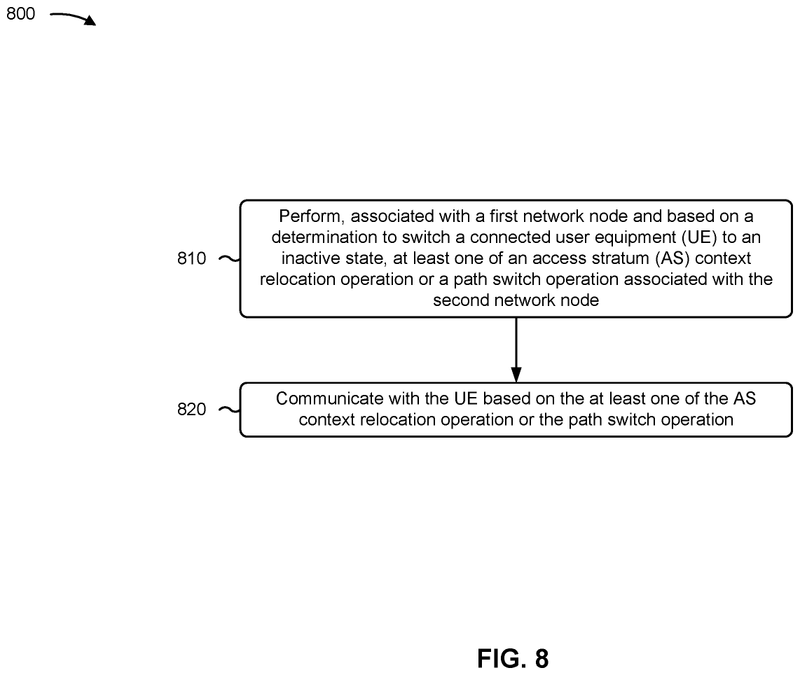

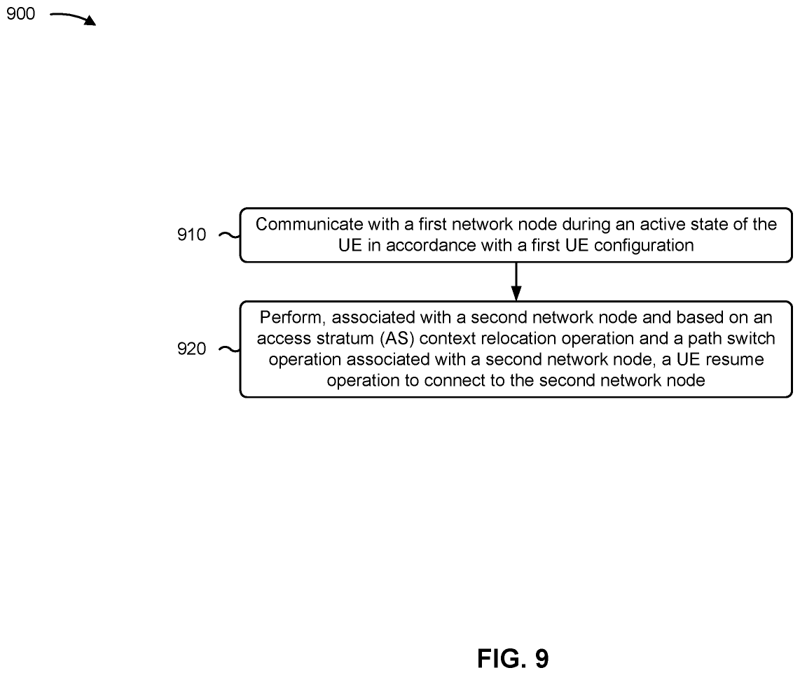

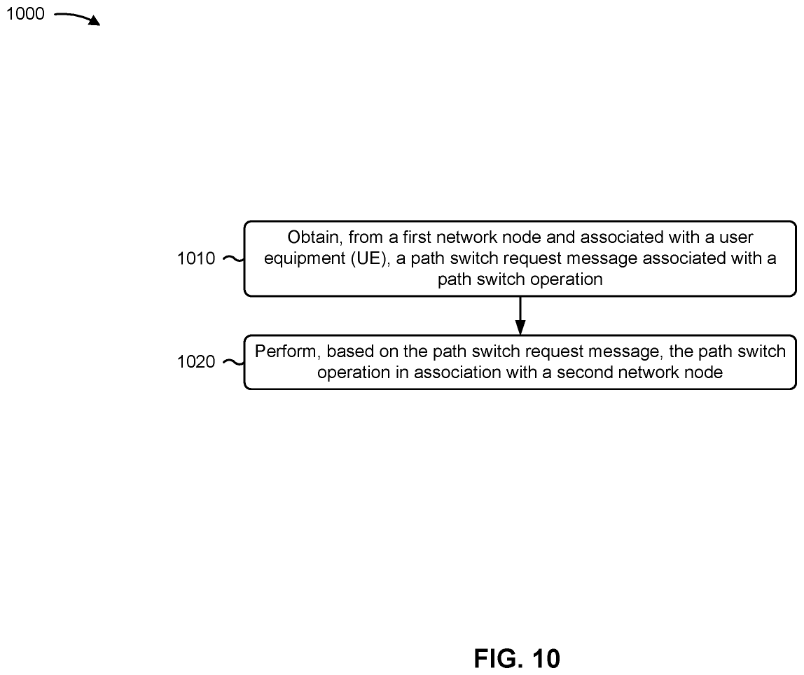

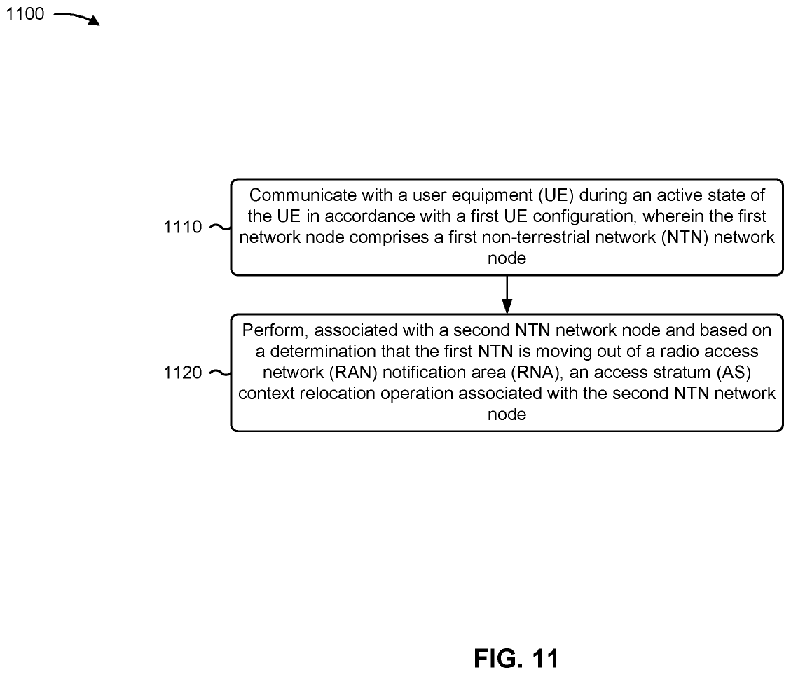

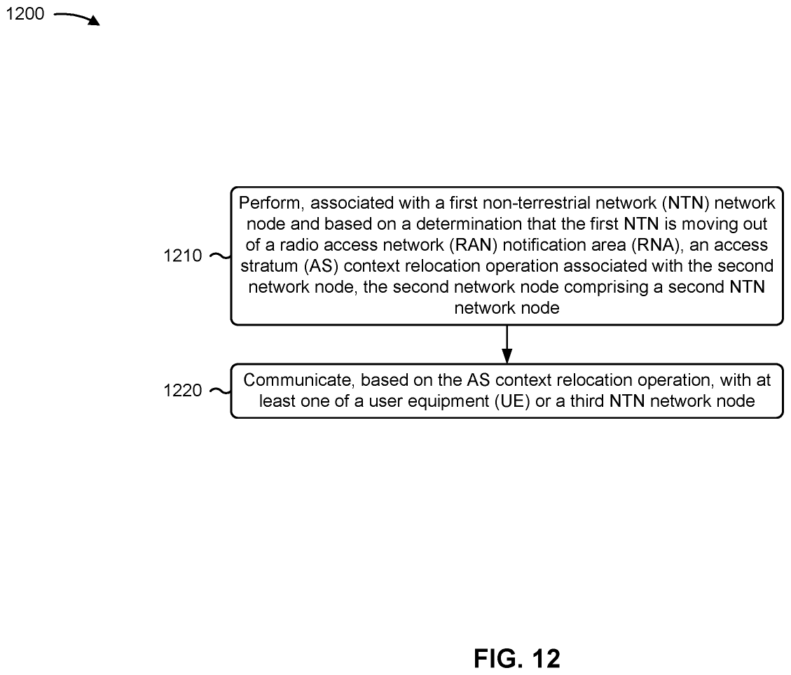

The controller/processor 240 of the network node 110, the controller/processor 280 of the UE 120, and/or any other component(s) of FIG. 2 may perform one or more techniques associated with inactive UE operations for non-terrestrial networks, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples. In some aspects, a first entity (e.g., a UE and/or a network node) may provide a communication to a second entity (e.g., another UE and/or network node) by providing the communication directly to the second entity or indirectly to the second entity (e.g., via one or more additional entities). The term “providing” refers to either directly providing or indirectly providing. Similarly, the term “obtaining” refers to either directly obtaining (e.g., directly obtaining a communication from another network node) or indirectly obtaining (e.g., obtaining the communication from another network node via one or more additional network nodes).

In some aspects, a first network node (e.g., the network node 110) may include means for communicating with a user equipment (UE) during an active state of the UE in accordance with a first UE configuration; and/or means for performing, associated with a second network node and based on a determination to switch the UE to an inactive state, an access stratum (AS) context relocation operation and a path switch operation associated with the second network node. The means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a second network node (e.g., the network node 110) may include means for performing, associated with a first network node and based on a determination to switch a connected user equipment (UE) to an inactive state, an access stratum (AS) context relocation operation and a path switch operation associated with the second network node; and/or means for communicating with the UE based on the AS context relocation operation and the path switch operation. The means for the second network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a UE (e.g., UE 120) may include means for communicating with a first network node during an active state of the UE in accordance with a first UE configuration; and/or means for performing, associated with a second network node and based on an access stratum (AS) context relocation operation and a path switch operation associated with a second network node, a UE resume operation to connect to the second network node. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a core network (e.g., the network node 110) may include means for obtaining, from a first network node and associated with a user equipment (UE), a path switch request message associated with a path switch operation; and/or means for performing, based on the path switch request message, the path switch operation in association with a second network node. In some aspects, the means for the core network to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a first network node (e.g., the network node 110) may include means for communicating with a user equipment (UE) during an active state of the UE in accordance with a first UE configuration, wherein the first network node comprises a first non-terrestrial network (NTN) network node; and/or means for performing, associated with a second NTN network node and based on a determination that the first NTN is moving out of a radio access network (RAN) notification area (RNA), an access stratum (AS) context relocation operation associated with the second NTN network node. The means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a second network node (e.g., the network node 110) may include means for performing, associated with a first non-terrestrial network (NTN) network node and based on a determination that the first NTN is moving out of a radio access network (RAN) notification area (RNA), an access stratum (AS) context relocation operation associated with the second network node, the second network node comprising a second NTN network node; and/or means for communicating, based on the AS context relocation operation, with at least one of a user equipment (UE) or a third NTN network node. The means for the second network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

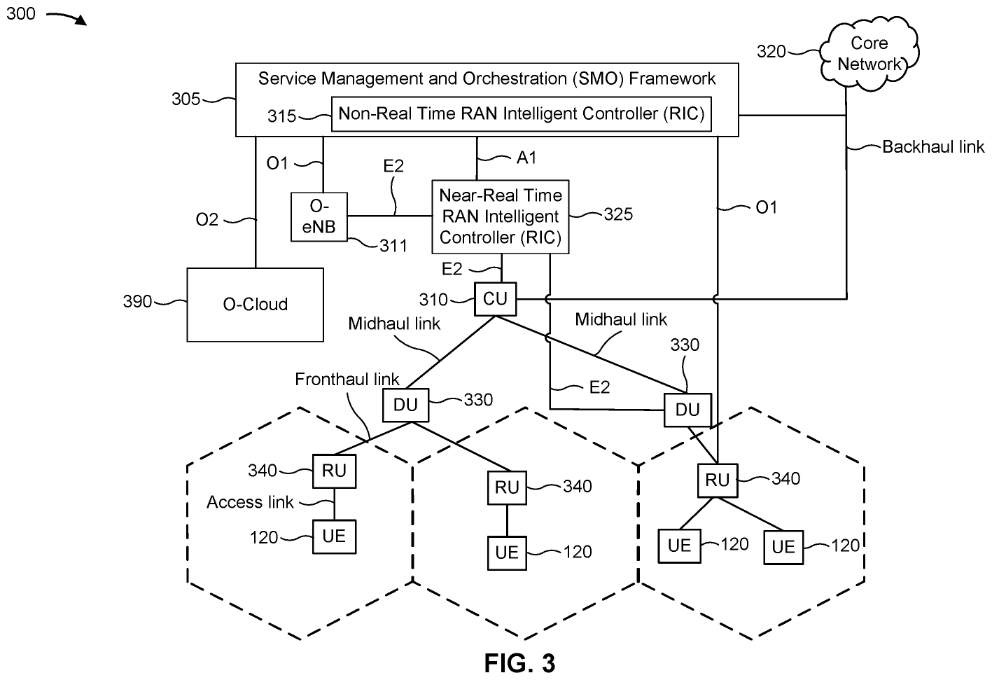

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

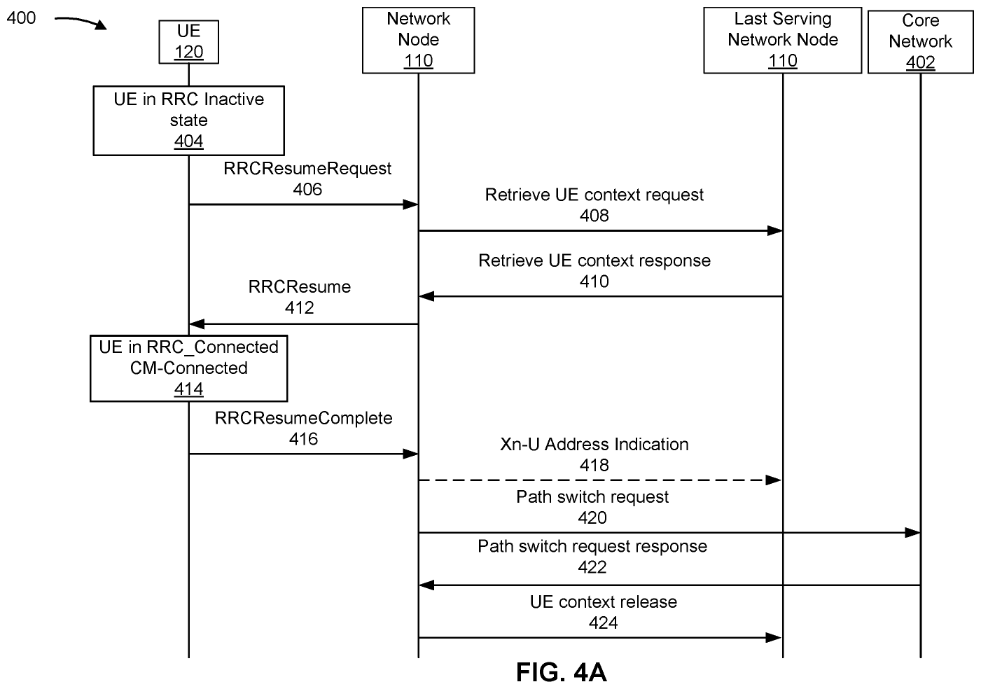

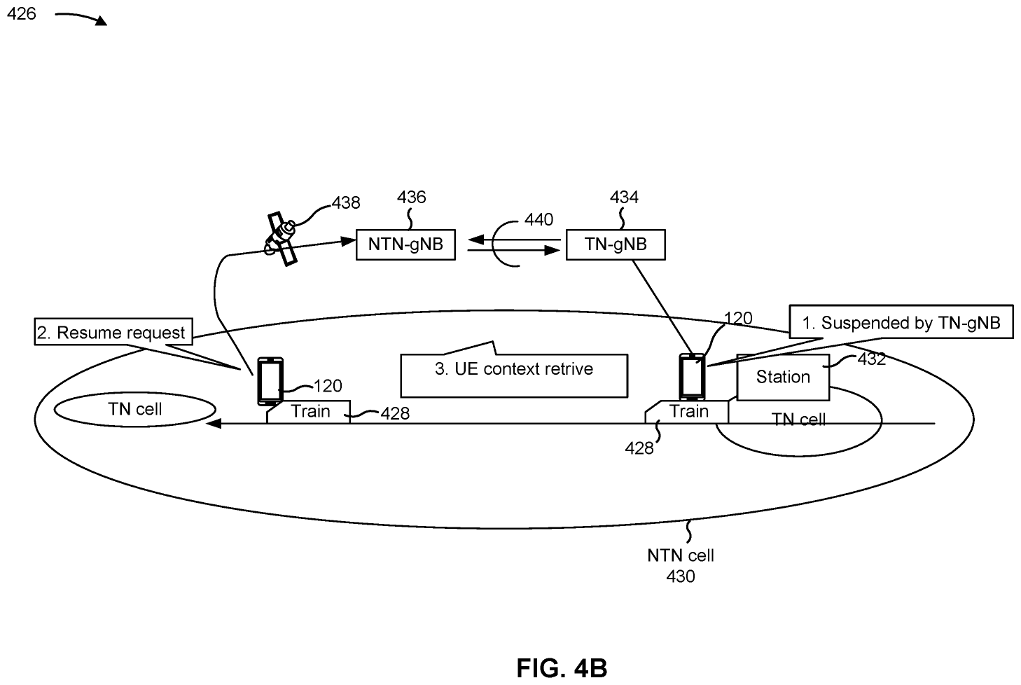

FIG. 4A illustrates an example 400 of a wireless network (e.g., wireless network 100) in which a UE (e.g., a UE 120) may support radio resource control (RRC) communication modes, in accordance with the present disclosure. The UE 120 may be communicatively connected with one or more network nodes 110 in the wireless network. The one or more network nodes 110 may be communicatively connected to a core network 402 (e.g., a 5G core access and mobility management function (AMF)). For example, the UE 120 may be connected to the one or more network nodes 110 in a dual connectivity configuration. In this case, a first network node 110 may serve the UE as a primary node and a second network node 110 may serve the UE as a secondary node. In some aspects, the UE 120 may support a connected communication mode (e.g., an RRC active mode, which may be referred to herein as an “active state”), an idle communication mode (e.g., an RRC idle mode), and an inactive communication mode (e.g., an RRC inactive mode, which may be referred to herein as an “inactive state”). RRC inactive mode may functionally reside between RRC active mode and RRC idle mode.

The UE 120 may transition between different modes (e.g., states) based at least in part on various commands and/or communications received from the one or more network nodes 110. For example, the UE may transition from RRC active mode or RRC inactive mode to RRC idle mode based at least in part on receiving an RRCRelease communication. As another example, the UE 120 may transition from RRC active mode to RRC inactive mode based at least in part on receiving an RRCRelease with suspendConfig communication. As another example, the UE 120 may transition from RRC idle mode to RRC active mode based at least in part on receiving an RRCSetupRequest communication. As another example, the UE 120 may transition from RRC inactive mode to RRC active mode based at least in part on receiving an RRCResumeRequest communication.

When transitioning to RRC inactive mode, the UE 120 and/or the one or more network nodes 110 may store a UE context (e.g., an access stratum (AS) context and/or higher-layer configurations). This permits the UE and/or the one or more network nodes 110 to apply the stored UE AS context when the UE transitions from RRC inactive mode to RRC active mode in order to resume communications with the one or more network nodes 110, which reduces latency of transitioning to RRC active mode relative to transitioning to the RRC active mode from RRC idle mode.

In some cases, the UE 120 may communicatively connect with a new primary node when transitioning from RRC idle mode or RRC inactive mode to RRC active mode (e.g., a primary node that is different from the last serving primary node when the UE transitioned to RRC idle mode or RRC inactive mode). In this case, the new primary node may be responsible for identifying a secondary node for the UE 120 in the dual connectivity configuration.

In some aspects, the inactive state (e.g., RRC inactive mode) may save UE 120 battery power while keeping a short connection establishment delay. The UE 120 and network node 110 maintain UE AS context even when an RRC connection is released. When the RRC connection is resumed, the UE 120 and network node 110 may use the UE AS context to establish RRC connection again, which can reduce several steps otherwise required in a traditional RRC connection establishment procedure.

As shown by reference number 404, the UE 120 may be in an RRC inactive state and, as shown by reference number 406, the UE 120 may transmit an RRC resume request message to the network node 110. The RRC resume request message may include an inactive radio network temporary identifier (I-RNTI), allocated by the last serving network node 110. As shown by reference number 408, the network node 110 may transmit a retrieve UE context request to the last serving network node 110. For example, the network node 110 may transmit the request if the network node 110 is able to resolve the network node identity contained in the I-RNTI. As shown by reference number 410, the last serving network node 110 may provide the UE AS context in a retrieve UE context response. As shown by reference number 412, the network node 110 may transmit an RRC resume message to the UE 120, which may enter an RRC connected state 414 and transmit, as shown by reference number 416, an RRC resume complete message to the network node 110.

If loss of downlink user data buffered in the last serving network node 110 is to be prevented, the network node 110 may provide an Xn-U address indication (e.g., an indication of forwarding addresses) to the last serving network node 110, as shown by reference number 418. As shown by reference number 420, the network node 110 may transmit a path switch request to the core network 402 to perform a path switch and, as shown by reference number 422, the core network 402 may transmit a path switch request response to the network node 110. As shown by reference number 424, the network node 110 may transmit a UE context release message to the last serving network node 110, triggering the release of the UE resources as the last serving network node 110.

FIG. 4B is a diagram illustrating an example 426 of NTN operations in accordance with the present disclosure. Example 426 illustrates aspects of Scenario 1 described above. As shown, a UE 120 may be associated with a train 428. For example, the UE 120 may be implemented in association with the train 428 or transported on a train that carries a user associated with the UE 120. The UE 120 may be moving within an NTN cell 430. In some aspects, the NTN cell 430 may have a large coverage and, thus, a stored AS context can be valid in a wide area. The power savings gain from utilizing a UE inactive state can be larger in an NTN than in a terrestrial network (TN) due to a longer over the air (OTA) delay in the NTN. In sparse TN deployment overlapping with NTN coverage, the UE 120 can be within the NTN cell 430 and, as a result, an RRC resume procedure can be performed within the NTN coverage.

Example 426 illustrates an example of Scenario 1 in which, while at a train station 432, a user uses the UE 120 while the UE 120 is connected to a terrestrial network node (shown as “TN-gNB”) 434. As the train 428 leaves the train station 432, the UE 120 is suspended (as shown by “1”) with TN-gNB AS context. After the train 428 has left the station 432, if the user attempts to use the UE 120, since there is no TN coverage, the UE 120 can try to resume (as shown by “2”) to an NTN network node (shown as “NTN-gNB”) 436, which may be implemented on a non-terrestrial vehicle 438. The NTN-gNB 436 can trigger a UE context retrieve procedure (as shown by “3”) to the TN-gNB 434.

Some aspects of the techniques described herein may include UE operations for inactive state associated with NTNs (e.g., to facilitate mitigation of data transmission and/or reception delay as a UE moves between TN coverage areas). In some aspects, for example, when a UE transitions to a UE inactive state, a network node may perform a UE inactive AS context relocation operation and a path switch operation to another network node to which the UE may connect. In example 426, when the UE 120 transitions to an inactive state (e.g., when the UE 120 is suspended), as shown by reference number 440, the TN-gNB 434 may relocate the UE AS context and perform a path switch operation to switch the path to NTN-gNB 436. If the UE 120 attempts to resume connectivity to TN-gNB 434, the TN-gNB 434 may perform a UE context retrieve procedure. Due to performing the AS context relocation and path switch, when the UE 120 resumes, the network node connecting to the UE 120 does not need to perform a UE inactive AS context retrieve and path switch from the last network node. In this way, some aspects may facilitate mitigating data transmission and/or reception delay.

Some wireless communication standards can require a UE to receive an RRC resume message that includes configuration information to be applied by the UE to resume U-plane data transmission in TNs and/or NTNs. In some aspects of the techniques described herein, a UE may be provided with a set of dedicated configurations for multiple cells when the UE transitions to an inactive state, each dedicated configuration corresponding to a respective cell of the multiple cells. When the UE resumes to an active state, the UE may apply the corresponding configuration for the cell to which the UE is resuming to the active state. In this way, U-plane data transmissions may be resumed even prior to the UE receiving an RRC resume message, thereby making travel between different cells more efficient and mitigating the risk of lost communications and unnecessary gaps in connectivity. In some aspects, the UE may identify the corresponding configuration based on the linkage of a cell identifier and the configuration. In some aspects, a restriction may be placed on a length of a list, stored at the UE, of cells for which corresponding dedicated configurations may be stored in the UE. In some other aspects, the restriction may be placed on the number of dedicated configurations that may be stored in the UE. For example, in some aspects, the restriction may restrict the number of cells and/or corresponding dedicated configurations to 4, 8, 16, or 64, among other examples. In some aspects, the restriction and/or the number of dedicated configurations stored in the UE may be based on a UE capability. In some aspects, one or more aspects of techniques described herein for storing multiple dedicated configurations may be combined with one or more aspects of techniques described herein for performing UE AS context relocation operations and/or path switch operations.

As indicated above, FIG. 4 is provided as an example. Other examples may differ from what is described with regard to FIG. 4.

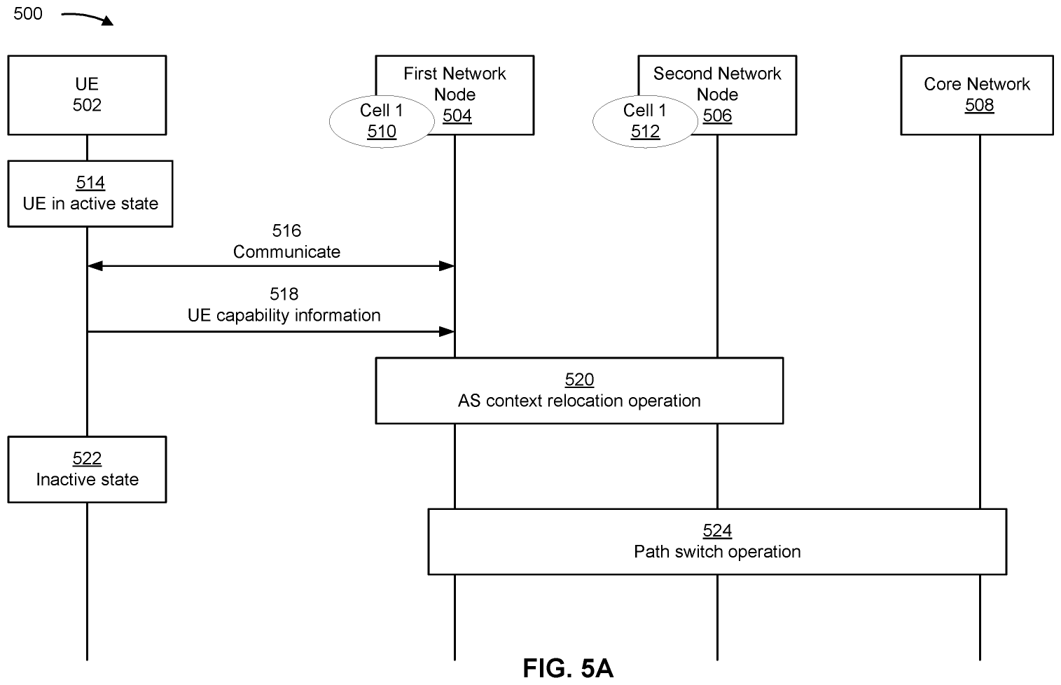

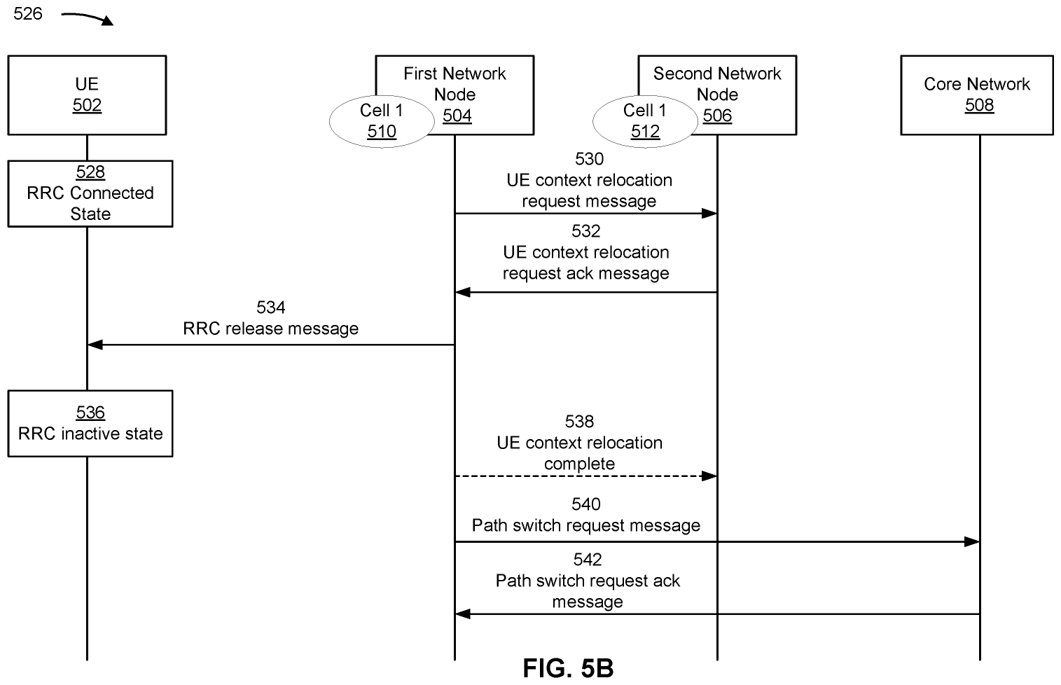

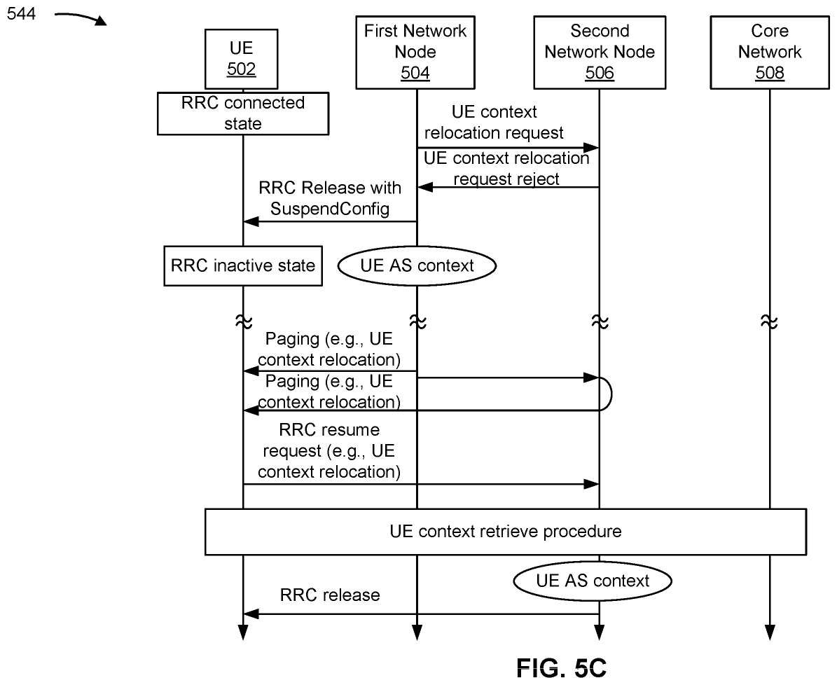

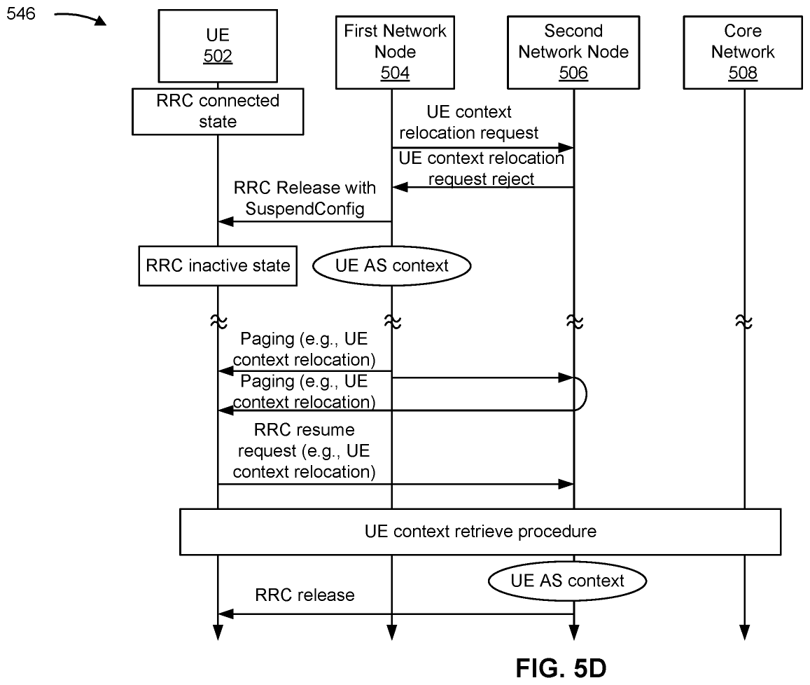

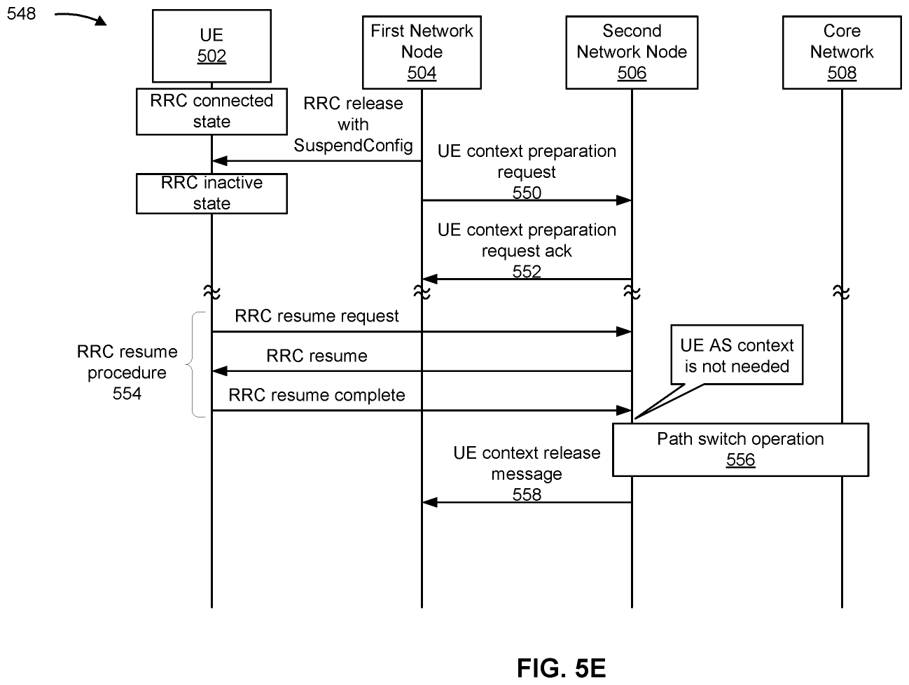

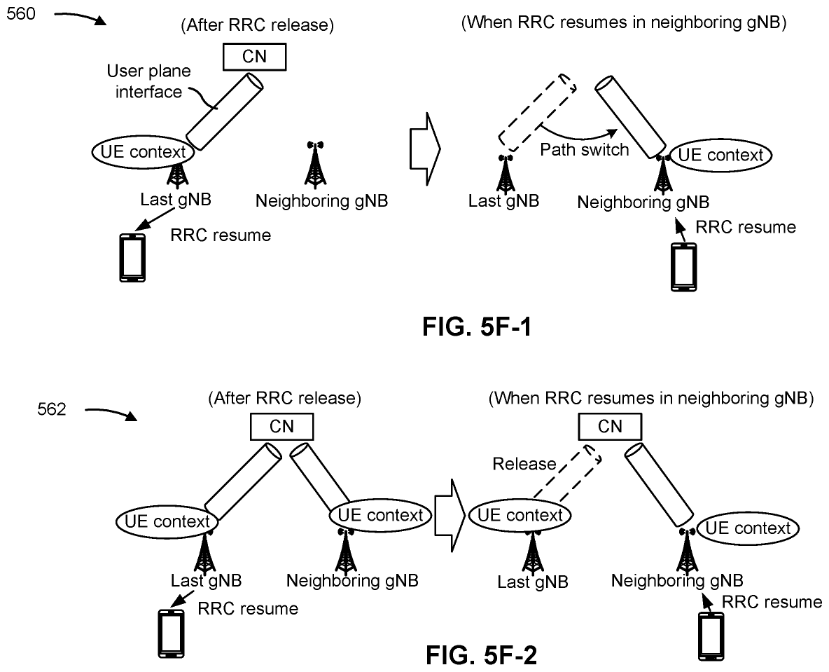

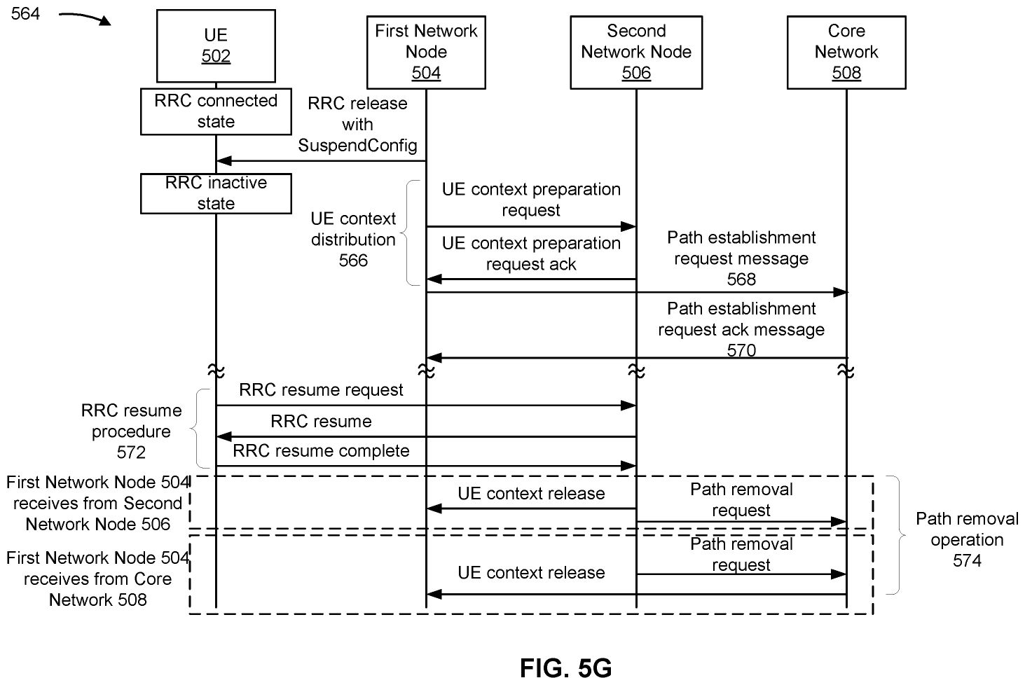

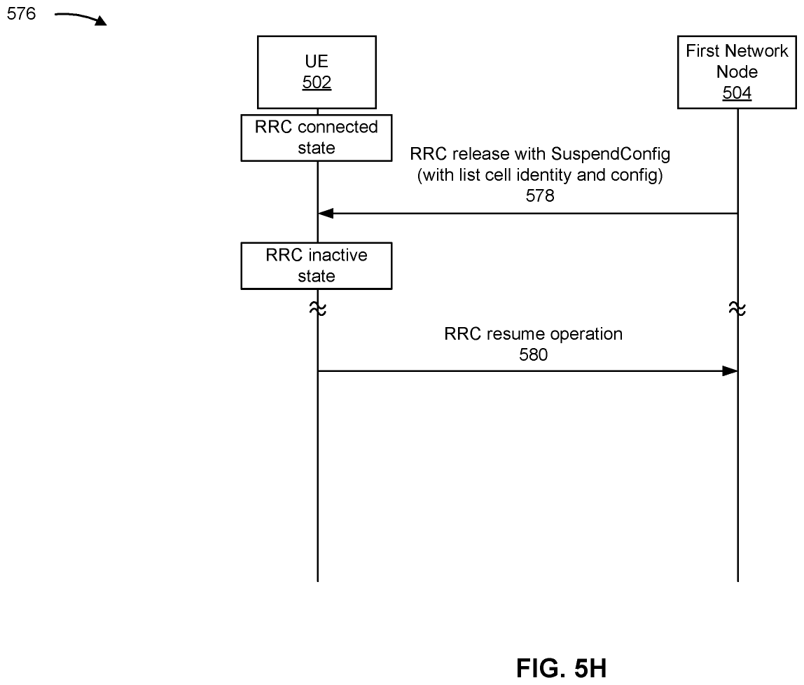

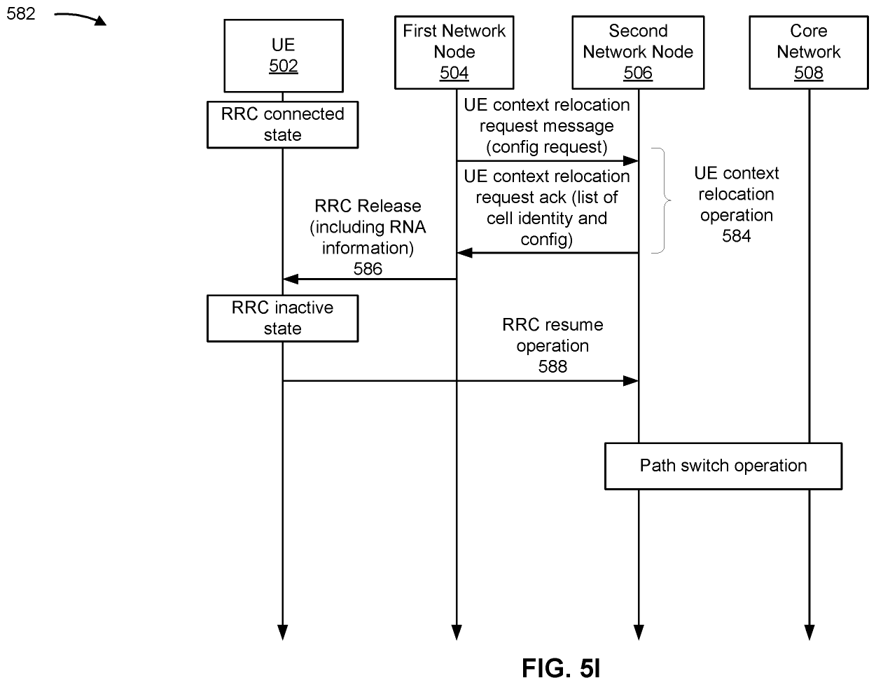

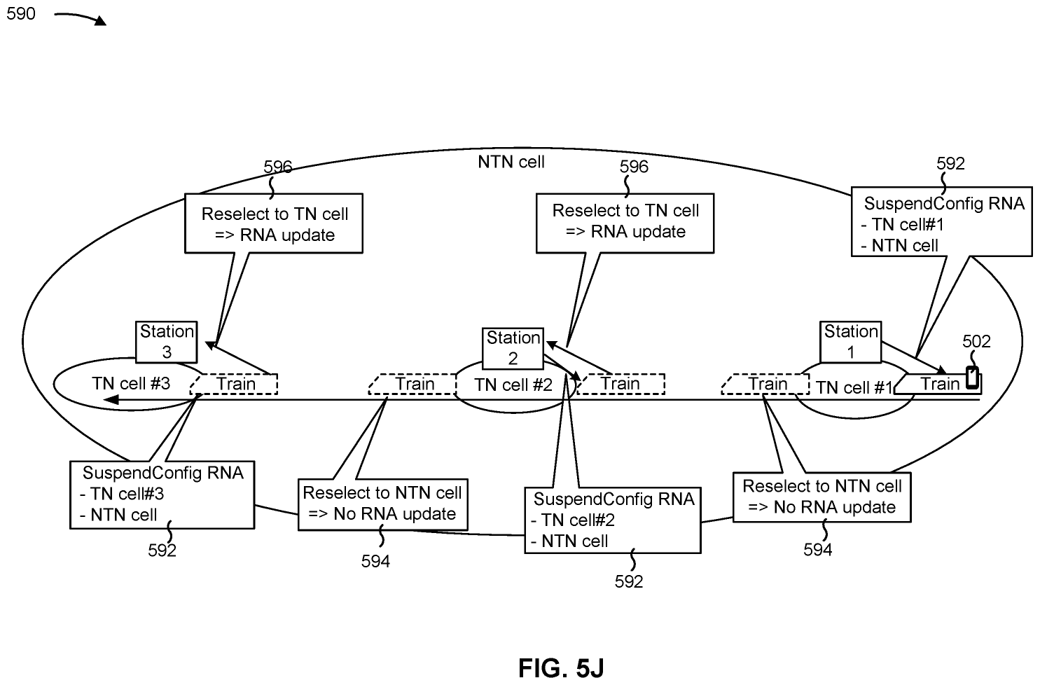

FIGS. 5A-5J are diagrams illustrating examples associated with inactive UE operations for non-terrestrial networks in accordance with the present disclosure.

FIG. 5A is a call flow diagram illustrating an example 500 associated with inactive UE operations in accordance with the present disclosure. As shown, a UE 502 may communicate with a first network node 504 and a second network node 506. The first network node 504 and the second network node 506 may communicate with a core network 508. The core network 508 may include any number of network nodes. The first network node 504 may provide a first cell 510 (shown as “cell 1”) and the second network node 506 may provide a second cell 512 (shown as “cell 2”). In some aspects, the first network node 504 and/or the second network node 506 may be a terrestrial network node or a non-terrestrial network node.

As shown by reference number 514, the UE 502 may be in an active state (e.g., an RRC connected state) with respect to the first network node 504. For example, the UE 502 may be in an active state in accordance with a first UE configuration. As shown by reference number 516, the UE 502 may communicate with the first network node 504 while in the active state. As shown by reference number 518, the UE 502 may transmit, and the first network node 504 may receive, UE capability information. The UE capability information may indicate one or more capabilities of the UE 502 associated with one or more aspects of the inactive UE operations described herein. As shown by reference number 520, the first network node 504 and the second network node 506 may perform an AS context relocation operation to relocate the UE AS context to the second network node 506. As shown by reference number 522, the UE 502 may enter an inactive state (e.g., an RRC inactive state) and as shown by reference number 524, the first network node 504, the second network node 506, and the core network 508 may perform a path switch operation associated with the second network node 506.

FIG. 5B is a call flow diagram illustrating an example 526 of a technique for inactive UE operations associated with aspects of Scenario 1 described above.

As shown by reference number 528, the UE 502 may be in an active state (e.g., an RRC connected state) with respect to the first network node 504. As shown by reference number 530, the first network node 504 may transmit, and the second network node 506 may receive, a UE context relocation request message. For example, in some aspects, when the first network node 504 decides to transition the UE 502 to an inactive state, the first network node 504 may transmit the UE context relocation request message to the second network node 506 to relocate UE AS context to the second network node 506. In some aspects, the first network node 504 may be configured to trigger the AS context relocation operation based on a UE inactive timer expiry and/or any number of other trigger conditions implemented at the first network node 504.

In some aspects, the first network node 504 may select the second network node 506 to be a target network node based on a target selection parameter. For example, in some aspects, the target selection parameter may be associated with a UE capability such as, for example, a supported frequency band, a supported content network type and/or a supported RAT. In some aspects, the target selection parameter may be associated with a location of the UE 502, a connection history of the UE 502, a velocity of the UE 502, a type of the UE 502, and/or a measurement report from the UE 502, among other examples. In some aspects, the target selection parameter may be associated with a network load associated with the first network node 504, the second network node 506, and/or an additional network node. In some aspects, each network node may share its load status with each other network node.

In some aspects, the UE context relocation request message may include at least one of an indication of a UE capability, an inactive radio network temporary identifier (RNTI) (I-RNTI) associated with the first network node 504, a second UE configuration, or a security parameter. The security parameter may include a security key (e.g., K_RRC,int, {KgNB, NCC}), a physical cell identifier (PCI), a cell-RNTI (C-RNTI) associated with the first network node 504, or a downlink absolute radio frequency channel number (EARFCN-DL) associated with the first network node 504.

As shown by reference number 532, the second network node 506 may transmit, and the first network node 504 may receive, a UE context relocation request acknowledgement (ack) message. For example, if the second network node 506 admits the request, the second network node 506 may send the UE context relocation request ack message to the first network node 504. The UE context relocation request acknowledgement message may include a C-RNTI associated with the second network node 506 and/or a second UE configuration, among other examples. The second UE configuration may be provided as a full configuration and/or a configuration delta (e.g., a difference between the second UE configuration and the first UE configuration). In some aspects, the configuration information (e.g., the information conveying the second configuration) may be multiplexed in an RRC release message and/or included in an RRC reconfiguration message, which may be multiplexed with the RRC release message in an RRC layer, a packet data convergence protocol (PDCP) layer, a radio link control (RLC) layer, a medium access control (MAC) layer or a physical layer.

In some aspects, if the second network node 506 cannot admit the request, the second network node 506 may transmit a UE context relocation reject message instead of the UE context relocation request acknowledgement message. In this case, the second network node 506 may include a cause value in the UE context relocation reject message. In some aspects, if the first network node 504 cannot receive the UE context relocation request acknowledgement message, the first network node 504 may transmit a request cancel message.

As shown by reference number 534, the first network node 504 may transmit, and the UE 502 may receive, an RRC release message. For example, the first network node 504 may provide the RRC release message based on obtaining the UE context relocation request acknowledgement message. In some aspects, providing the RRC release message may include multiplexing the RRC release message with an RRC reconfiguration message in at least one of an RRC layer, a PDCP layer, an RLC layer, a MAC layer, or a physical layer. In some aspects, the UE context relocation request message may include a configuration list request, the UE context relocation request acknowledgment message may include a cell identity associated with the second network node 506, and the RRC release message may include a cell identity list including the cell identity associated with the second network node 506 and a configuration list including a second UE configuration associated with the second network node 506. In some aspects, the first network node 504 may receive at least one additional cell identity associated with at least one additional network node and at least one additional configuration associated with the at least one additional network node, and the cell identity list may include the at least one additional cell identity and the configuration list may include the at least one additional configuration. In some aspects, at least one of the cell identity list or a RAN notification area (RNA) list, included in the RRC release message, may include RNA information.

As shown by reference number 536, the UE 502 may transition to an RRC inactive state. For example, if the UE 502 receives the RRC release message, the UE 502 may apply the second configuration and transition to the RRC inactive state. As shown by reference number 538, in some aspects, the first network node 504 may transmit, and the second network node 506 may receive, a UE context relocation complete message. In some aspects, the first network node 504 may provide the UE relocation complete message based on a complete message condition being satisfied. In some aspects, the complete message condition may be satisfied based on the first network node 504 receiving, from the UE 502, a layer 2 acknowledgment communication (e.g., a hybrid automatic repeat request (HARQ) acknowledge (ACK) or an RLC ACK). In some aspects, the complete message condition may be satisfied based on an expiry of a timer that has a start time associated with providing the RRC release message. In some aspects, the UE relocation complete message may indicate a UE identifier associated with the UE 502.

As shown by reference number 540, the first network node 504 may provide, and the core network 508 may obtain, a path switch request message. As shown by reference number 542, the core network 508 may provide, and the first network node 504 may obtain, a path switch request acknowledgment message. For example, the first network node 504 may perform a path switch operation and then release the UE AS context. In some aspects, the path switch operation may be performed before providing the RRC release message, in which case the UE AS context may be released after providing the RRC release message. In some aspects, the path switch operation may be performed before providing the UE context relocation complete message, in which case the UE AS context may be released after providing the UE context relocation complete message. In some aspects, the first network node 504 may provide the path switch request message based on a completion of the AS context relocation operation. In some aspects, the path switch request message may indicate at least one of a network node identifier associated with the second network node 506, a tunnel endpoint identifier, or a UE context relocation cause.

In some aspects, performing the AS context relocation operation may include performing the AS context relocation operation during an inactive state of the UE 502. In an example scenario, the first network node 504 may be a terrestrial network node and the second network node 506 may be an NTN network node. The first network node 504 may request UE context relocation to the second network node 506 but the request may be rejected due to congestion. The first network node 504 may give up relocation and transition the UE 502 to an inactive state, keeping the UE AS context at the first network node 504. After some time, the first network node 504 may determine to try the UE context relocation operation again (e.g., by detecting that the congestion associated with the second network node 506 is resolved based on load information shared by the second network node 506) and may trigger paging to the UE 502 (with a cause value set to, e.g., UE context relocation, RNA update, or UE location confirm).

FIG. 5C is a flow diagram illustrating an example 544 of a first case, in which the UE 502 resumes to the second network node 506. In the first case, if the UE 502 resumes to the second network node 506 (with cause value set to, e.g., UE context relocation, RNA update, or UE location confirm), the second network node 506 may derive the UE AS context from the first network node 504 using an RRC resume procedure and then may transition the UE 502 to inactive state again.

FIG. 5D is a flow diagram illustrating an example 546 of a second case, in which the UE 502 resumes to the first network node 504. In the second case, if the UE 502 resumes to the first network node 504 (with cause value set as in the first case), the first network node 504 may trigger a UE context relocation procedure to the second network node 506. During the UE context relocation operation, the UE 502 may maintain an inactive state (e.g., the UE 502 may receive RRC release after it transmits an RRC resume request to the first network node 504) or the UE 502 may transition to an RRC connected state (e.g., the UE 502 may receive RRC resume/setup after it transmits an RRC resume request to the first network node 504, after which the UE 502 may receive RRC release again).

In some cases, even after a first network node performs a UE AS context relocation to relocate the UE AS context to a second network node, a situation can arise in which a network node performs a UE context retrieve operation subsequent to receiving an RRC resume request from the UE. For example, in some cases, the UE might attempt to resume connection to the cell provided by the first network node, in which case the first network node can perform a UE context retrieve procedure to retrieve the relocated UE AS context from the second network node. In some other cases. For example, while the UE AS context is relocated from the first network node 504 to the second network node 506 during transition of the UE 502 to the RRC inactive state, the UE 502 may be located within another network node's coverage area (e.g., the first network node 504 or a third network node).

Some aspects of the techniques described herein may include storing the UE AS context at multiple network nodes, thereby mitigating the need for the UE retrieve operation. For example, in some aspects, the first network node 504 may maintain a UE AS context associated with the UE 502 subsequent to performing the UE AS context relocation operation. In this way, if the UE attempts to resume active connection to the first network node instead of the second network node, the first network node is already prepared and does not need to introduce additional delay by performing a UE context retrieve operation. Similarly, if the first network node relocates the UE AS context to a third network node in addition to the second network node, the third network may not need to perform a UE context retrieve operation if the UE attempts to resume active connection to the third network node. In some aspects, a user and/or control-plane interface may be maintained only in the last network node to which the UE was connected or in multiple network nodes.

FIG. 5E is a flow diagram illustrating an example 548 associated with maintaining UE AS context in multiple network nodes in accordance with the present disclosure. For example, after the UE 502 is inactive state, the last network node (e.g., the first network node 504) may distribute the UE AS context with I-RNTI to the neighboring gNB(s), including the second network node 506. In example 548, the user plane interface (NG-U) may be associated with the first network node 504. In some aspects, the distribution of the UE AS context may be performed even before the first network node 504 sends RRC release. In some aspects, the distribution of the UE AS context may be transparent to the UE 502.

As shown by reference number 550, the first network node 504 may provide, to at least one neighboring network node (e.g., the second network node 506), a UE context preparation request message. The UE context preparation request message may include the UE AS context and an I-RNTI. As shown by reference number 552, the second network node 506 may provide, and the first network node 504 may obtain, a UE context preparation request acknowledgment message. As shown by reference number 554, the UE 502 and the second network node 506 may perform an RRC resume procedure. As shown by reference number 556, the second network node 506 and the core network 508 may perform a path switch operation and, as shown by reference number 558, the second network node 506 may provide, and the first network node 504 may obtain, a UE context release communication message.

In some aspects, when the first network node 504 receives the UE context release, it may ask the other neighboring network nodes to release the UE AS context. In some other aspects, the second network node 506 may send UE context release messages to all the relevant network nodes which stored the same UE AS context. The first network node 504 may provide the list of relevant network nodes. Otherwise, the second network node 506 may blindly send UE context release messages to all the possible network nodes.

In some aspects, the UE context preparation request message may include a configuration list request. The UE context preparation request acknowledgment message may include a cell identity associated with the second network node 506, and the RRC release message may include a cell identity list that includes the cell identity associated with the second network node 506 and a configuration list that includes a second UE configuration associated with the second network node 506. In some aspects, the first network node 504 may obtain at least one additional cell identity associated with at least one additional network node and at least one additional configuration associated with the at least one additional network node, and the cell identity list may include the at least one additional cell identity and the configuration list may include the at least one additional configuration.

After the UE 502 is in an inactive state, the first network node 504 may distribute the UE AS context with I-RNTI to the neighboring network nodes and the user plane interface may also be established between neighboring network nodes and the core network 508. This distribution may be performed even before the first network node 504 sends RRC release and may be transparent to the UE 502.

FIG. 5F is a diagram illustrating examples associated with maintaining multiple user plane interfaces, in accordance with the present disclosure. As shown by reference number 560, in some aspects, a user plane interface may be maintained only in the last network node and as shown by reference number 562, in some other aspects, the user plane interface may be maintained in multiple network nodes. In the example of 562, since the user plane interface path is already established in the possible network nodes to which the UE 502 may connect, delay due to path switch can be eliminated even if the inactive state UE 502 moves around between the different network nodes. In some aspects, the last network node or the core network may establish the additional user plane interfaces.

FIG. 5G is a diagram illustrating an example 564 associated with maintaining multiple user plane interfaces, in accordance with the present disclosure. As shown by reference number 566, the first network node 504 may distribute the UE AS context to the neighboring network nodes (including the second network node 506). As shown by reference number 568, the first network node 504 may provide, and the core network 508 may obtain, a path establishment request message. The path establishment request message may be for establishing a second user plane interface, associated with the UE 502, between the core network 508 and the second network node 506. As shown by reference number 570, the core network 508 may provide, and the second network node 506 may obtain, a path establishment request acknowledgment message associated with the second user plane interface. As shown by reference number 572, the UE 502 and the second network node 506 may perform an RRC resume procedure. As shown by reference number 574, a path removal request operation may be performed. For example, the second network node 506 may provide, and the core network 508 may obtain, a path removal request. The core network 508 or the second network node 506 may provide a UE context release message to the first network node 504. In some aspects, the RRC release may be performed based on a timer which starts upon path establishment.

In some aspects, if the core network 508 has U-plane paths with multiple network nodes, some aspects may provide for techniques for sending downlink data from the core network 508 to the first network node 504 and/or the second network node 506. In some aspects, for example, the downlink (DL) U-plane packets may be duplicated by the core network and sent to all or some of the network nodes. This duplication may be done until the path release is completed for the second network node 506. In some aspects, the DL U-plane packets may be assigned with a sequence number (SN). The SN may facilitate duplication detection by the UE 502. In some aspects, the core network 508 may assign the SN and add it in a header of a dedicated protocol (e.g., an internet protocol (IP) packet may be encapsulated by a dedicated protocol layer). The UE 502 also may include a reception side of the dedicated protocol layer for duplication detection. In some aspects, the core network 508 may assign the SN and inform the network nodes of it, e.g., in an NG-U protocol header. The RAN protocol may include the SN in a header (e.g., service data adaptation protocol (SDAP) header or PDCP header). In some aspects, a network node (e.g., a RAN node) may assign the SN and include it in a header (e.g., SDAP header or PDCP header).

In some aspects, DL packet duplication in the core network means multiple network nodes receive DL data and trigger RAN paging to each other. In some aspects, only specific network nodes may trigger RAN paging (e.g., only the last network node). In some aspects, all the network nodes may trigger RAN paging, and the recipient node may perform paging several times. In some aspects, if the network node has already triggered paging for the UE (e.g., based on DL data arrival to the network node from the core network or receiving RAN paging indication from another network node), the subsequent RAN paging indications may be discarded and/or ignored.

In some wireless communication standards, the UE may be required to receive an RRC resume message to resume U-plane data transmission, which may take time within an NTN environment. In some aspects, as shown in FIG. 5H, the UE may be provided with dedicated configurations for multiple cells when the UE goes to inactive state. When the UE attempts to resume to a connected state, the UE may apply the corresponding configuration for the cell to which the UE is resuming to a connected state. The UE may identify the corresponding configuration based on the linkage of cell identity and configuration. For example, the last network node may provide the UE with a list of cell identities and configurations in an RRC release message with a suspended configuration. The UE may trigger a resume operation and apply the configuration corresponding to the serving cell, if included in the provided list. Then, the UE may send and RRC message (e.g., resume request, RRC resume completion or RRCreconfiguration complete) and may start transmitting U-plane data immediately. Dedicated resources such as contention based random access (CBRA) resources, random access message resources (e.g., msgA resources), and/or dedicated scheduling request (SR) resources may reduce uplink transmission delay. For improved resource efficiency, the UE may release the resources upon expiry of a timer which starts when the UE receives the configuration. The UE may autonomously transition to the RRC connected state. The RRC message may be transmitted via a dedicated control channel (DCCH) (e.g., a signalling radio bearer #1 (SRB1)). It the serving cell is not included in the list, or the serving cell included in the list broadcasts to fallback to a legacy resume procedure, the UE may apply an legacy RRC resume procedure. FIG. 5H illustrates an example of the above combined with UE context relocation the storing of UE AS context at multiple network nodes.

FIG. 5H is a flow diagram illustrating an example 576 associated with RNA information handling, in accordance with the present disclosure. In the example 576, the UE 502 may be provided with a dedicated configuration for multiple cells when the UE 502 transitions to inactive state. When the UE 502 attempts to resume to a connected state, the UE 502 may apply the corresponding configuration for the cell to which the UE 502 is attempting to resume connection. The UE 502 may identify the corresponding configuration based on the linkage of cell identity and configuration. In some aspects, a restriction may be placed on a length of a cell identity list. For example, the cell identity list may include 4, 8, 16, or 64 cells based on a UE capability.

As shown by reference number 578, the first network node 504 may provide, and the UE 502 may obtain, an RRC release message that includes RNA information. The RNA information may include a cell identity list and a list of UE configurations associated with the cells identified in the cell identity list. As shown by reference number 580, the UE 502 may perform an RRC resume operation. In some aspects, the UE 502 may apply the configuration corresponding to a cell provided by the first network node 504. For example, the UE 502 may apply the configuration based on the configuration being included in the RNA information. To perform the RRC resume operation, the UE 502 may provide an RRC message (e.g., an RRC resume request message, an RRC resume completion message, or an RRC reconfiguration complete message) and may start transmitting U-plane data immediately. In some aspects, dedicated resources such as CBRA resources, random access message resources (e.g., msgA resources), and/or dedicated SR resources may be used to reduce uplink transmission delay. For improved resource efficiency, the UE may release the resources upon expiry of timer which starts when the UE receives the configuration.

In some aspects, the UE 502 may autonomously transition to an RRC connected state. The RRC message may be transmitted via a dedicated control channel (DCCH) (e.g., a signaling radio bearer (SRB) 1). If the serving cell is not included in the list, or the serving cell included in the list broadcasts to fallback to a legacy resume procedure, the UE 502 may apply the legacy RRC resume procedure. In some aspects, the techniques described above for providing RNA information may be combined with techniques described herein for performing UE AS context relocation and/or storing UE AS context in multiple network nodes.

FIG. 5I is a flow diagram illustrating an example 582 associated with the RNA information handling techniques described above and implemented in combination with UE AS context relocation techniques and techniques for maintaining UE AS context in multiple network nodes, in accordance with the present disclosure. As shown by reference number 584, for example, the first network node 504 and the second network node 506 may perform a UE context relocation operation. In aspects in which the UE AS context is to be maintained at multiple network nodes, the first network node 504 and the second network node 506 may perform a UE context preparation operation in which the UE AS context is distributed to the second network node 506, while still being maintained at the first network node 504.

As shown, the UE context relocation operation may include the first network node 504 providing a UE context relocation request message to the second network node 506. The UE context relocation message may include a request for a configuration list (and/or other RNA information). The second network node 506 may provide a UE context relocation request ack message that includes a cell identity list and a configuration list. As shown by reference number 586, the first network node 504 may provide an RRC release message that includes the RNA information (e.g., the cell identity list and the configuration list). The UE 502 may store the RNA information and transition to the inactive state. As shown by reference number 588, the UE may perform an RRC resume operation associated with the second network node 506, applying the configuration received in the RNA information. A path switch operation may be performed and to perform the RRC resume operation, the UE 502 may provide an RRC message (e.g., an RRC resume request message, an RRC resume completion message, or an RRC reconfiguration complete message) and may start transmitting U-plane data immediately upon completion of the path switch operation.

In some cases, a UE may be configured with an RNA for inactive state. For example, an RRC Release message can include RNA information as a list of cells or a list of RAN area codes. The UE can trigger an RNA update periodically or when a selected cell is not in the list of configured RNA. In cases of sparse TN coverage, including an NTN cell in the RNA information may expand connectivity options for UEs, which may result in more consistent connectivity. Since NTN cell coverage may be large, a UE may not need to trigger RNA updates frequently, even if the UE is moving around. In some cases, however, a network may not be configured to include an NTN cell explicitly in RNA information in cases in which the RNA information may include a RAN area code (RA code) list due to the coarse granularity of the RA code list. In some cases, as a UE moves in and out of TN cell coverage areas that are within an NTN cell coverage area, the UE may trigger RNA updates due to reselection of TN cells that are not listed in current RNA information. In some other cases, the UE may trigger RNA updates due to a periodical update configuration.

Some aspects of the techniques described herein may include signalling RNA as a combination of an RA code list and a cell list. In this way, an NTN network node may be indicated in the cell list and, therefore, in the RNA information, enhancing the options for cell reselection available to the UE. In some aspects, RNA information updates may be triggered per cell, per cell type, or per-orbit type, thereby enabling less frequent RNA information update triggering in cases in which a UE is moving within an NTN coverage area (e.g., as described above in connection with Scenario 1).

FIG. 5J is a diagram illustrating an example 590 associated with RNA information updates, in accordance with the present disclosure. In the illustrated example 590, a UE 502 may be associated with a train (or other moving device such as a piloted vehicle and/or an unpiloted vehicle, among other examples) that moves from a first location (e.g., a first train station, a first town, a first roadside unit (RSU), and/or a first docking station, among other examples) (shown as “station 1”) associated with a first TN cell (shown as “TN cell #1”) to a second location (shown as “station 2”) associated with a second TN cell (shown as “TN cell #2”) and from the second location to a third location (shown as “station 3”) associated with a third TN cell (shown as “TN cell #3”). The cells deployed in each location may not be within the same RNA. In one or more examples, because TN frequencies may be prioritized over NTN frequencies for cell re-selection, when the train comes to a new location (e.g., with new TN cell coverage), the UE 502 may trigger an RNA information update even while the NTN cell is still available.

As shown by reference number 592, each time the UE begins to move out of a TN cell coverage area, the UE 502 may receive a suspend configuration RNA communication that includes RNA information associated with the current TN cell and an NTN cell. As the UE 502 leaves a location, as shown by reference number 594, the UE 502 may reselect to the NTN cell. In this case, no RNA update is needed, as the UE 502 has already stored RNA information associated with the NTN cell. However, as shown by reference number 596, each time the UE approaches a new location associated with a new TN cell coverage area, the UE 502 may reselect to the TN cell associated therewith and may receive RNA update information associated with the TN cell. In some aspects, a rule may be established in a wireless communication standard and/or via configuration that limits the cells that a UE may reselect. For example, in some aspects, the rule may cause the UE to not reselect a cell not included in current RNA information if the UE camps on a cell included in the RNA information, thereby potentially reducing the number of times that the UE triggers RNA information updates. In some aspects, RNA information updates may be triggered per cell, per cell type, or per-orbit type, thereby enabling less frequent RNA information update triggering in cases in which a UE is moving within an NTN coverage area. The rule may establish a list of prohibited cells, which may be cells that the UE 502 may be prohibited from reselecting (e.g., a first cell that is not indicated in current RNA information if the UE 502 camps on a second cell that is indicated in the current RNA information).

For example, the UE 502 may be prohibited from reselecting a first cell (e.g., TN cell #2) that is not indicated in current RNA information if the UE 502 camps on a second cell (e.g., the NTN cell) that is indicated in the current RNA information. If the UE 502 detects that the re-selected cell is the prohibited cell, then the UE 502 may re-select to the previous cell. In some aspects, the prohibition may apply to a limited set of combinations of the first cell and the second cell. For example, prohibition may apply only when the first cell is a TN cell and the second cell is an NTN cell, when the first cell is any cell and the second cell is an NTN cell, and/or when the first cell is any cell and the second cell is indicated by the network. The indication from the network may be provided with RNA information (e.g., in an explicit list of cell identities, an explicit list of RA codes, or a bitmap). In some aspects, the prohibition may be a hard prohibition or a soft prohibition. A hard prohibition refers to an explicit prohibition that the UE 502 must follow and the soft prohibition refers to a prohibition that causes the UE 502 to adjust cell reselection parameters such that the UE 502 is not likely to re-select the prohibited cell.

In some cases, as described above, when a UE is in an inactive state (e.g., an RRC inactive state), the UE 502 can periodically trigger RNA information updates based on a timer configured by the network (e.g., referred to as a “t380 timer”). In some cases, there can be a trade-off between UE battery consumption (and/or network signalling) and UE location precision. In some wireless communication standards, the t380 timer may be a per-UE timer and the same value can be applied regardless of cell type (e.g., regardless of whether the cell is a TN cell, an NTN cell, a geostationary equatorial orbit (GSO), or a non-geostationary orbit (NGSO)). Given that NTN coverage is large, if the UE 502 is in an NTN cell, the UE 502 does not need to trigger RNA update frequently, thereby reducing consumption of battery resources and signalling resources.

In some aspects, t380 timer signalling may be configured to be per-cell signalling and/or per-orbit type signalling. For example, a network node may provide configuration information to the UE 502 that is indicative of a per-cell RNA timer, a per-cell-type RNA timer, or a per-orbit-type RNA timer. In this way, for example, a timer associated with an NTN cell may be longer than a timer associated with a TN cell, since the UE 502 will not need RNA information updates as frequently when moving within an NTN cell. As a result, the timer may reduce battery and signalling resource consumption.

As indicated above, FIGS. 5A-5J are provided as examples. Other examples may differ from what is described with regard to FIGS. 5A-5J.

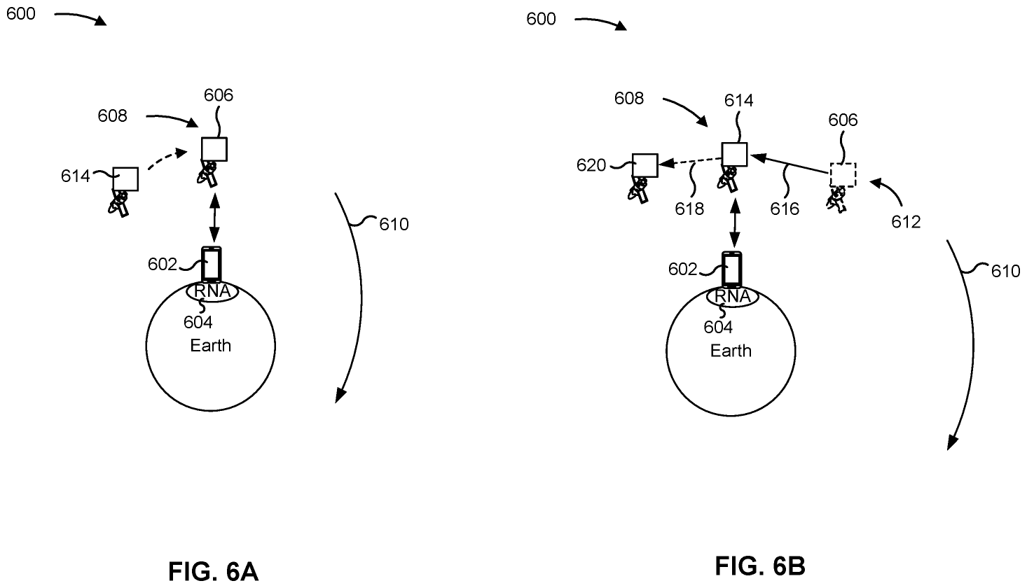

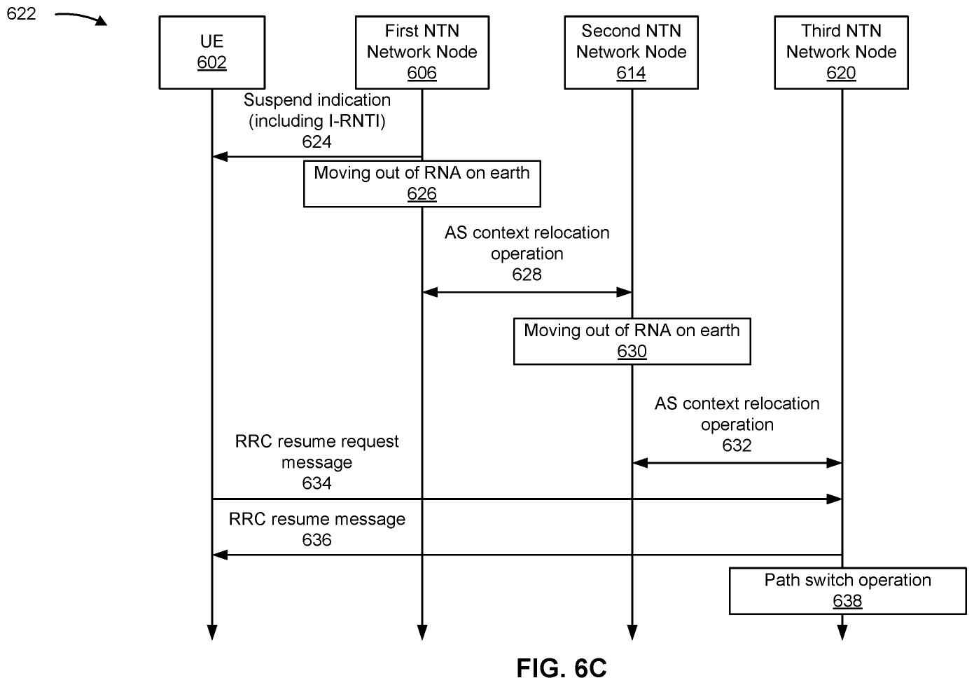

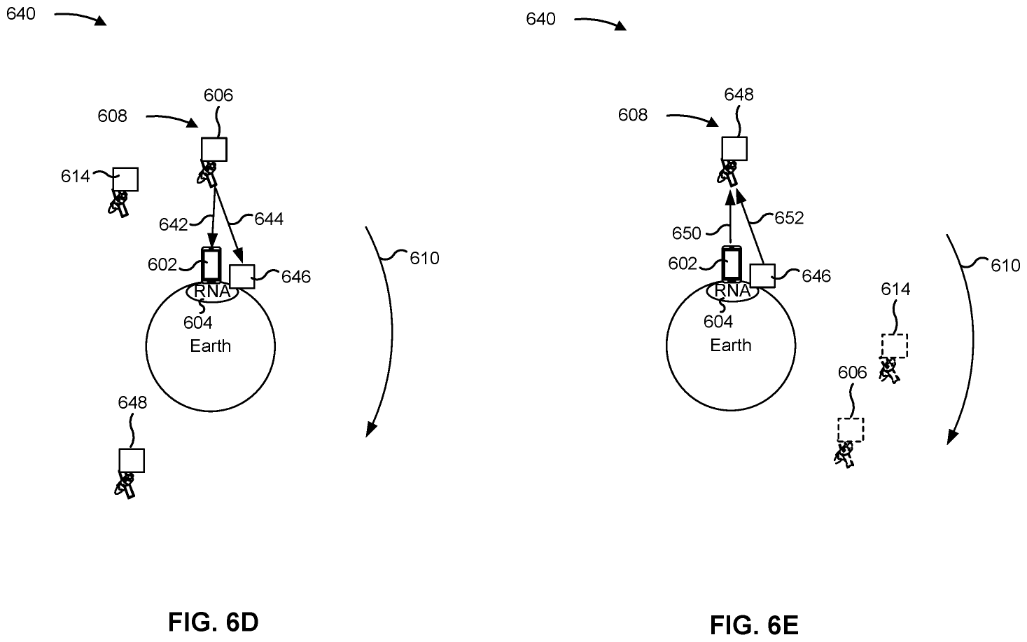

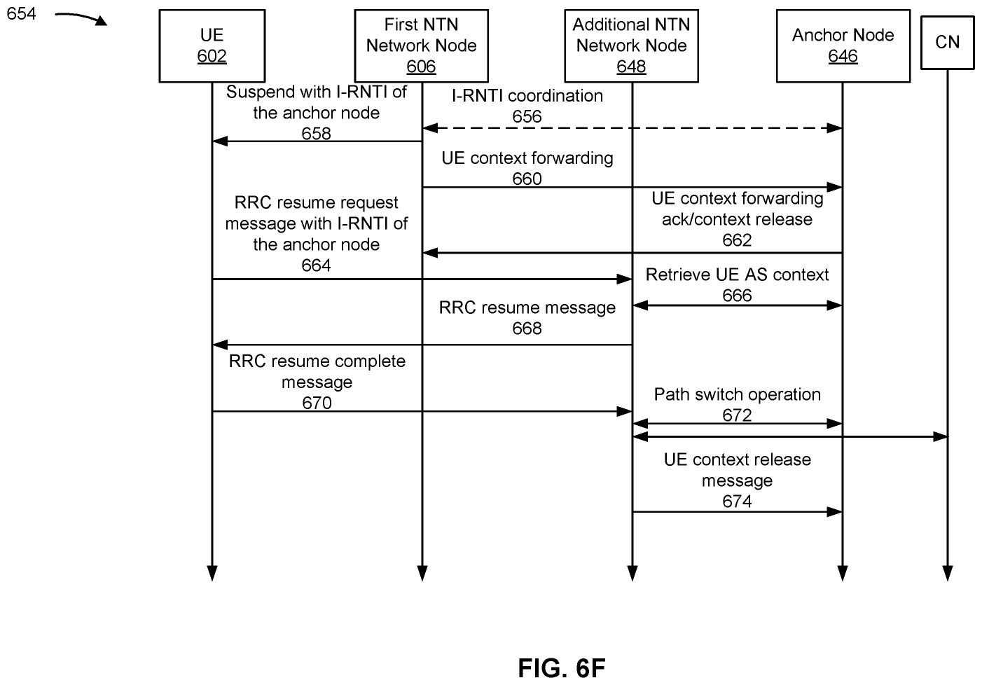

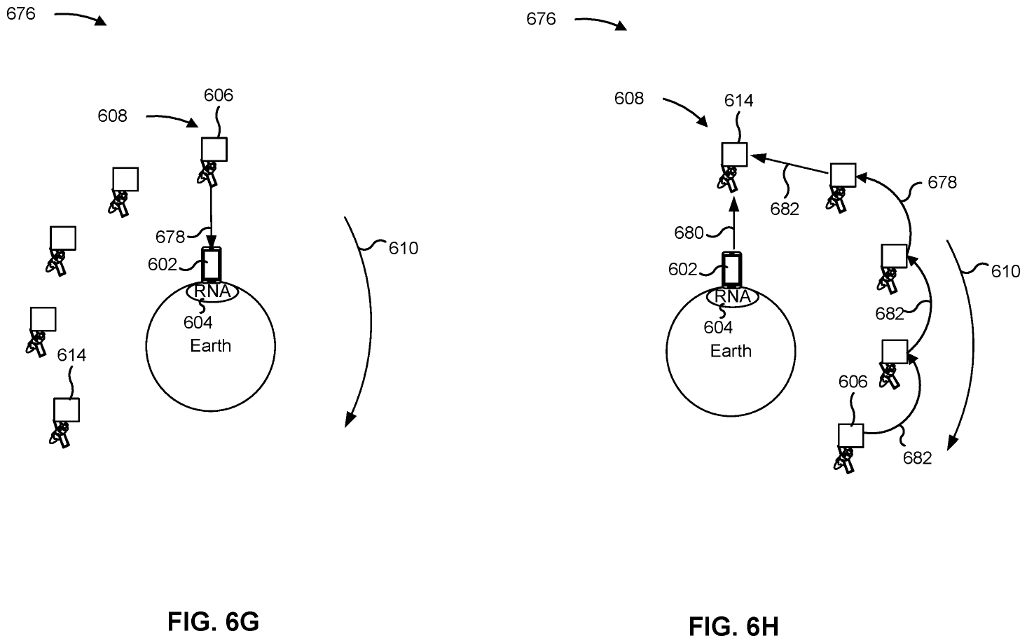

FIGS. 6A-6D illustrate examples associated with RNA handling for NTN network nodes, in accordance with the present disclosure. For example, FIGS. 6A-6D FIGS. 6A and 6B are sequential diagrams illustrating an example 600 of NTN communications, in accordance with the present disclosure. As shown, a UE 602 may be located on earth within an RNA 604. The UE 602 initially may be RRC connected to a first NTN network node 606, while the first NTN network node 606 is in a first position 608 in its orbit around the earth. In some cases, associated with network node processed payload for electromagnetic compatibility (EMC) standards, a last NTN network node to which a UE was connected may be located far from the RNA and may not store the UE AS context as it has moved out of RNA. Thus, when the UE resumes, the network node to which the UE 602 resumes may not be able to retrieve the UE AS context from the last NTN network node. For example, as shown in FIG. 6B, the NTN network node 606 may orbit the earth in an orbital direction 610 and when it moves into a position 612 other than the first position 608, the first NTN network node 606 may no longer be within the RNA 604 and thus may no longer store the UE AS context. Thus, for example, when the UE 602 attempts to resume to a second NTN network node 614, the second NTN network node 614 may not be able to retrieve the UE AS context from the first NTN network node 606, thereby causing the UE 602 to not be able to resume.

Some aspects of the techniques described herein may provide RNA handling for NTN networks. In some aspects, a first NTN network node may forward UE AS context to a neighboring NTN network node based on the satellite movement (e.g., as part of RNA information). In some aspects, for example, the techniques described above for UE context relocation may be used to forward the UE AS context. In some aspects, the first NTN network node may forward the UE AS context to an anchor node. In some aspects, the anchor node may be an NTN gateway or a gNB implemented on a satellite having a geostationary orbit. The second NTN network node may retrieve the UE AS context from the anchor node. In some aspects, the first NTN network node may maintain the UE AS context even outside of the RNA.

For example, as shown by reference number 616 in FIG. 6B, the first NTN network node 606 may perform a AS context relocation operation associated with the second network node 614 to forward the UE AS context to the second NTN network node 614. In some aspects, for example, the first NTN network node 606 may perform the AS context relocation operation associated with the second NTN network node 614 based on a determination that the second NTN network node 614 will be in the RNA when the UE 602 next attempts to resume to a connected status. In this way, as shown by reference number 618, the UE 602 may resume connectivity to the second NTN network node 614, as the second NTN network node 614 will have the UE AS context. As shown by reference number 618, in some aspects, the second NTN network node 614 may forward the UE AS context to a third NTN network node 620 based on the third NTN network node being likely to be the next network node to which the UE 602 connects. Each NTN network node may forward the UE AS context to another NTN network node in this manner, thereby transferring the UE AS context to keep it maintained within the RNA as the NTN network nodes orbit the earth.

FIG. 6C is a call flow diagram illustrating an example 622 associated with the communications described in connection with FIGS. 6A and 6B, in accordance with the present disclosure. As shown by reference number 624, the first NTN network node 606 may provide, and the UE 602 may obtain, a suspend indication that includes an I-RNTI associated with the first NTN network node 606. As shown by reference number 626, the first NTN network node 606 may begin moving out of the RNA on the earth and, based on a determination that the first NTN network node 606 is moving out of the RNA, the first NTN network node 606 may perform an AS context relocation operation associated with the second NTN network node 614, as shown by reference number 628. The first NTN network node 606 may perform the AS context relocation operation by providing the UE AS context along with an I-RNTI associated with the first NTN network node 606 to the second NTN network node 614.

As shown by reference number 630, the second NTN network node 614 may begin moving out of the RNA and, based on a determination that the second NTN network node 614 is moving out of the RNA, the second NTN network node 614 may perform an AS context relocation operation associated with the third NTN network node 620, as shown by reference number 632. The second NTN network node 614 may perform the AS context relocation operation by providing the UE AS context along with an I-RNTI associated with the second NTN network node 614 to the third NTN network node 620. If the third NTN network node 620 is within the RNA when the UE 602 attempts to resume, the UE 602 may provide, and the third NTN network node 620 may obtain, an RRC resume request message, as shown by reference number 634. The third NTN network node 620 may provide, and the UE 602 may obtain, an RRC resume message, as shown by reference number 636. As shown by reference number 638, the third NTN network node 620 may perform a path switch operation to facilitating U-plane connection with the UE 602.

FIGS. 6D and 6E are diagrams illustrating an example 640 associated with using an anchor node for forwarding UE AS context, in accordance with the present disclosure. As shown by reference number 642, the first NTN network node 606 may provide a suspend message to the UE 602 based on a determination that the first NTN network node 606 will be moving out of the RNA 604. Also based on that determination, as shown by reference number 644, the first NTN network node 606 may forward the UE AS context to an anchor node 646. The anchor node 646 may store the UE AS context. Subsequently, the UE 602 may provide an RRC resume request message to an additional NTN network node 648, as shown by reference number 650. As shown by reference number 652, the additional NTN network node 648 may retrieve the UE AS context from the anchor node 646 to facilitate performing the RRC resume operation with the UE 602.

In some aspects, the anchor node 646 may implement a full wireless communication protocol stack, while, in other aspects, the anchor node 646 may implement a portion of a wireless communication protocol stack. In some aspects, the anchor node 646 may support both control-plane (C-plane) and user-plane (U-plane) communications. For example, the portion of the wireless communication protocol stack may include only an RRC layer, a PDCP layer, and an SDAP layer. In some aspects, the anchor node 646 may support only C-plane communications. For example, the portion of the wireless communication protocol stack may include only an RRC layer and a PDCP layer. In some aspects, the anchor node 646 may be associated with a RAN node address index. In some aspects, an I-RNTI associated with the UE 602 may include the RAN node address index and at least one additional RAN node address index associated with at least one additional network node. If multiple network nodes store the UE AS context, the corresponding I-RNTI may include multiple RAN node address index values. The length and position of each RAN node address index may be coordinated among the multiple network nodes. In some aspects, a UE ID part of the RAN node address index may be identical for the nodes, and in other aspects, separate UE IDs may be used. In some aspects, for example, the additional NTN network node 648 may trigger a UE context retrieve procedure to either the first NTN network node 606 or to multiple network nodes (e.g., including the anchor node 646) based on the received I-RNTI. The additional NTN network node 648 may prioritize the network nodes for which procedure delay is shorter or select the network nodes in order of IDs contained in the I-RNTI.

FIG. 6F is a call flow diagram illustrating an example 654 associated with using an anchor node for forwarding UE AS context, in accordance with the present disclosure. As shown by reference number 656, the first NTN network node 606, the additional NTN network node 648, and the anchor node 646 may perform I-RNTI coordination. For example, the first NTN network node 606, the first NTN network node 606, the additional NTN network node 648, and the anchor node 646 may exchange associated I-RNTIs. As shown by reference number 658, the first NTN network node 606 may provide, and the UE 602 may obtain, a suspend message that includes the I-RNTI associated with the anchor node 646. As shown by reference number 660, the first NTN network node 606 and the anchor node 646 may perform a UE context forwarding operation (e.g., an AS context relocation operation) in which the first NTN network node 606 provides the UE AS context to the anchor node 646. The anchor node 646 may provide a UE context forwarding ack message and/or a UE context release message to the first NTN network node 606, as shown by reference number 662.

As shown by reference number 664, the UE 602 may provide, and the additional NTN network node 648 may obtain, an RRC resume request message that includes the I-RNTI associated with the anchor node 646. Based on receiving the RRC resume request message, the additional NTN network node 648 may retrieve the UE AS context from the anchor node 646, as shown by reference number 666. For example, the additional NTN network node 648 may retrieve the UE AS context from the anchor node 646 based on the RRC resume request message including the I-RNTI associated with the anchor node 646. As shown by reference number 668, the additional NTN network node 648 may provide, and the UE 602 may obtain, an RRC resume message and, as shown by reference number 670, the UE 602 may provide an RRC resume complete message to the additional NTN network node 648. Based on completion of the RRC resume operation, as shown by reference number 672, the additional NTN network node 648, the anchor node 646, and the CN may perform a path switch operation to establish a U-plane path between the UE 602 and the additional NTN network node 648. Based on completion of the path switch operation, the additional NTN network node 648 may provide a UE context release message to the anchor node 646, as shown by reference number 674.

In some aspects, the last network node to be connected with the UE 602 may retain the UE AS context even if the last network node moves out of the RNA. In this way, when the UE attempts to resume to a connected state with respect to a next network node, the next network node may retrieve the UE AS context from the last network node. FIGS. 6G and 6H are diagrams illustrating an example 676 associated with maintaining UE AS context, in accordance with the present disclosure. For example, as shown by reference number 678, the first NTN network node 606 may provide a suspend message to the UE 602 based on a determination that the first NTN network node 606 will be moving out of the RNA 604. As shown by reference number 680, the UE 602 may provide an RRC resume request message to the second NTN network node 614 based on the second NTN network node 614 being within the RNA. As shown by reference number 682, the second NTN network node 614 may retrieve the UE AS context from the first NTN network node 606 via an inter-satellite link (ISL). In some aspects, a legacy I-RNTI allocation framework may be utilized with the ISL. While I-RNTI space may be shared with multiple RNAs defined on earth, some wireless communication standards may restrict the supported UE AS context in one RNA. In some aspects, the RNA identification may be used by the second NTN network node 614 to retrieve the UE AS context. This RNA identification may be transferred in a control interface such as, for example, an Xn interface. An example of an J-RNTI profile table in accordance with the present disclosure is depicted below in Table 1.

TABLE 1

| | | NG-RAN | | | |
|---|---|---|---|---|---|
| | | node | | | |
| | | address | | | |
| | | index | | | |
| | | (e.g., gNB | | | |
| | | ID, eNB | RAT- | PLMN- | |
| Profile | UE specific | ID, NTN | specific | specific | |
| ID | reference | GW ID) | information | information | Comment |
| 1 | 20 bits | 20 bits | N/A | N/A | NG-RAN node address index may be |
| | (~1 million | (~1 | | | very well represented by the LSBs of |
| | values) | million | | | the gNB ID. |
| | | values) | | | This profile may be applicable for any |
| | | | | | NG-RAN RAT. |
| 2 | 20 bits | 16 bits | N/A | 4 bits (Max 16 | Max number of PLMN IDs broadcast |
| | (~1 million | (65.000 | | PLMNs) | in NR is 12. |
| | values) | nodes) | | | This profile may be applicable for any |
| | | | | | NG-RAN RAT. |
| 3 | 24 bits | 16 bits | N/A | N/A | Reduced node address to maximise |
| | (16 million | (65.000 | | | addressable UE contexts. |
| | values) | nodes) | | | This profile may be applicable for any |
| | | | | | NG-RAN RAT. |
| X1 | 24 bits | 10 bits | N/A | N/A | |
| | (16 million | (~1024 | | | |
| | values) | nodes) | | | |
| X2 | 24 bits | 5 bits + 5 | N/A | N/A | |
| | (16 million | bits (aims | | | |
| | values) | to support | | | |
| | | 2 nodes | | | |
| | | storing UE | | | |
| | | context) | | | |
| | | (~1024 | | | |
| | | nodes) | | | |
| X3 | 12 bits + 12 | 5 bits + 5 | N/A | N/A | |
| | bits (aims to | bits (aims | | | |
| | support | to support | | | |
| | separate UE | 2 nodes | | | |
| | IDs for 2 nodes | storing UE | | | |
| | storing UE | context) | | | |
| | context) | (~1024 | | | |
| | (8 million | nodes) | | | |
| | values) | | | | |

As indicated above, FIGS. 6A-6H are provided as examples. Other examples may differ from what is described with regard to FIGS. 6A-6H.

FIG. 7 is a diagram illustrating an example process 700 performed, for example, by a first network node, in accordance with the present disclosure. Example process 700 is an example where the first network node (e.g., first network node 504) performs operations associated with inactive user equipment operations for NTNs.

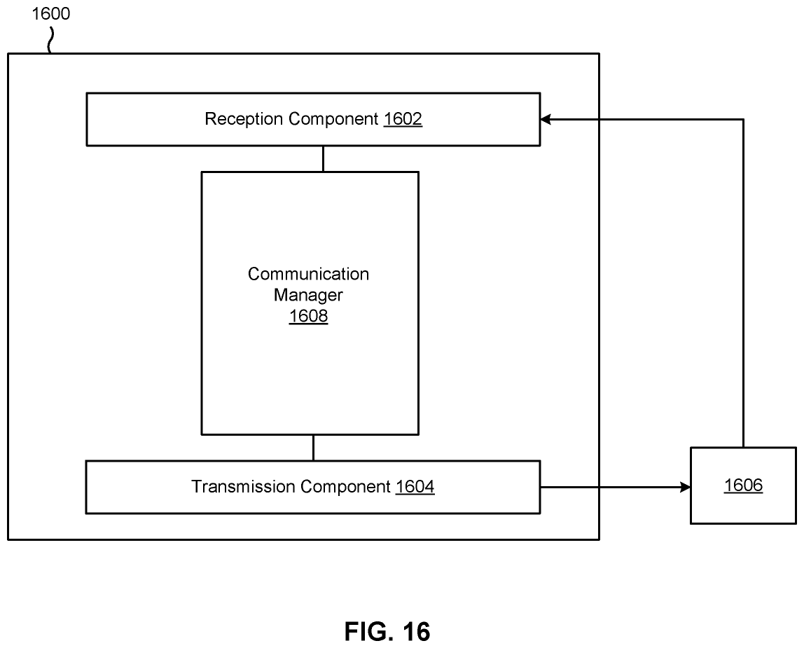

As shown in FIG. 7, in some aspects, process 700 may include communicating with a UE during an active state of the UE in accordance with a first UE configuration (block 710). For example, the first network node (e.g., using communication manager 1608, reception component 1602, and/or transmission component 1604, depicted in FIG. 16) may communicate with a UE during an active state of the UE in accordance with a first UE configuration, as described above.

As further shown in FIG. 7, in some aspects, process 700 may include performing, associated with a second network node and based on a determination to switch the UE to an inactive state, an AS context relocation operation and a path switch operation associated with the second network node (block 720). For example, the first network node (e.g., using communication manager 1608, reception component 1602, and/or transmission component 1604, depicted in FIG. 16) may perform, associated with a second network node and based on a determination to switch the UE to an inactive state, an AS context relocation operation and a path switch operation associated with the second network node, as described above.

Process 700 may include additional aspects, such as any single aspect or any combination of aspects described below and/or in connection with one or more other processes described elsewhere herein.

In a first aspect, at least one of the first network node or the second network node comprises a terrestrial network node. In a second aspect, alone or in combination with the first aspect, at least one of the first network node or the second network node comprises a non-terrestrial network node. In a third aspect, alone or in combination with one or more of the first and second aspects, performing the AS context relocation operation comprises providing, to the second network node, a UE context relocation request message, obtaining, from the second network node, a UE context relocation request acknowledgement message, and providing, to the UE and based on obtaining the UE context relocation request acknowledgement, an RRC release message.

In a fourth aspect, alone or in combination with one or more of the first through third aspects, the UE context relocation request message comprises at least one of an indication of a UE capability, an I-RNTI associated with the first network node, a second UE configuration, or a security parameter. In a fifth aspect, alone or in combination with one or more of the first through fourth aspects, the security parameter comprises at least one of a security key, a physical cell identifier, C-RNTI associated with the first network node, or a downlink absolute radio frequency channel number associated with the first network node. In a sixth aspect, alone or in combination with one or more of the first through fifth aspects, the UE context relocation request acknowledgement message comprises a C-RNTI associated with the second network node or a second UE configuration. In a seventh aspect, alone or in combination with one or more of the first through sixth aspects, providing the RRC release message comprises multiplexing the RRC release message with an RRC reconfiguration message in at least one of an RRC layer, a service data adaptation protocol (SDAP) layer, a PDCP layer, an RLC layer, a MAC layer, or a physical layer.

In an eighth aspect, alone or in combination with one or more of the first through seventh aspects, the UE context relocation request message comprises a configuration list request, wherein the UE context relocation request acknowledgment message comprises a cell identity associated with the second network node, and wherein the RRC release message includes a cell identity list comprising the cell identity associated with the second network node and a configuration list comprising a second UE configuration associated with the second network node. In a ninth aspect, alone or in combination with one or more of the first through eighth aspects, process 700 includes receiving at least one additional cell identity associated with at least one additional network node and at least one additional configuration associated with the at least one additional network node, wherein the cell identity list comprises the at least one additional cell identity and the configuration list comprises the at least one additional configuration. In a tenth aspect, alone or in combination with one or more of the first through ninth aspects, at least one of the cell identity list or an RNA list, included in the RRC release message, comprises RNA information.

In an eleventh aspect, alone or in combination with one or more of the first through tenth aspects, performing the AS context relocation operation comprises providing a UE relocation complete message to the second network node. In a twelfth aspect, alone or in combination with one or more of the first through eleventh aspects, providing the UE relocation complete message comprises providing the UE relocation complete message based on a complete message condition being satisfied. In a thirteenth aspect, alone or in combination with one or more of the first through twelfth aspects, the complete message condition is satisfied based on receiving, from the UE, a layer 2 acknowledgment communication. In a fourteenth aspect, alone or in combination with one or more of the first through thirteenth aspects, the complete message condition is satisfied based on an expiry of a timer that has a start time associated with the providing a radio resource control release message. In a fifteenth aspect, alone or in combination with one or more of the first through fourteenth aspects, the UE relocation complete message indicates a UE identifier associated with the UE.

In a sixteenth aspect, alone or in combination with one or more of the first through fifteenth aspects, performing the path switch operation comprises providing, to a core network, a path switch request message, and obtaining, from the core network, a path switch request acknowledgment message. In a seventeenth aspect, alone or in combination with one or more of the first through sixteenth aspects, providing the path switch request message comprises providing the path switch request message based on a completion of the AS context relocation operation. In an eighteenth aspect, alone or in combination with one or more of the first through seventeenth aspects, the path switch request message indicates at least one of a network node identifier associated with the second network node, a tunnel endpoint identifier, or a UE context relocation cause.

In a nineteenth aspect, alone or in combination with one or more of the first through eighteenth aspects, process 700 includes selecting the second network node based on a target selection parameter. In a twentieth aspect, alone or in combination with one or more of the first through nineteenth aspects, the target selection parameter is associated with at least one of a capability of the UE, a location of the UE, a connection history of the UE, a velocity of the UE, a type of the UE, a measurement report obtained from the UE, or a network load associated with the second network node. In a twenty-first aspect, alone or in combination with one or more of the first through twentieth aspects, performing the AS context relocation operation comprises performing the AS context relocation operation during an inactive state of the UE.

In a twenty-second aspect, alone or in combination with one or more of the first through twenty-first aspects, process 700 includes maintaining a UE context associated with the UE subsequent to performing the AS context relocation operation. In a twenty-third aspect, alone or in combination with one or more of the first through twenty-second aspects, performing the AS context relocation operation comprises providing, to at least one neighboring network node, a UE context preparation request message comprising the UE AS context and an inactive radio network temporary identifier, the at least one neighboring network node including the second network node. In a twenty-fourth aspect, alone or in combination with one or more of the first through twenty-third aspects, performing the AS context relocation operation further comprises obtaining, from the second network node, a UE context preparation request acknowledgment message.

In a twenty-fifth aspect, alone or in combination with one or more of the first through twenty-fourth aspects, the UE context preparation request message comprises a configuration list request, wherein the UE context preparation request acknowledgment message comprises a cell identity associated with the second network node, and wherein an RRC release message includes a cell identity list comprising the cell identity associated with the second network node and a configuration list comprising a second UE configuration associated with the second network node. In a twenty-sixth aspect, alone or in combination with one or more of the first through twenty-fifth aspects, process 700 includes obtaining at least one additional cell identity associated with at least one additional network node and at least one additional configuration associated with the at least one additional network node, wherein the cell identity list comprises the at least one additional cell identity and the configuration list comprises the at least one additional configuration. In a twenty-seventh aspect, alone or in combination with one or more of the first through twenty-sixth aspects, at least one of the cell identity list or an RNA list, included in the RRC release message, comprises RNA information.

In a twenty-eighth aspect, alone or in combination with one or more of the first through twenty-seventh aspects, process 700 includes maintaining, subsequent to performing the AS context relocation operation, a first user plane interface, associated with the UE, between a core network and the first network node. In a twenty-ninth aspect, alone or in combination with one or more of the first through twenty-eighth aspects, process 700 includes providing, to the core network, a path establishment request message for establishing a second user plane interface, associated with the UE, between the core network and the second network node, and obtaining, from the core network, a path establishment request acknowledgment message associated with the second user plane interface.

In a thirtieth aspect, alone or in combination with one or more of the first through twenty-ninth aspects, process 700 includes receiving, from the core network, a UE context release message. In a thirty-first aspect, alone or in combination with one or more of the first through thirtieth aspects, process 700 includes starting a context release timer based on receiving the path establishment request acknowledgment, and releasing a UE AS context associated with the UE based on an expiry of the context release timer.

In a thirty-second aspect, alone or in combination with one or more of the first through thirty-first aspects, process 700 includes obtaining, from the core network, a downlink user plane packet comprising a sequence number. In a thirty-third aspect, alone or in combination with one or more of the first through thirty-second aspects, the downlink user plane packet includes a header associated with a dedicated protocol, the header indicating the sequence number. In a thirty-fourth aspect, alone or in combination with one or more of the first through thirty-third aspects, process 700 includes receiving, from the core network, an indication of the sequence number. In a thirty-fifth aspect, alone or in combination with one or more of the first through thirty-fourth aspects, receiving the indication comprises receiving a user plane packet comprising a user plane protocol header that includes the indication. In a thirty-sixth aspect, alone or in combination with one or more of the first through thirty-fifth aspects, process 700 includes assigning the sequence number, and providing a packet to the core network, the packet comprising a header that indicates the sequence number. In a thirty-seventh aspect, alone or in combination with one or more of the first through thirty-sixth aspects, the header comprises a service data adaptation protocol header. In a thirty-eighth aspect, alone or in combination with one or more of the first through thirty-seventh aspects, the header comprises a packet data convergence protocol header.

In a thirty-ninth aspect, alone or in combination with one or more of the first through thirty-eighth aspects, process 700 includes performing, in association with an RAN paging restriction, a RAN paging operation based on receiving the downlink user plane packet. In a fortieth aspect, alone or in combination with one or more of the first through thirty-ninth aspects, process 700 includes obtaining an RAN triggering communication from at least one additional network node, the at least one additional network node comprising the second network node, and providing a plurality of UE paging messages based on obtaining the RAN triggering communication. In a forty-first aspect, alone or in combination with one or more of the first through fortieth aspects, process 700 includes providing, to the UE, a reselection prohibition indication of at least one cell reselection prohibition associated with reselection of a first cell included in a first RNA based on the UE being camped on a first cell included in a second RNA. In a forty-second aspect, alone or in combination with one or more of the first through forty-first aspects, the reselection prohibition indication is indicative of the first cell and a second cell. In a forty-third aspect, alone or in combination with one or more of the first through forty-second aspects, the configuration information indicates that at least one of the first cell or the second cell comprises at least one of a terrestrial network cell or a non-terrestrial network cell. In a forty-fourth aspect, alone or in combination with one or more of the first through forty-third aspects, providing the reselection prohibition indication comprises providing at least one of RNA information including the reselection prohibition indication, a cell identity list including the reselection prohibition indication, a random access code including the reselection prohibition indication, or a bitmap including the reselection prohibition indication. In a forty-fifth aspect, alone or in combination with one or more of the first through forty-fourth aspects, the cell reselection prohibition comprises a soft prohibition. In a forty-sixth aspect, alone or in combination with one or more of the first through forty-fifth aspects, the cell reselection prohibition comprises a hard prohibition.

In a forty-seventh aspect, alone or in combination with one or more of the first through forty-sixth aspects, process 700 includes providing, to the UE, configuration information indicative of a per-cell RNA timer, a per-cell-type RNA timer, or a per-orbit-type RNA timer.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a second network node, in accordance with the present disclosure. Example process 800 is an example where the second network node (e.g., second network node 506) performs operations associated with inactive user equipment operations for NTNs.

As shown in FIG. 8, in some aspects, process 800 may include performing, associated with a first network node and based on a determination to switch a connected UE to an inactive state, an AS context relocation operation and a path switch operation associated with the second network node (block 810). For example, the second network node (e.g., using communication manager 1608, reception component 1602, and/or transmission component 1604, depicted in FIG. 16) may perform, associated with a first network node and based on a determination to switch a connected UE to an inactive state, an AS context relocation operation and a path switch operation associated with the second network node, as described above.

As further shown in FIG. 8, in some aspects, process 800 may include communicating with the UE based on the AS context relocation operation and the path switch operation (block 820). For example, the second network node (e.g., using communication manager 1608, reception component 1602, and/or transmission component 1604, depicted in FIG. 16) may communicate with the UE based on the AS context relocation operation and the path switch operation, as described above.

Process 800 may include additional aspects, such as any single aspect or any combination of aspects described below and/or in connection with one or more other processes described elsewhere herein.

In a first aspect, at least one of the first network node or the second network node comprises a terrestrial network node. In a second aspect, alone or in combination with the first aspect, at least one of the first network node or the second network node comprises a non-terrestrial network node. In a third aspect, alone or in combination with one or more of the first and second aspects, performing the AS context relocation operation comprises obtaining, from the first network node, a UE context relocation request message, and providing, to the first network node, a UE context relocation request acknowledgement message.

In a fourth aspect, alone or in combination with one or more of the first through third aspects, the UE context relocation request message comprises at least one of an indication of a UE capability, an I-RNTI associated with the first network node, a second UE configuration, or a security parameter. In a fifth aspect, alone or in combination with one or more of the first through fourth aspects, the security parameter comprises at least one of a security key, a physical cell identifier, a C-RNTI associated with the first network node, or a downlink absolute radio frequency channel number associated with the first network node. In a sixth aspect, alone or in combination with one or more of the first through fifth aspects, the UE context relocation request acknowledgement message comprises a C-RNTI associated with the second network node or a second UE configuration.

In a seventh aspect, alone or in combination with one or more of the first through sixth aspects, the UE context relocation request message comprises a configuration list request, and wherein the UE context relocation request acknowledgment message comprises a cell identity associated with the second network node. In an eighth aspect, alone or in combination with one or more of the first through seventh aspects, performing the AS context relocation operation comprises obtaining a UE relocation complete message from the first network node. In a ninth aspect, alone or in combination with one or more of the first through eighth aspects, obtaining the UE relocation complete message comprises obtaining the UE relocation complete message based on a complete message condition being satisfied. In a tenth aspect, alone or in combination with one or more of the first through ninth aspects, the UE relocation complete message condition is satisfied based on receiving, from the UE, a layer 2 acknowledgment communication. In an eleventh aspect, alone or in combination with one or more of the first through tenth aspects, the UE relocation complete message condition is satisfied based on an expiry of a timer that has a start time associated with providing a radio resource control release message.

In a twelfth aspect, alone or in combination with one or more of the first through eleventh aspects, the UE relocation complete message indicates a UE identifier associated with the UE. In a thirteenth aspect, alone or in combination with one or more of the first through twelfth aspects, the second network node comprises a target network node for the AS context relocation operation and the path switch operation based on a target selection parameter. In a fourteenth aspect, alone or in combination with one or more of the first through thirteenth aspects, the target selection parameter is associated with at least one of a capability of the UE, a location of the UE, a connection history of the UE, a velocity of the UE, a type of the UE, a measurement report obtained from the UE, or a network load associated with the target network node. In a fifteenth aspect, alone or in combination with one or more of the first through fourteenth aspects, performing the AS context relocation operation comprises performing the AS context relocation operation during an inactive state of the UE.

In a sixteenth aspect, alone or in combination with one or more of the first through fifteenth aspects, process 800 includes maintaining a UE AS context associated with the UE subsequent to performing the AS context relocation operation. In a seventeenth aspect, alone or in combination with one or more of the first through sixteenth aspects, performing the AS context relocation operation comprises obtaining, from the first network node, a UE context preparation request message comprising the UE AS context and an inactive radio network temporary identifier. In an eighteenth aspect, alone or in combination with one or more of the first through seventeenth aspects, performing the AS context relocation operation further comprises providing, to the first network node, a UE context preparation request acknowledgment message. In a nineteenth aspect, alone or in combination with one or more of the first through eighteenth aspects, the UE context preparation request message comprises a configuration list request, and wherein the UE context preparation request acknowledgment message comprises a cell identity associated with the second network node. In a twentieth aspect, alone or in combination with one or more of the first through nineteenth aspects, process 800 includes maintaining, subsequent to performing the AS context relocation operation, a second user plane interface, associated with the UE, between a core network and the second network node.

In a twenty-first aspect, alone or in combination with one or more of the first through twentieth aspects, process 800 includes performing an RRC resume operation in association with the first network node to release a UE context associated with the UE, providing, to the first network node and based on completion of the RRC resume operation, a UE context release message, and providing, to the core network and based on providing the UE context release message, a path removal request message for removing a second user plane interface, associated with the UE, between the core network and the second network node. In a twenty-second aspect, alone or in combination with one or more of the first through twenty-first aspects, process 800 includes obtaining, from the core network, a downlink user plane packet comprising a sequence number. In a twenty-third aspect, alone or in combination with one or more of the first through twenty-second aspects, the downlink user plane packet includes a header associated with a dedicated protocol, the header indicating the sequence number. In a twenty-fourth aspect, alone or in combination with one or more of the first through twenty-third aspects, process 800 includes receiving, from the core network, an indication of the sequence number. In a twenty-fifth aspect, alone or in combination with one or more of the first through twenty-fourth aspects, receiving the indication comprises receiving a user plane packet comprising a user plane protocol header that includes the indication. In a twenty-sixth aspect, alone or in combination with one or more of the first through twenty-fifth aspects, process 800 includes assigning the sequence number, and providing a packet to the core network, the packet comprising a header that indicates the sequence number. In a twenty-seventh aspect, alone or in combination with one or more of the first through twenty-sixth aspects, the header comprises a service data adaptation protocol header. In a twenty-eighth aspect, alone or in combination with one or more of the first through twenty-seventh aspects, the header comprises a packet data convergence protocol header.

In a twenty-ninth aspect, alone or in combination with one or more of the first through twenty-eighth aspects, process 800 includes performing, in association with a RAN paging restriction, a RAN paging operation based on receiving the downlink user plane packet. In a thirtieth aspect, alone or in combination with one or more of the first through twenty-ninth aspects, process 800 includes providing a RAN triggering communication to the first network node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 502) performs operations associated with inactive user equipment operations for NTNs.

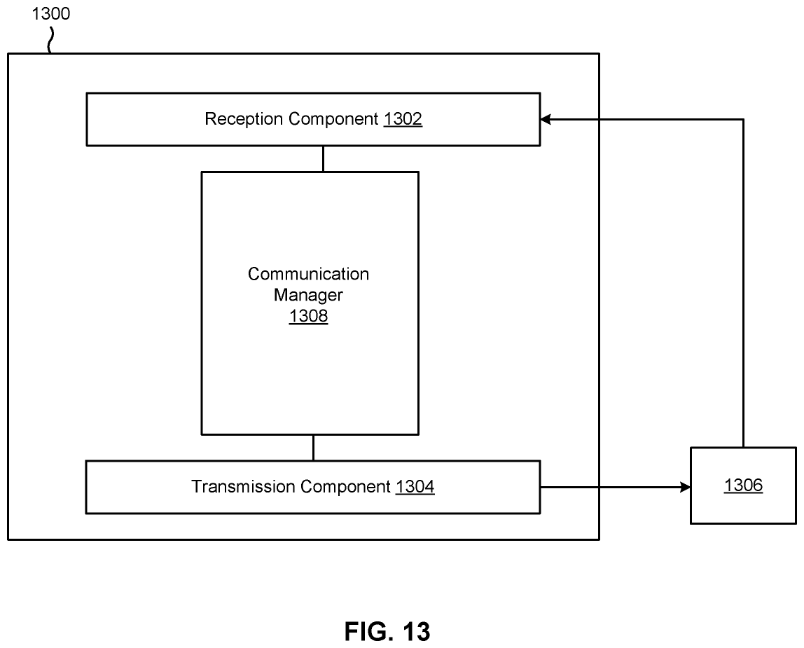

As shown in FIG. 9, in some aspects, process 900 may include communicating with a first network node during an active state of the UE in accordance with a first UE configuration (block 910). For example, the UE (e.g., using communication manager 1308, reception component 1302, and/or transmission component 1304, depicted in FIG. 13) may communicate with a first network node during an active state of the UE in accordance with a first UE configuration, as described above.

As further shown in FIG. 9, in some aspects, process 900 may include performing, associated with a second network node and based on an AS context relocation operation and a path switch operation associated with a second network node, a UE resume operation to connect to the second network node (block 920). For example, the UE (e.g., using communication manager 1308, reception component 1302, and/or transmission component 1304, depicted in FIG. 13) may perform, associated with a second network node and based on an AS context relocation operation and a path switch operation associated with a second network node, a UE resume operation to connect to the second network node, as described above.

Process 900 may include additional aspects, such as any single aspect or any combination of aspects described below and/or in connection with one or more other processes described elsewhere herein.

In a first aspect, at least one of the first network node or the second network node comprises a terrestrial network node. In a second aspect, alone or in combination with the first aspect, at least one of the first network node or the second network node comprises a non-terrestrial network node. In a third aspect, alone or in combination with one or more of the first and second aspects, process 900 includes obtaining, from the first network node, an RRC release message. In a fourth aspect, alone or in combination with one or more of the first through third aspects, the RRC release message is multiplexed with an RRC reconfiguration message in at least one of an RRC layer, a PDCP layer, an RLC layer, a MAC layer, or a physical layer.

In a fifth aspect, alone or in combination with one or more of the first through fourth aspects, the RRC release message includes a cell identity list comprising a cell identity associated with the second network node and a configuration list comprising a second UE configuration associated with the second network node. In a sixth aspect, alone or in combination with one or more of the first through fifth aspects, the cell identity list comprises at least one additional cell identity associated with at least one additional network node and the configuration list comprises at least one additional configuration associated with the at least one additional network node. In a seventh aspect, alone or in combination with one or more of the first through sixth aspects, at least one of the cell identity list or an RNA list, included in the RRC release message, comprises RNA information.

In an eighth aspect, alone or in combination with one or more of the first through seventh aspects, process 900 includes obtaining, from the first network node, a downlink user plane packet comprising a sequence number. In a ninth aspect, alone or in combination with one or more of the first through eighth aspects, the downlink user plane packet includes a header associated with a dedicated protocol, the header indicating the sequence number. In a tenth aspect, alone or in combination with one or more of the first through ninth aspects, process 900 includes obtaining, from the first network node, a first paging message including a cause value associated with a UE context relocation operation, obtaining, from the second network node, a second paging message associated with the UE context relocation operation, and providing an RRC resume request message associated with the UE context relocation operation. In an eleventh aspect, alone or in combination with one or more of the first through tenth aspects, providing the RRC resume request message comprises providing the RRC resume request message to the first network node. In a twelfth aspect, alone or in combination with one or more of the first through eleventh aspects, providing the RRC resume request message comprises providing the RRC resume request message to the second network node.

In a thirteenth aspect, alone or in combination with one or more of the first through twelfth aspects, process 900 includes obtaining a reselection prohibition indication of at least one cell reselection prohibition associated with reselection of a first cell included in an RNA based on the UE being camped on a first cell included in a second RNA. In a fourteenth aspect, alone or in combination with one or more of the first through thirteenth aspects, the reselection prohibition indication is indicative of the first cell and the second cell. In a fifteenth aspect, alone or in combination with one or more of the first through fourteenth aspects, process 900 includes receiving configuration information that indicates that at least one of the first cell or the second cell comprises at least one of a terrestrial network cell or a non-terrestrial network cell.

In a sixteenth aspect, alone or in combination with one or more of the first through fifteenth aspects, obtaining the reselection prohibition indication comprises obtaining at least one of RNA information including the reselection prohibition indication, a cell identity list including the reselection prohibition indication, a random access code including the reselection prohibition indication, or a bitmap including the reselection prohibition indication. In a seventeenth aspect, alone or in combination with one or more of the first through sixteenth aspects, the cell reselection prohibition comprises a soft prohibition. In an eighteenth aspect, alone or in combination with one or more of the first through seventeenth aspects, the cell reselection prohibition comprises a hard prohibition.

In a nineteenth aspect, alone or in combination with one or more of the first through eighteenth aspects, process 900 includes obtaining configuration information indicative of a per-cell RNA timer, a per-cell-type RNA timer, or a per-orbit-type RNA timer.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a core network implemented as one or more network nodes, in accordance with the present disclosure. Example process 1000 is an example where the core network (e.g., core network 508) performs operations associated with inactive user equipment operations for NTNs.

As shown in FIG. 10, in some aspects, process 1000 may include obtaining, from a first network node and associated with a UE, a path switch request message associated with a path switch operation (block 1010). For example, the core network (e.g., using communication manager 1608 and/or reception component 1602, depicted in FIG. 16) may obtain, from a first network node and associated with a UE, a path switch request message associated with a path switch operation, as described above.

As further shown in FIG. 10, in some aspects, process 1000 may include performing, based on the path switch request message, the path switch operation in association with a second network node (block 1020). For example, the core network (e.g., using communication manager 1608, reception component 1602, and/or transmission component 1604, depicted in FIG. 16) may perform, based on the path switch request message, the path switch operation in association with a second network node, as described above.

Process 1000 may include additional aspects, such as any single aspect or any combination of aspects described below and/or in connection with one or more other processes described elsewhere herein.

In a first aspect, at least one of the first network node or the second network node comprises a terrestrial network node. In a second aspect, alone or in combination with the first aspect, at least one of the first network node or the second network node comprises a non-terrestrial network node. In a third aspect, alone or in combination with one or more of the first and second aspects, process 1000 includes providing, to the first network node, a path switch request acknowledgment message. In a fourth aspect, alone or in combination with one or more of the first through third aspects, obtaining the path switch request message comprises obtaining the path switch request message based on a completion of an AS context relocation operation associated with the UE. In a fifth aspect, alone or in combination with one or more of the first through fourth aspects, the path switch request message indicates at least one of a network node identifier associated with the second network node, a tunnel endpoint identifier, or a UE context relocation cause.

In a sixth aspect, alone or in combination with one or more of the first through fifth aspects, process 1000 includes establishing, in association with the path switch operation, a second user plane interface, associated with the UE, between the core network and the second network node, and maintaining, subsequent to completion of an AS context relocation operation associated with the UE, a first user plane interface, associated with the UE, between the core network and the first network node. In a seventh aspect, alone or in combination with one or more of the first through sixth aspects, process 1000 includes obtaining, from the first network node, a path establishment request message for establishing the second user plane interface, and providing, to the first network node, a path establishment request acknowledgment message associated with the second user plane interface. In an eighth aspect, alone or in combination with one or more of the first through seventh aspects, process 1000 includes obtaining, from the second network node, a path removal request message for removing the second user plane interface, and providing, to the first network node and based on obtaining the path removal request message, a UE context release message. In a ninth aspect, alone or in combination with one or more of the first through eighth aspects, process 1000 includes providing, to the first network node, a UE context release message.

In a tenth aspect, alone or in combination with one or more of the first through ninth aspects, process 1000 includes providing, to the first network node, a downlink user plane packet comprising a sequence number. In an eleventh aspect, alone or in combination with one or more of the first through tenth aspects, the downlink user plane packet includes a header associated with a dedicated protocol, the header indicating the sequence number. In a twelfth aspect, alone or in combination with one or more of the first through eleventh aspects, process 1000 includes providing, to the first network node, an indication of the sequence number. In a thirteenth aspect, alone or in combination with one or more of the first through twelfth aspects, providing the indication comprises providing a user plane packet comprising a user plane protocol header that includes the indication. In a fourteenth aspect, alone or in combination with one or more of the first through thirteenth aspects, process 1000 includes obtaining, from the first network node, a packet comprising a header that indicates the sequence number. In a fifteenth aspect, alone or in combination with one or more of the first through fourteenth aspects, the header comprises a service data adaptation protocol header. In a sixteenth aspect, alone or in combination with one or more of the first through fifteenth aspects, the header comprises a packet data convergence protocol header.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a first network node, in accordance with the present disclosure. Example process 1100 is an example where the first network node (e.g., first network node 606) performs operations associated with inactive user equipment operations for NTNs.

As shown in FIG. 11, in some aspects, process 1100 may include communicating with a UE during an active state of the UE in accordance with a first UE configuration, wherein the first network node comprises a first NTN network node (block 1110). For example, the first network node (e.g., using communication manager 1608, reception component 1602, and/or transmission component 1604, depicted in FIG. 16) may communicate with a UE during an active state of the UE in accordance with a first UE configuration, wherein the first network node comprises a first NTN network node, as described above.

As further shown in FIG. 11, in some aspects, process 1100 may include performing, associated with a second NTN network node and based on a determination that the first NTN is moving out of an RNA, an AS context relocation operation associated with the second NTN network node (block 1120). For example, the first network node (e.g., using communication manager 1608, reception component 1602, and/or transmission component 1604, depicted in FIG. 16) may perform, associated with a second NTN network node and based on a determination that the first NTN is moving out of an RNA, an AS context relocation operation associated with the second NTN network node, as described above.

Process 1100 may include additional aspects, such as any single aspect or any combination of aspects described below and/or in connection with one or more other processes described elsewhere herein.

In a first aspect, the second NTN network node is within the RNA. In a second aspect, alone or in combination with the first aspect, the second NTN network node comprises an anchor node configured to store a UE AS context associated with the UE for connection, by the UE, to a third NTN network node. In a third aspect, alone or in combination with one or more of the first and second aspects, the anchor node comprises an NTN gateway node. In a fourth aspect, alone or in combination with one or more of the first through third aspects, the anchor node comprises a geostationary satellite. In a fifth aspect, alone or in combination with one or more of the first through fourth aspects, the anchor node implements a full wireless communication protocol stack. In a sixth aspect, alone or in combination with one or more of the first through fifth aspects, the anchor node implements a portion of a wireless communication protocol stack. In a seventh aspect, alone or in combination with one or more of the first through sixth aspects, the portion of the wireless communication protocol stack includes only a radio resource control layer and a packet data convergence protocol layer.

In an eighth aspect, alone or in combination with one or more of the first through seventh aspects, the anchor node is associated with a RAN node address index. In a ninth aspect, alone or in combination with one or more of the first through eighth aspects, an inactive radio network temporary identifier associated with the UE comprises the RAN node address index and at least one additional RAN node address index associated with at least one additional network node. In a tenth aspect, alone or in combination with one or more of the first through ninth aspects, process 1100 includes maintaining a UE AS context associated with the UE while the first network node is outside of the RNA. In an eleventh aspect, alone or in combination with one or more of the first through tenth aspects, performing the AS context relocation operation comprises forwarding the UE AS context to the second NTN network node via an inter-satellite link.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a second network node, in accordance with the present disclosure. Example process 1200 is an example where the second network node (e.g., second network node 614) performs operations associated with inactive user equipment operations for NTNs.

As shown in FIG. 12, in some aspects, process 1200 may include performing, associated with a first NTN network node and based on a determination that the first NTN is moving out of an RNA, an AS context relocation operation associated with the second network node, the second network node comprising a second NTN network node (block 1210). For example, the second network node (e.g., using communication manager 1608, reception component 1602, and/or transmission component 1604, depicted in FIG. 16) may perform, associated with a first NTN network node and based on a determination that the first NTN is moving out of an RNA, an AS context relocation operation associated with the second network node, the second network node comprising a second NTN network node, as described above.

As further shown in FIG. 12, in some aspects, process 1200 may include communicating, based on the AS context relocation operation, with at least one of a UE or a third NTN network node (block 1220). For example, the second network node (e.g., using communication manager 1608, reception component 1602, and/or transmission component 1604, depicted in FIG. 16) may communicate, based on the AS context relocation operation, with at least one of a UE or a third NTN network node, as described above.

Process 1200 may include additional aspects, such as any single aspect or any combination of aspects described below and/or in connection with one or more other processes described elsewhere herein.

In a first aspect, the second NTN network node is within the RNA. In a second aspect, alone or in combination with the first aspect, the second NTN network node comprises an anchor node configured to store a UE AS context associated with the UE for connection, by the UE, to the third NTN network node. In a third aspect, alone or in combination with one or more of the first and second aspects, the anchor node comprises an NTN gateway node. In a fourth aspect, alone or in combination with one or more of the first through third aspects, the anchor node comprises a geostationary satellite. In a fifth aspect, alone or in combination with one or more of the first through fourth aspects, the anchor node implements a full wireless communication protocol stack. In a sixth aspect, alone or in combination with one or more of the first through fifth aspects, the anchor node implements a portion of a wireless communication protocol stack. In a seventh aspect, alone or in combination with one or more of the first through sixth aspects, the portion of the wireless communication protocol stack includes only a radio resource control layer and a packet data convergence protocol layer.

In an eighth aspect, alone or in combination with one or more of the first through seventh aspects, the anchor node is associated with a RAN node address index. In a ninth aspect, alone or in combination with one or more of the first through eighth aspects, an inactive radio network temporary identifier associated with the UE comprises the RAN node address index and at least one additional RAN node address index associated with at least one additional network node. In a tenth aspect, alone or in combination with one or more of the first through ninth aspects, a UE AS context associated with the UE is maintained on the first NTN network node while the first NTN network node is outside of the RNA. In an eleventh aspect, alone or in combination with one or more of the first through tenth aspects, performing the AS context relocation operation comprises obtaining the UE AS context from the first NTN network node via an inter-satellite link.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a communication manager 1308.

In some aspects, the apparatus 1300 may be configured to perform one or more operations described herein in connection with FIGS. 5A-6H. Additionally, or alternatively, the apparatus 1300 may be configured to perform one or more processes described herein, such as process 900 of FIG. 9. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

In some examples, means for transmitting, outputting, or sending (or means for outputting for transmission) may include one or more antennas, a modulator, a transmit MIMO processor, a transmit processor, or a combination thereof, of the UE described above in connection with FIG. 2.

In some examples, means for receiving (or means for obtaining) may include one or more antennas, a demodulator, a MIMO detector, a receive processor, or a combination thereof, of the UE described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving, obtaining, transmitting, providing, and/or performing, may include various processing system components, such as a receive processor, a transmit processor, a controller/processor, a memory, or a combination thereof, of the UE described above in connection with FIG. 2.

The communication manager 1308, the reception component 1302, and/or the transmission component 1304 may communicate with a first network node during an active state of the UE in accordance with a first UE configuration. In some aspects, the communication manager 1308 may include one or more antennas, a modem, a controller/processor, a memory, or a combination thereof, of the UE described in connection with FIG. 2. In some aspects, the communication manager 1308 may include the reception component 1302 and/or the transmission component 1304. In some aspects, the communication manager 1308 may be, be similar to, include, or be included in, the communication manager 140 depicted in FIGS. 1 and 2

The communication manager 1308, the reception component 1302, and/or the transmission component 1304 may perform, associated with a second network node and based on an AS context relocation operation and a path switch operation associated with a second network node, a UE resume operation to connect to the second network node. The communication manager 1308 and/or the reception component 1302 may obtain, from the first network node, an RRC release message. The communication manager 1308 and/or the reception component 1302 may obtain, from the first network node, a downlink user plane packet comprising a sequence number. The communication manager 1308 and/or the reception component 1302 may obtain, from the first network node, a first paging message including a cause value associated with a UE context relocation operation. The communication manager 1308 and/or the reception component 1302 may obtain, from the second network node, a second paging message associated with the UE context relocation operation. The communication manager 1308 and/or the transmission component 1304 may provide an RRC resume request message associated with the UE context relocation operation.

The communication manager 1308 and/or the reception component 1302 may obtain a reselection prohibition indication of at least one cell reselection prohibition associated with reselection of a first cell included in a first RNA based on the UE being camped on a first cell included in a second RNA. The communication manager 1308 and/or the reception component 1302 may receive configuration information that indicates that at least one of the first cell or the second cell comprises at least one of a terrestrial network cell or a non-terrestrial network cell. The communication manager 1308 and/or the reception component 1302 may obtain configuration information indicative of an RNA timer, a per-cell-type RNA timer, or a per-orbit-type RNA timer.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

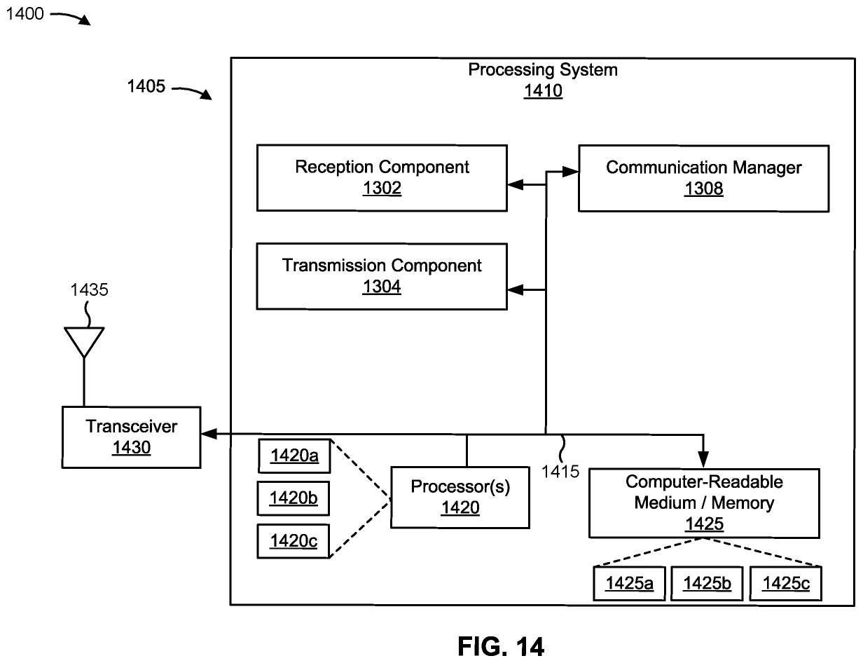

FIG. 14 is a diagram illustrating an example 1400 of a hardware implementation for an apparatus 1405 employing a processing system 1410, in accordance with the present disclosure. The apparatus 1405 may be a UE.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor (or processing circuitry) 1420, the illustrated components, and the computer-readable medium/memory (or memory circuitry) 1425. The processor 1420 may include multiple processors, such as processor 1420a, processor 1420b, and processor 1420c. The memory 1425 may include multiple memories, such as memory 1425a, memory 1425b, and memory 1425c. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302 and/or the communication manager 1308. In addition, the transceiver 1430 receives information from the processing system 1410, specifically the transmission component 1304 and/or the communication manager 1308, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the UE 120 and may include the memory 282 and/or at least one of the TX MIMO processor 266, the RX processor 258, and/or the controller/processor 280. In some aspects, the apparatus 1405 for wireless communication includes means for communicating with a first network node during an active state of the UE in accordance with a first UE configuration; and performing, associated with a second network node and based on an AS context relocation operation and a path switch operation associated with a second network node, a UE resume operation to connect to the second network node. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 14 is provided as an example. Other examples may differ from what is described in connection with FIG. 14.

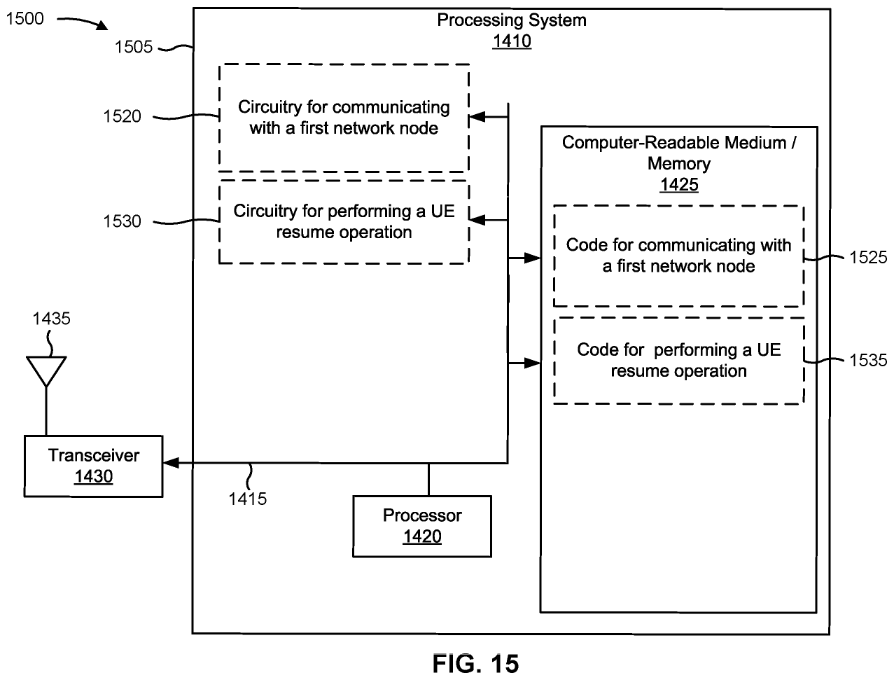

FIG. 15 is a diagram illustrating an example 1500 of an implementation of code and circuitry for an apparatus 1505, in accordance with the present disclosure. The circuitry may include processing circuitry and memory circuitry. The apparatus 1505 may be a UE, or a UE may include the apparatus 1505.

As shown in FIG. 15, the apparatus 1505 may include circuitry for communicating with a first network node (circuitry 1520). For example, the circuitry 1520 may enable the apparatus 1505 to communicate with a first network node during an active state of the UE in accordance with a first UE configuration.

As shown in FIG. 15, the apparatus 1505 may include, stored in computer-readable medium 1425, code for communicating with a first network node (code 1525). For example, the code 1525, when executed by processor 1420, may cause processor 1420 to cause transceiver 1430 to communicate with a first network node during an active state of the UE in accordance with a first UE configuration.

As shown in FIG. 15, the apparatus 1505 may include circuitry for performing a UE resume operation (circuitry 1530). For example, the circuitry 1530 may enable the apparatus 1505 to perform, associated with a second network node and based on an AS context relocation operation and a path switch operation associated with a second network node, a UE resume operation to connect to the second network node.

As shown in FIG. 15, the apparatus 1505 may include, stored in computer-readable medium 1425, code for performing a UE resume operation to connect to the second network node (code 1535). For example, the code 1535, when executed by processor 1420, may cause processor 1420 to cause transceiver 1430 to perform, associated with a second network node and based on an AS context relocation operation and a path switch operation associated with a second network node, a UE resume operation to connect to the second network node.

FIG. 15 is provided as an example. Other examples may differ from what is described in connection with FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include a communication manager 1608.

In some aspects, the apparatus 1600 may be configured to perform one or more operations described herein in connection with FIGS. 5A-6H. Additionally, or alternatively, the apparatus 1600 may be configured to perform one or more processes described herein, such as process 700 of FIG. 7, process 800 of FIG. 8, process 1000 of FIG. 10, process 1100 of FIG. 11, process 1200 of FIG. 12, or a combination thereof. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

In some examples, means for transmitting, outputting, or sending (or means for outputting for transmission) may include one or more antennas, a modulator, a transmit MIMO processor, a transmit processor, or a combination thereof, of the network node described above in connection with FIG. 2.

In some examples, means for receiving (or means for obtaining) may include one or more antennas, a demodulator, a MIMO detector, a receive processor, or a combination thereof, of the network node described above in connection with FIG. 2.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for receiving, obtaining, transmitting, providing, determining, selecting, maintaining, starting, assigning, and/or performing, may include various processing system components, such as a receive processor, a transmit processor, a controller/processor, a memory, or a combination thereof, of the network node described above in connection with FIG. 2.

The communication manager 1608, the reception component 1602, and/or the transmission component 1604 may communicate with a UE during an active state of the UE in accordance with a first UE configuration. In some aspects, the communication manager 1608 may include one or more antennas, a modem, a controller/processor, a memory, or a combination thereof, of the network node described in connection with FIG. 2. In some aspects, the communication manager 1608 may include the reception component 1602 and/or the transmission component 1604. In some aspects, the communication manager 1608 may be, be similar to, include, or be included in, the communication manager 150 depicted in FIGS. 1 and 2.

The communication manager 1608, the reception component 1602, and/or the transmission component 1604 may perform, associated with a second network node and based on a determination to switch the UE to an inactive state, an AS context relocation operation and a path switch operation associated with the second network node. The communication manager 1608 and/or the reception component 1602 may receive at least one additional cell identity associated with at least one additional network node and at least one additional configuration associated with the at least one additional network node, wherein the cell identity list comprises the at least one additional cell identity and the configuration list comprises the at least one additional configuration. The communication manager 1608 may select the second network node based on a target selection parameter. The communication manager 1608 may maintain a UE AS context associated with the UE subsequent to performing the AS context relocation operation.

The communication manager 1608 and/or the reception component 1602 may obtain at least one additional cell identity associated with at least one additional network node and at least one additional configuration associated with the at least one additional network node, wherein the cell identity list comprises the at least one additional cell identity and the configuration list comprises the at least one additional configuration.

The communication manager 1608 may maintain, subsequent to performing the AS context relocation operation, a first user plane interface, associated with the UE, between a core network and the first network node. The communication manager 1608 and/or the transmission component 1604 may provide, to the core network, a path establishment request message for establishing a second user plane interface, associated with the UE, between the core network and the second network node. The communication manager 1608 and/or the reception component 1602 may obtain, from the core network, a path establishment request acknowledgment message associated with the second user plane interface. The communication manager 1608 and/or the reception component 1602 may receive, from the core network, a UE context release message. The communication manager 1608 may start a context release timer based on receiving the path establishment request acknowledgment. The communication manager 1608 may release a UE AS context associated with the UE based on an expiry of the context release timer.

The communication manager 1608 and/or the reception component 1602 may receive, from the core network, an indication of the sequence number. The communication manager 1608 may assign the sequence number. The communication manager 1608 and/or the transmission component 1604 may provide a packet to the core network, the packet comprising a header that indicates the sequence number. The communication manager 1608, the reception component 1602, and/or the transmission component 1604 may perform, in association with an RAN paging restriction, a RAN paging operation based on receiving the downlink user plane packet. The communication manager 1608 and/or the reception component 1602 may obtain an RAN triggering communication from at least one additional network node, the at least one additional network node comprising the second network node. The communication manager 1608 and/or the transmission component 1604 may provide a plurality of UE paging messages based on obtaining the RAN triggering communication.

The communication manager 1608 and/or the transmission component 1604 may provide, to the UE, a reselection prohibition indication of at least one cell reselection prohibition associated with reselection of a first cell included in a first RNA based on the UE being camped on a first cell included in a second RNA. The communication manager 1608 and/or the transmission component 1604 may provide, to the UE, configuration information indicative of a per-cell radio access RNA timer, a per-cell-type RNA timer, or a per-orbit-type RNA timer.

The communication manager 1608, the reception component 1602, and/or the transmission component 1604 may perform, associated with a first network node and based on a determination to switch a connected UE to an inactive state, an AS context relocation operation and a path switch operation associated with the second network node. The communication manager 1608, the reception component 1602, and/or the transmission component 1604 may communicate with the UE based on the AS context relocation operation and the path switch operation. The communication manager 1608 may maintain a UE AS context associated with the UE subsequent to performing the AS context relocation operation. The communication manager 1608 may maintain, subsequent to performing the AS context relocation operation, a second user plane interface, associated with the UE, between a core network and the second network node.

The communication manager 1608, the reception component 1602, and/or the transmission component 1604 may perform an RRC resume operation in association with the first network node to release a UE AS context associated with the UE. The communication manager 1608 and/or the transmission component 1604 may provide, to the first network node and based on completion of the RRC resume operation, a UE context release message. The communication manager 1608 and/or the transmission component 1604 may provide, to the core network and based on providing the UE context release message, a path removal request message for removing a second user plane interface, associated with the UE, between the core network and the second network node. The communication manager 1608 and/or the reception component 1602 may receive, from the core network, an indication of the sequence number. The communication manager 1608 may assign the sequence number. The communication manager 1608 and/or the transmission component 1604 may provide a packet to the core network, the packet comprising a header that indicates the sequence number.

The communication manager 1608, the reception component 1602, and/or the transmission component 1604 may perform, in association with an RAN paging restriction, a RAN paging operation based on receiving the downlink user plane packet. The communication manager 1608 and/or the transmission component 1604 may provide an RAN triggering communication to the first network node.

The communication manager 1608 and/or the reception component 1602 may obtain, from a first network node and associated with a UE, a path switch request message associated with a path switch operation. The communication manager 1608, the reception component 1602, and/or the transmission component 1604 may perform, based on the path switch request message, the path switch operation in association with a second network node. The communication manager 1608 and/or the transmission component 1604 may provide, to the first network node, a path switch request acknowledgment message. The communication manager 1608, the reception component 1602, and/or the transmission component 1604 may establish, in association with the path switch operation, a second user plane interface, associated with the UE, between the core network and the second network node.

The communication manager 1608 may maintain, subsequent to completion of an AS context relocation operation associated with the UE, a first user plane interface, associated with the UE, between the core network and the first network node. The communication manager 1608 and/or the reception component 1602 may obtain, from the first network node, a path establishment request message for establishing the second user plane interface. The communication manager 1608 and/or the transmission component 1604 may provide, to the first network node, a path establishment request acknowledgment message associated with the second user plane interface. The communication manager 1608 and/or the reception component 1602 may obtain, from the second network node, a path removal request message for removing the second user plane interface. The communication manager 1608 and/or the transmission component 1604 may provide, to the first network node and based on obtaining the path removal request message, a UE context release message. The communication manager 1608 and/or the transmission component 1604 may provide, to the first network node, a UE context release message.

The communication manager 1608 and/or the transmission component 1604 may provide, to the first network node, an indication of the sequence number. The communication manager 1608 and/or the reception component 1602 may obtain, from the first network node, a packet comprising a header that indicates the sequence number.

The communication manager 1608, the reception component 1602, and/or the transmission component 1604 may communicate with a UE during an active state of the UE in accordance with a first UE configuration, wherein the first network node comprises a first NTN network node. The communication manager 1608, the reception component 1602, and/or the transmission component 1604 may perform, associated with a second NTN network node and based on a determination that the first NTN is moving out of an RNA, an AS context relocation operation associated with the second NTN network node. The communication manager 1608 may maintain a UE AS context associated with the UE while the first network node is outside of the RNA.

The communication manager 1608, the reception component 1602, and/or the transmission component 1604 may perform, associated with a first NTN network node and based on a determination that the first NTN is moving out of an RNA, an AS context relocation operation associated with the second network node, the second network node comprising a second NTN network node. The communication manager 1608, the reception component 1602, and/or the transmission component 1604 may communicate, based on the AS context relocation operation, with at least one of a UE or a third NTN network node.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

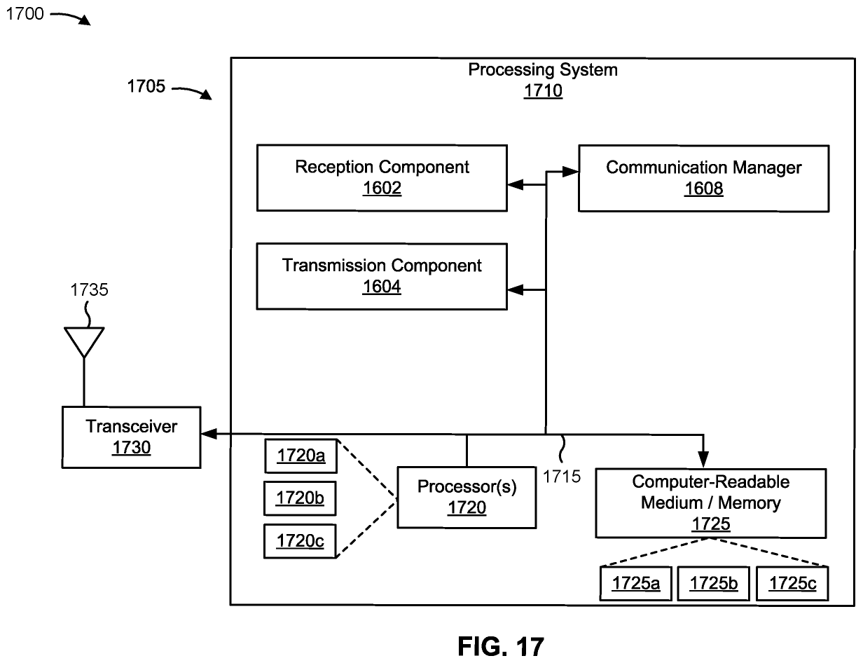

FIG. 17 is a diagram illustrating an example 1700 of a hardware implementation for an apparatus 1705 employing a processing system 1710, in accordance with the present disclosure. The apparatus 1705 may be a network node.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor (or processing circuitry) 1720, the illustrated components, and the computer-readable medium/memory (or memory circuitry) 1725. The processor 1720 may include multiple processors, such as processor 1720a, processor 1720b, and processor 1720c. The memory 1725 may include multiple memories, such as memory 1725a, memory 1725b, and memory 1725c. The bus 1715 may also link various other circuits, such as timing sources, peripherals, voltage regulators, and/or power management circuits.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602 and/or the communication manager 1608. In addition, the transceiver 1730 receives information from the processing system 1710, specifically the transmission component 1604 and/or the communication manager 1608, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software. The processing system further includes at least one of the illustrated components. The components may be software modules running in the processor 1720, resident/stored in the computer readable medium/memory 1725, one or more hardware modules coupled to the processor 1720, or some combination thereof.

In some aspects, the processing system 1710 may be a component of the network node 110 and may include the memory 242 and/or at least one of the TX MIMO processor 230, the RX processor 238, and/or the controller/processor 240. In some aspects, the apparatus 1705 for wireless communication includes means for communicating with a UE during an active state of the UE in accordance with a first UE configuration and performing, associated with a second network node and based on a determination to switch the UE to an inactive state, an AS context relocation operation and a path switch operation associated with the second network node; means for performing, associated with a first network node and based on a determination to switch a connected UE to an inactive state, an AS context relocation operation and a path switch operation associated with the second network node and communicating with the UE based on the AS context relocation operation and the path switch operation; means for obtaining, from a first network node and associated with a UE, a path switch request message associated with a path switch operation and performing, based on the path switch request message, the path switch operation in association with a second network node; means for communicating with a UE during an active state of the UE in accordance with a first UE configuration, wherein the first network node comprises a first NTN network node and performing, associated with a second NTN network node and based on a determination that the first NTN is moving out of an RNA, an AS context relocation operation associated with the second NTN network node; and/or means for performing, associated with a first NTN network node and based on a determination that the first NTN is moving out of an RNA, an AS context relocation operation associated with the second network node, the second network node comprising a second NTN network node and communicating, based on the AS context relocation operation, with at least one of a UE or a third NTN network node. The aforementioned means may be one or more of the aforementioned components of the apparatus 1600 and/or the processing system 1710 of the apparatus 1705 configured to perform the functions recited by the aforementioned means. As described elsewhere herein, the processing system 1710 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 17 is provided as an example. Other examples may differ from what is described in connection with FIG. 17.

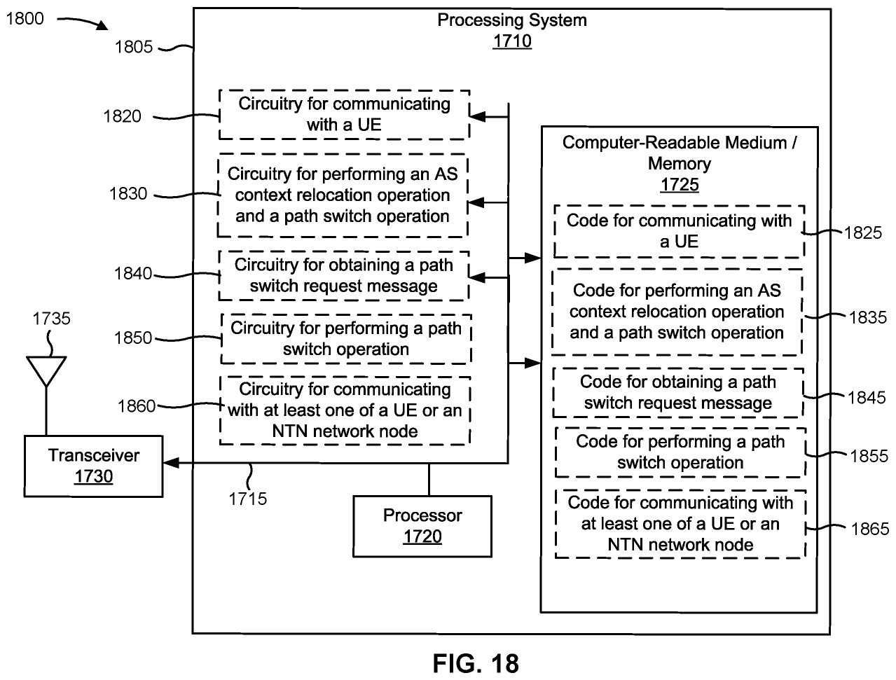

FIG. 18 is a diagram illustrating an example 1800 of an implementation of code and circuitry for an apparatus 1805, in accordance with the present disclosure. The circuitry may include processing circuitry and memory circuitry. The apparatus 1805 may be a network node, or a network node may include the apparatus 1805.

As shown in FIG. 18, the apparatus 1805 may include circuitry for communicating with a user equipment UE (circuitry 1820). For example, the circuitry 1820 may enable the apparatus 1805 to communicate with a UE during an active state of the UE in accordance with a first UE configuration. In some examples, the circuitry 1820 may enable the apparatus 1805 to communicate with a UE based on an AS relocation operation and a path switch operation.

As shown in FIG. 18, the apparatus 1805 may include, stored in computer-readable medium 1725, code for communicating with a UE (code 1825). For example, the code 1825, when executed by processor 1720, may cause processor 1720 to cause transceiver 1730 to communicate with a UE during an active state of the UE in accordance with a first UE configuration. In some examples, the code 1825 may enable the apparatus 1805 to communicate with a UE based on an AS relocation operation and a path switch operation.

As shown in FIG. 18, the apparatus 1805 may include circuitry for performing an AS context relocation operation and a path switch operation (circuitry 1830). For example, the circuitry 1830 may enable the apparatus 1805 to perform, associated with a second network node and based on a determination to switch the UE to an inactive state, an AS context relocation operation and a path switch operation associated with the second network node.

As shown in FIG. 18, the apparatus 1805 may include, stored in computer-readable medium 1725, code for performing an access stratum AS context relocation operation and a path switch operation associated with the second network node (code 1835). For example, the code 1835, when executed by processor 1720, may cause processor 1720 to cause transceiver 1730 to perform, associated with a second network node and based on a determination to switch the UE to an inactive state, an AS context relocation operation and a path switch operation associated with the second network node.

As shown in FIG. 18, the apparatus 1805 may include circuitry for obtaining a path switch request message (circuitry 1840). For example, the circuitry 1840 may enable the apparatus 1805 to obtain, from a first network node and associated with a UE, a path switch request message associated with a path switch operation.

As shown in FIG. 18, the apparatus 1805 may include, stored in computer-readable medium 1725, code for obtaining a path switch request message associated with a path switch operation (code 1845). For example, the code 1845, when executed by processor 1720, may cause processor 1720 to cause transceiver 1730 to obtain, from a first network node and associated with a UE, a path switch request message associated with a path switch operation.

As shown in FIG. 18, the apparatus 1805 may include circuitry for performing a path switch operation (circuitry 1850). For example, the circuitry 1850 may enable the apparatus 1805 to perform, based on the path switch request message, the path switch operation in association with a second network node.

As shown in FIG. 18, the apparatus 1805 may include, stored in computer-readable medium 1725, code for performing a path switch operation (code 1855). For example, the code 1855, when executed by processor 1720, may cause processor 1720 to cause transceiver 1730 to perform, based on the path switch request message, the path switch operation in association with a second network node.

As shown in FIG. 18, the apparatus 1805 may include circuitry for communicating with at least one of a UE or an NTN network node (circuitry 1860). For example, the circuitry 1860 may enable the apparatus 1805 to communicate, based on the AS context relocation operation, with at least one of a UE or a third NTN network node.

As shown in FIG. 18, the apparatus 1805 may include, stored in computer-readable medium 1725, code for communicating with at least one of a UE or an NTN network node (code 1865). For example, the code 1865, when executed by processor 1720, may cause processor 1720 to cause transceiver 1730 to communicate, based on the AS context relocation operation, with at least one of a UE or a third NTN network node.

FIG. 18 is provided as an example. Other examples may differ from what is described in connection with FIG. 18.

The following provides an overview of some Aspects of the present disclosure:

Aspect 1: A method of wireless communication performed by an apparatus at a first network node, comprising: communicating with a user equipment (UE) during an active state of the UE in accordance with a first UE configuration; and performing, associated with a second network node and based on a determination to switch the UE to an inactive state, at least one of an access stratum (AS) context relocation operation or a path switch operation associated with the second network node.

Aspect 2: The method of Aspect 1, wherein at least one of the first network node or the second network node comprises a terrestrial network node.

Aspect 3: The method of either of claims 1 or 2, wherein at least one of the first network node or the second network node comprises a non-terrestrial network node.

Aspect 4: The method of any of Aspects 1-3, wherein performing the AS context relocation operation comprises: providing, to the second network node, a UE context relocation request message; obtaining, from the second network node, a UE context relocation request acknowledgement message; and providing, to the UE and based on obtaining the UE context relocation request acknowledgement, a radio resource control (RRC) release message.

Aspect 5: The method of Aspect 4, wherein the UE context relocation request message comprises at least one of an indication of a UE capability, an inactive radio network temporary identifier (RNTI) (I-RNTI) associated with the first network node, a second UE configuration, or a security parameter.

Aspect 6: The method of Aspect 5, wherein the security parameter comprises at least one of a security key, a physical cell identifier, a cell-RNTI (C-RNTI) associated with the first network node, or a downlink absolute radio frequency channel number associated with the first network node.

Aspect 7: The method of any of Aspects 4-6, wherein the UE context relocation request acknowledgement message comprises a cell-RNTI (C-RNTI) associated with the second network node or a second UE configuration.

Aspect 8: The method of Aspect 7, wherein providing the RRC release message comprises multiplexing the RRC release message with an RRC reconfiguration message in at least one of an RRC layer, a service data adaptation protocol (SDAP) layer, a packet data convergence protocol (PDCP) layer, a radio link control (RLC) layer, a medium access control (MAC) layer, or a physical layer.

Aspect 9: The method of any of Aspects 4-8, wherein the UE context relocation request message comprises a configuration list request, wherein the UE context relocation request acknowledgment message comprises a cell identity associated with the second network node, and wherein the RRC release message includes a cell identity list comprising the cell identity associated with the second network node and a configuration list comprising a second UE configuration associated with the second network node.

Aspect 10: The method of Aspect 9, further comprising receiving at least one additional cell identity associated with at least one additional network node and at least one additional configuration associated with the at least one additional network node, wherein the cell identity list comprises the at least one additional cell identity and the configuration list comprises the at least one additional configuration.

Aspect 11: The method of either of claims 9 or 10, wherein at least one of the cell identity list or a radio access network (RAN) notification area (RNA) list, included in the RRC release message, comprises RNA information.

Aspect 12: The method of any of Aspects 1-11, wherein performing the AS context relocation operation comprises providing a UE relocation complete message to the second network node.

Aspect 13: The method of Aspect 12, wherein providing the UE relocation complete message comprises providing the UE relocation complete message based on a complete message condition being satisfied.

Aspect 14: The method of Aspect 13, wherein the complete message condition is satisfied based on receiving, from the UE, a layer 2 acknowledgment communication.

Aspect 15: The method of either of Aspects 13 or 14, wherein the complete message condition is satisfied based on an expiry of a timer that has a start time associated with the providing a radio resource control release message.

Aspect 16: The method of any of Aspects 12-15, wherein the UE relocation complete message indicates a UE identifier associated with the UE.

Aspect 17: The method of any of Aspects 1-16, wherein performing the path switch operation comprises: providing, to a core network, a path switch request message; and obtaining, from the core network, a path switch request acknowledgment message.

Aspect 18: The method of Aspect 17, wherein providing the path switch request message comprises providing the path switch request message based on a completion of the AS context relocation operation.

Aspect 19: The method of either of claims 17 or 18, wherein the path switch request message indicates at least one of a network node identifier associated with the second network node, a tunnel endpoint identifier, or a UE context relocation cause.

Aspect 20: The method of any of Aspects 1-19, further comprising selecting the second network node based on a target selection parameter.

Aspect 21: The method of Aspect 20, wherein the target selection parameter is associated with at least one of a capability of the UE, a location of the UE, a connection history of the UE, a velocity of the UE, a type of the UE, a measurement report obtained from the UE, or a network load associated with the second network node.

Aspect 22: The method of any of Aspects 1-21, wherein performing the AS context relocation operation comprises performing the AS context relocation operation during an inactive state of the UE.

Aspect 23: The method of any of Aspects 1-22, further comprising maintaining a UE AS context associated with the UE subsequent to performing the AS context relocation operation.

Aspect 24: The method of Aspect 23, wherein performing the AS context relocation operation comprises providing, to at least one neighboring network node, a UE context preparation request message comprising the UE AS context and an inactive radio network temporary identifier, the at least one neighboring network node including the second network node.

Aspect 25: The method of Aspect 24, wherein performing the AS context relocation operation further comprises obtaining, from the second network node, a UE context preparation request acknowledgment message.

Aspect 26: The method of Aspect 25, wherein the UE context preparation request message comprises a configuration list request, wherein the UE context preparation request acknowledgment message comprises a cell identity associated with the second network node, and wherein a radio resource control (RRC) release message includes a cell identity list comprising the cell identity associated with the second network node and a configuration list comprising a second UE configuration associated with the second network node.

Aspect 27: The method of Aspect 26, further comprising obtaining at least one additional cell identity associated with at least one additional network node and at least one additional configuration associated with the at least one additional network node, wherein the cell identity list comprises the at least one additional cell identity and the configuration list comprises the at least one additional configuration.

Aspect 28: The method of either of Aspects 26 or 27, wherein at least one of the cell identity list or a radio access network (RAN) notification area (RNA) list, included in the RRC release message, comprises RNA information.

Aspect 29: The method of any of Aspects 1-28, further comprising maintaining, subsequent to performing the AS context relocation operation, a first user plane interface, associated with the UE, between a core network and the first network node.

Aspect 30: The method of Aspect 29, further comprising: providing, to the core network, a path establishment request message for establishing a second user plane interface, associated with the UE, between the core network and the second network node; and obtaining, from the core network, a path establishment request acknowledgment message associated with the second user plane interface.

Aspect 31: The method of Aspect 30, further comprising receiving, from the core network, a UE context release message.

Aspect 32: The method of either of Aspects 30 or 31, further comprising: starting a context release timer based on receiving the path establishment request acknowledgment; and releasing a UE AS context associated with the UE based on an expiry of the context release timer.

Aspect 33: The method of any of Aspects 30-32, obtaining, from the core network, a downlink user plane packet comprising a sequence number.

Aspect 34: The method of Aspect 33, wherein the downlink user plane packet includes a header associated with a dedicated protocol, the header indicating the sequence number.

Aspect 35: The method of Aspect 34, further comprising receiving, from the core network, an indication of the sequence number.

Aspect 36: The method of Aspect 35, wherein receiving the indication comprises receiving a user plane packet comprising a user plane protocol header that includes the indication.

Aspect 37: The method of Aspect 34, further comprising: assigning the sequence number; and providing a packet to the core network, the packet comprising a header that indicates the sequence number.

Aspect 38: The method of Aspect 37, wherein the header comprises a service data adaptation protocol header.

Aspect 39: The method of Aspect 37, wherein the header comprises a packet data convergence protocol header.

Aspect 40: The method of any of Aspects 33-39, further comprising performing, in association with a radio access network (RAN) paging restriction, a RAN paging operation based on receiving the downlink user plane packet.

Aspect 41: The method of any of Aspects 33-40, further comprising: obtaining a radio access network (RAN) triggering communication from at least one additional network node, the at least one additional network node comprising the second network node; and providing a plurality of UE paging messages based on obtaining the RAN triggering communication.

Aspect 42: The method of any of Aspects 1-41, further comprising providing, to the UE, a reselection prohibition indication of at least one cell reselection prohibition associated with reselection of a first cell included in a first radio access network (RAN) notification area (RNA) based on the UE being camped on a first cell included in a second RNA.

Aspect 43: The method of Aspect 42, wherein the reselection prohibition indication is indicative of the first cell and a second cell.

Aspect 44: The method of Aspect 43, wherein the configuration information indicates that at least one of the first cell or the second cell comprises at least one of a terrestrial network cell or a non-terrestrial network cell.

Aspect 45: The method of either of Aspects 43 or 44, wherein providing the reselection prohibition indication comprises providing at least one of RNA information including the reselection prohibition indication, a cell identity list including the reselection prohibition indication, a random access code including the reselection prohibition indication, or a bitmap including the reselection prohibition indication.

Aspect 46: The method of any of Aspects 42-45, wherein the cell reselection prohibition comprises a soft prohibition.

Aspect 47: The method of any of Aspects 42-46, wherein the cell reselection prohibition comprises a hard prohibition.

Aspect 48: The method of any of Aspects 1-47, further comprising providing, to the UE, configuration information indicative of a per-cell radio access network (RAN) notification area (RNA) timer, a per-cell-type RNA timer, or a per-orbit-type RNA timer.

Aspect 49: A method of wireless communication performed by an apparatus at a second network node, comprising: performing, associated with a first network node and based on a determination to switch a connected user equipment (UE) to an inactive state, at least one of an access stratum (AS) context relocation operation or a path switch operation associated with the second network node; and communicating with the UE based on the at least one of the AS context relocation operation or the path switch operation.

Aspect 50: The method of Aspect 49, wherein at least one of the first network node or the second network node comprises a terrestrial network node.

Aspect 51: The method of either of claims 49 or 50, wherein at least one of the first network node or the second network node comprises a non-terrestrial network node.

Aspect 52: The method of any of Aspects 49-51, wherein performing the AS context relocation operation comprises: obtaining, from the first network node, a UE context relocation request message; and providing, to the first network node, a UE context relocation request acknowledgement message.

Aspect 53: The method of Aspect 52, wherein the UE context relocation request message comprises at least one of an indication of a UE capability, an inactive radio network temporary identifier (RNTI) (I-RNTI) associated with the first network node, a second UE configuration, or a security parameter.

Aspect 54: The method of Aspect 53, wherein the security parameter comprises at least one of a security key, a physical cell identifier, a cell-RNTI (C-RNTI) associated with the first network node, or a downlink absolute radio frequency channel number associated with the first network node.

Aspect 55: The method of any of Aspects 52-54, wherein the UE context relocation request acknowledgement message comprises a cell-RNTI (C-RNTI) associated with the second network node or a second UE configuration.

Aspect 56: The method of any of Aspects 52-55, wherein the UE context relocation request message comprises a configuration list request, and wherein the UE context relocation request acknowledgment message comprises a cell identity associated with the second network node.

Aspect 57: The method of any of Aspects 49-56, wherein performing the AS context relocation operation comprises obtaining a UE relocation complete message from the first network node.

Aspect 58: The method of Aspect 57, wherein obtaining the UE relocation complete message comprises obtaining the UE relocation complete message based on a complete message condition being satisfied.

Aspect 59: The method of Aspect 58, wherein the UE relocation complete message condition is satisfied based on receiving, from the UE, a layer 2 acknowledgment communication.

Aspect 60: The method of either of Aspects 58 or 59, wherein the UE relocation complete message condition is satisfied based on an expiry of a timer that has a start time associated with providing a radio resource control release message.

Aspect 61: The method of any of Aspects 57-60, wherein the UE relocation complete message indicates a UE identifier associated with the UE.

Aspect 62: The method of any of Aspects 49-61, wherein the second network node comprises a target network node for the AS context relocation operation and the path switch operation based on a target selection parameter.

Aspect 63: The method of Aspect 62, wherein the target selection parameter is associated with at least one of a capability of the UE, a location of the UE, a connection history of the UE, a velocity of the UE, a type of the UE, a measurement report obtained from the UE, or a network load associated with the target network node.

Aspect 64: The method of any of Aspects 49-63, wherein performing the AS context relocation operation comprises performing the AS context relocation operation during an inactive state of the UE.

Aspect 65: The method of any of Aspects 49-64, further comprising maintaining a UE AS context associated with the UE subsequent to performing the AS context relocation operation.

Aspect 66: The method of Aspect 65, wherein performing the AS context relocation operation comprises obtaining, from the first network node, a UE context preparation request message comprising the UE AS context and an inactive radio network temporary identifier.

Aspect 67: The method of Aspect 66, wherein performing the AS context relocation operation further comprises providing, to the first network node, a UE context preparation request acknowledgment message.

Aspect 68: The method of Aspect 67, wherein the UE context preparation request message comprises a configuration list request, and wherein the UE context preparation request acknowledgment message comprises a cell identity associated with the second network node.

Aspect 69: The method of any of Aspects 49-68, further comprising maintaining, subsequent to performing the AS context relocation operation, a second user plane interface, associated with the UE, between a core network and the second network node.

Aspect 70: The method of Aspect 69, further comprising: performing a radio resource control (RRC) resume operation in association with the first network node to release a UE AS context associated with the UE; providing, to the first network node and based on completion of the RRC resume operation, a UE context release message; and providing, to the core network and based on providing the UE context release message, a path removal request message for removing a second user plane interface, associated with the UE, between the core network and the second network node.

Aspect 71: The method of either of claims 69 or 70, obtaining, from the core network, a downlink user plane packet comprising a sequence number.

Aspect 72: The method of Aspect 71, wherein the downlink user plane packet includes a header associated with a dedicated protocol, the header indicating the sequence number.

Aspect 73: The method of Aspect 72, further comprising receiving, from the core network, an indication of the sequence number.

Aspect 74: The method of Aspect 73, wherein receiving the indication comprises receiving a user plane packet comprising a user plane protocol header that includes the indication.

Aspect 75: The method of Aspect 74, further comprising: assigning the sequence number; and providing a packet to the core network, the packet comprising a header that indicates the sequence number.

Aspect 76: The method of Aspect 75, wherein the header comprises a service data adaptation protocol header.

Aspect 77: The method of Aspect 75, wherein the header comprises a packet data convergence protocol header.

Aspect 78: The method of any of Aspects 71-77, further comprising performing, in association with a radio access network (RAN) paging restriction, a RAN paging operation based on receiving the downlink user plane packet.

Aspect 79: The method of any of Aspects 71-78, further comprising providing a radio access network (RAN) triggering communication to the first network node.

Aspect 80: A method of wireless communication performed by an apparatus at a user equipment (UE), comprising: communicating with a first network node during an active state of the UE in accordance with a first UE configuration; and performing, associated with a second network node and based on an access stratum (AS) context relocation operation and a path switch operation associated with a second network node, a UE resume operation to connect to the second network node.

Aspect 81: The method of Aspect 80, wherein at least one of the first network node or the second network node comprises a terrestrial network node.

Aspect 82: The method of either of claims 80 or 81, wherein at least one of the first network node or the second network node comprises a non-terrestrial network node.

Aspect 83: The method of any of Aspects 80-82, further comprising obtaining, from the first network node, a radio resource control (RRC) release message.

Aspect 84: The method of Aspect 83, wherein the RRC release message is multiplexed with an RRC reconfiguration message in at least one of an RRC layer, a packet data convergence protocol (PDCP) layer, a radio link control (RLC) layer, a medium access control (MAC) layer, or a physical layer.

Aspect 85: The method of either of claims 83 or 84, wherein the RRC release message includes a cell identity list comprising a cell identity associated with the second network node and a configuration list comprising a second UE configuration associated with the second network node.

Aspect 86: The method of Aspect 85, wherein the cell identity list comprises at least one additional cell identity associated with at least one additional network node and the configuration list comprises at least one additional configuration associated with the at least one additional network node.

Aspect 87: The method of either of Aspects 85 or 86, wherein at least one of the cell identity list or a radio access network (RAN) notification area (RNA) list, included in the RRC release message, comprises RNA information.

Aspect 88: The method of Aspect 80, further comprising obtaining, from the first network node, a downlink user plane packet comprising a sequence number.

Aspect 89: The method of Aspect 88, wherein the downlink user plane packet includes a header associated with a dedicated protocol, the header indicating the sequence number.

Aspect 90: The method of any of Aspects 80-89, further comprising: obtaining, from the first network node, a first paging message including a cause value associated with a UE context relocation operation; obtaining, from the second network node, a second paging message associated with the UE context relocation operation; and providing a radio resource control (RRC) resume request message associated with the UE context relocation operation.

Aspect 91: The method of Aspect 90, wherein providing the RRC resume request message comprises providing the RRC resume request message to the first network node.

Aspect 92: The method of either of claims 90 or 91, wherein providing the RRC resume request message comprises providing the RRC resume request message to the second network node.

Aspect 93: The method of any of Aspects 80-92, further comprising obtaining a reselection prohibition indication of at least one cell reselection prohibition associated with reselection of a first cell included in a first radio access network (RAN) notification area (RNA) based on the UE being camped on a first cell included in a second RNA.

Aspect 94: The method of Aspect 93, wherein the reselection prohibition indication is indicative of the first cell and the second cell.

Aspect 95: The method of Aspect 94, further comprising receiving configuration information that indicates that at least one of the first cell or the second cell comprises at least one of a terrestrial network cell or a non-terrestrial network cell.

Aspect 96: The method of any of Aspects 93-95, wherein obtaining the reselection prohibition indication comprises obtaining at least one of RNA information including the reselection prohibition indication, a cell identity list including the reselection prohibition indication, a random access code including the reselection prohibition indication, or a bitmap including the reselection prohibition indication.

Aspect 97: The method of any of Aspects 93-96, wherein the cell reselection prohibition comprises a soft prohibition.

Aspect 98: The method of any of Aspects 93-97, wherein the cell reselection prohibition comprises a hard prohibition.

Aspect 99: The method of any of Aspects 80-98, further comprising obtaining configuration information indicative of a per-cell radio access network (RAN) notification area (RNA) timer, a per-cell-type RNA timer, or a per-orbit-type RNA timer.

Aspect 100: A method of wireless communication performed by an apparatus at a core network, comprising: obtaining, from a first network node and associated with a user equipment (UE), a path switch request message associated with a path switch operation; and performing, based on the path switch request message, the path switch operation in association with a second network node.

Aspect 101: The method of Aspect 100, wherein at least one of the first network node or the second network node comprises a terrestrial network node.

Aspect 102: The method of either of claims 100 or 101, wherein at least one of the first network node or the second network node comprises a non-terrestrial network node.

Aspect 103: The method of any of Aspects 100-102, further comprising providing, to the first network node, a path switch request acknowledgment message.

Aspect 104: The method of any of Aspects 100-103, wherein obtaining the path switch request message comprises obtaining the path switch request message based on a completion of an access stratum (AS) context relocation operation associated with the UE.

Aspect 105: The method of any of Aspects 100-104, wherein the path switch request message indicates at least one of a network node identifier associated with the second network node, a tunnel endpoint identifier, or a UE context relocation cause.

Aspect 106: The method of any of Aspects 100-104, further comprising: establishing, in association with the path switch operation, a second user plane interface, associated with the UE, between the core network and the second network node; and maintaining, subsequent to completion of an access stratum (AS) context relocation operation associated with the UE, a first user plane interface, associated with the UE, between the core network and the first network node.

Aspect 107: The method of Aspect 106, further comprising: obtaining, from the first network node, a path establishment request message for establishing the second user plane interface; and providing, to the first network node, a path establishment request acknowledgment message associated with the second user plane interface.

Aspect 108: The method of either of claims 106 or 107, further comprising: obtaining, from the second network node, a path removal request message for removing the second user plane interface; and providing, to the first network node and based on obtaining the path removal request message, a UE context release message.

Aspect 109: The method of any of Aspects 100-108, further comprising providing, to the first network node, a UE context release message.

Aspect 110: The method of any of Aspects 100-109, providing, to the first network node, a downlink user plane packet comprising a sequence number.

Aspect 111: The method of Aspect 110, wherein the downlink user plane packet includes a header associated with a dedicated protocol, the header indicating the sequence number.

Aspect 112: The method of either of claims 110 or 111, further comprising providing, to the first network node, an indication of the sequence number.

Aspect 113: The method of Aspect 112, wherein providing the indication comprises providing a user plane packet comprising a user plane protocol header that includes the indication.

Aspect 114: The method of any of Aspects 110-113, further comprising obtaining, from the first network node, a packet comprising a header that indicates the sequence number.

Aspect 115: The method of Aspect 114, wherein the header comprises a service data adaptation protocol header.

Aspect 116: The method of any of Aspects 114-115, wherein the header comprises a packet data convergence protocol header.

Aspect 117: A method of wireless communication performed by an apparatus at a first network node, comprising: communicating with a user equipment (UE) during an active state of the UE in accordance with a first UE configuration, wherein the first network node comprises a first non-terrestrial network (NTN) network node; and performing, associated with a second NTN network node and based on a determination that the first NTN is moving out of a radio access network (RAN) notification area (RNA), an access stratum (AS) context relocation operation associated with the second NTN network node.

Aspect 118: The method of Aspect 117, wherein the second NTN network node is within the RNA.

Aspect 119: The method of either of claims 117 or 118, wherein the second NTN network node comprises an anchor node configured to store a UE AS context associated with the UE for connection, by the UE, to a third NTN network node.

Aspect 120: The method of Aspect 119, wherein the anchor node comprises an NTN gateway node.

Aspect 121: The method of either of Aspects 119 or 120, wherein the anchor node comprises a geostationary satellite.

Aspect 122: The method of any of Aspects 119-121, wherein the anchor node implements a full wireless communication protocol stack.

Aspect 123: The method of any of Aspects 119-122, wherein the anchor node implements a portion of a wireless communication protocol stack.

Aspect 124: The method of Aspect 123, wherein the portion of the wireless communication protocol stack includes only a radio resource control layer and a packet data convergence protocol layer.

Aspect 125: The method of any of Aspects 119-124, wherein the anchor node is associated with a RAN node address index.

Aspect 126: The method of Aspect 125, wherein an inactive radio network temporary identifier associated with the UE comprises the RAN node address index and at least one additional RAN node address index associated with at least one additional network node.

Aspect 127: The method of any of Aspects 117-126, further comprising maintaining a UE AS context associated with the UE while the first network node is outside of the RNA.

Aspect 128: The method of Aspect 127, wherein performing the AS context relocation operation comprises forwarding the UE AS context to the second NTN network node via an inter-satellite link.

Aspect 129: A method of wireless communication performed by an apparatus at a second network node, comprising: performing, associated with a first non-terrestrial network (NTN) network node and based on a determination that the first NTN is moving out of a radio access network (RAN) notification area (RNA), an access stratum (AS) context relocation operation associated with the second network node, the second network node comprising a second NTN network node; and communicating, based on the AS context relocation operation, with at least one of a user equipment (UE) or a third NTN network node.

Aspect 130: The method of Aspect 129, wherein the second NTN network node is within the RNA.

Aspect 131: The method of either of claims 129 or 130, wherein the second NTN network node comprises an anchor node configured to store a UE AS context associated with the UE for connection, by the UE, to the third NTN network node.

Aspect 132: The method of Aspect 131, wherein the anchor node comprises an NTN gateway node.

Aspect 133: The method of Aspect 131, wherein the anchor node comprises a geostationary satellite.

Aspect 134: The method of any of Aspects 131-133, wherein the anchor node implements a full wireless communication protocol stack.

Aspect 135: The method of any of Aspects 131-133, wherein the anchor node implements a portion of a wireless communication protocol stack.

Aspect 136: The method of Aspect 135, wherein the portion of the wireless communication protocol stack includes only a radio resource control (RRC) layer and a packet data convergence protocol (PDCP)layer, or only an RRC layer, a PDCP layer, and a service data adaptation protocol (SDAP) layer.

Aspect 137: The method of any of Aspects 131-136, wherein the anchor node is associated with a RAN node address index.

Aspect 138: The method of Aspect 137, wherein an inactive radio network temporary identifier associated with the UE comprises the RAN node address index and at least one additional RAN node address index associated with at least one additional network node.

Aspect 139: The method of any of Aspects 129-138, wherein a UE AS context associated with the UE is maintained on the first NTN network node while the first NTN network node is outside of the RNA.

Aspect 140: The method of Aspect 139, wherein performing the AS context relocation operation comprises obtaining the UE AS context from the first NTN network node via an inter-satellite link.

Aspect 141: An apparatus for wireless communication at a device, comprising a processor; memory coupled with the processor; and instructions stored in the memory and executable by the processor to cause the apparatus to perform the method of one or more of Aspects 1-48.

Aspect 142: A device for wireless communication, comprising a memory and one or more processors coupled to the memory, the one or more processors configured to perform the method of one or more of Aspects 1-48.

Aspect 143: An apparatus for wireless communication, comprising at least one means for performing the method of one or more of Aspects 1-48.

Aspect 144: A non-transitory computer-readable medium storing code for wireless communication, the code comprising instructions executable by a processor to perform the method of one or more of Aspects 1-48.

Aspect 145: A non-transitory computer-readable medium storing a set of instructions for wireless communication, the set of instructions comprising one or more instructions that, when executed by one or more processors of a device, cause the device to perform the method of one or more of Aspects 1-48.

Aspect 146: An apparatus for wireless communication at a device, comprising a processor; memory coupled with the processor; and instructions stored in the memory and executable by the processor to cause the apparatus to perform the method of one or more of Aspects 49-79.

Aspect 147: A device for wireless communication, comprising a memory and one or more processors coupled to the memory, the one or more processors configured to perform the method of one or more of Aspects 49-79.

Aspect 148: An apparatus for wireless communication, comprising at least one means for performing the method of one or more of Aspects 49-79.

Aspect 149: A non-transitory computer-readable medium storing code for wireless communication, the code comprising instructions executable by a processor to perform the method of one or more of Aspects 49-79.

Aspect 150: A non-transitory computer-readable medium storing a set of instructions for wireless communication, the set of instructions comprising one or more instructions that, when executed by one or more processors of a device, cause the device to perform the method of one or more of Aspects 49-79.

Aspect 151: An apparatus for wireless communication at a device, comprising a processor; memory coupled with the processor; and instructions stored in the memory and executable by the processor to cause the apparatus to perform the method of one or more of Aspects 80-99.

Aspect 152: A device for wireless communication, comprising a memory and one or more processors coupled to the memory, the one or more processors configured to perform the method of one or more of Aspects 80-99.

Aspect 153: An apparatus for wireless communication, comprising at least one means for performing the method of one or more of Aspects 80-99.

Aspect 154: A non-transitory computer-readable medium storing code for wireless communication, the code comprising instructions executable by a processor to perform the method of one or more of Aspects 80-99.

Aspect 155: A non-transitory computer-readable medium storing a set of instructions for wireless communication, the set of instructions comprising one or more instructions that, when executed by one or more processors of a device, cause the device to perform the method of one or more of Aspects 80-99.

Aspect 156: An apparatus for wireless communication at a device, comprising a processor; memory coupled with the processor; and instructions stored in the memory and executable by the processor to cause the apparatus to perform the method of one or more of Aspects 100-116.

Aspect 157: A device for wireless communication, comprising a memory and one or more processors coupled to the memory, the one or more processors configured to perform the method of one or more of Aspects 100-116.

Aspect 158: An apparatus for wireless communication, comprising at least one means for performing the method of one or more of Aspects 100-116.

Aspect 159: A non-transitory computer-readable medium storing code for wireless communication, the code comprising instructions executable by a processor to perform the method of one or more of Aspects 100-116.

Aspect 160: A non-transitory computer-readable medium storing a set of instructions for wireless communication, the set of instructions comprising one or more instructions that, when executed by one or more processors of a device, cause the device to perform the method of one or more of Aspects 100-116.

Aspect 161: An apparatus for wireless communication at a device, comprising a processor; memory coupled with the processor; and instructions stored in the memory and executable by the processor to cause the apparatus to perform the method of one or more of Aspects 117-128.

Aspect 162: A device for wireless communication, comprising a memory and one or more processors coupled to the memory, the one or more processors configured to perform the method of one or more of Aspects 117-128.

Aspect 163: An apparatus for wireless communication, comprising at least one means for performing the method of one or more of Aspects 117-128.

Aspect 164: A non-transitory computer-readable medium storing code for wireless communication, the code comprising instructions executable by a processor to perform the method of one or more of Aspects 117-128.

Aspect 165: A non-transitory computer-readable medium storing a set of instructions for wireless communication, the set of instructions comprising one or more instructions that, when executed by one or more processors of a device, cause the device to perform the method of one or more of Aspects 117-128.

Aspect 166: An apparatus for wireless communication at a device, comprising a processor; memory coupled with the processor; and instructions stored in the memory and executable by the processor to cause the apparatus to perform the method of one or more of Aspects 129-140.

Aspect 167: A device for wireless communication, comprising a memory and one or more processors coupled to the memory, the one or more processors configured to perform the method of one or more of Aspects 129-140.

Aspect 168: An apparatus for wireless communication, comprising at least one means for performing the method of one or more of Aspects 129-140.

Aspect 169: A non-transitory computer-readable medium storing code for wireless communication, the code comprising instructions executable by a processor to perform the method of one or more of Aspects 129-140.

Aspect 170: A non-transitory computer-readable medium storing a set of instructions for wireless communication, the set of instructions comprising one or more instructions that, when executed by one or more processors of a device, cause the device to perform the method of one or more of Aspects 129-140.

Aspect 171: An apparatus for wireless communication at a first network node, comprising: a processing system that includes processor circuitry and memory circuitry that stores code and is coupled with the processor circuitry, the processing system configured to cause the network node to perform the method of one or more of Aspects 1-48.

Aspect 172: An apparatus for wireless communication at a second network node, comprising: a processing system that includes processor circuitry and memory circuitry that stores code and is coupled with the processor circuitry, the processing system configured to cause the second network node to perform the method of one or more of Aspects 49-79.

Aspect 173: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 80-99.

Aspect 174: An apparatus for wireless communication at a core network, comprising: a processing system that includes processor circuitry and memory circuitry that stores code and is coupled with the processor circuitry, the processing system configured to cause the core network to perform the method of one or more of Aspects 100-116.

Aspect 175: An apparatus for wireless communication at a first network node, comprising: a processing system that includes processor circuitry and memory circuitry that stores code and is coupled with the processor circuitry, the processing system configured to cause the first network node to perform the method of one or more of Aspects 117-128.

Aspect 176: An apparatus for wireless communication at a second network node, comprising: a processing system that includes processor circuitry and memory circuitry that stores code and is coupled with the processor circuitry, the processing system configured to cause the second network node to perform the method of one or more of Aspects 129-140.

Aspect 177: An apparatus for wireless communication at a device, comprising one or more memories; and one or more processors coupled with the one or more memories and individually or collectively configured to cause the apparatus to perform the method of one or more of Aspects 1-48.

Aspect 178: An apparatus for wireless communication at a device, comprising one or more memories; and one or more processors coupled with the one or more memories and individually or collectively configured to cause the apparatus to perform the method of one or more of Aspects 49-79.

Aspect 179: An apparatus for wireless communication at a device, comprising one or more memories; and one or more processors coupled with the one or more memories and individually or collectively configured to cause the apparatus to perform the method of one or more of Aspects 80-99.

Aspect 180: An apparatus for wireless communication at a device, comprising one or more memories; and one or more processors coupled with the one or more memories and individually or collectively configured to cause the apparatus to perform the method of one or more of Aspects 100-116.

Aspect 181: An apparatus for wireless communication at a device, comprising one or more memories; and one or more processors coupled with the one or more memories and individually or collectively configured to cause the apparatus to perform the method of one or more of Aspects 117-128.

Aspect 182: An apparatus for wireless communication at a device, comprising one or more memories; and one or more processors coupled with the one or more memories and individually or collectively configured to cause the apparatus to perform the method of one or more of Aspects 129-140.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first network node, comprising:
one or more memories; and
one or more processors coupled with the one or more memories and configured to cause the first network node to:
communicate with a user equipment (UE) during an active state of the UE in accordance with a first UE configuration; and
perform, associated with a second network node and based on a determination to switch the UE to an inactive state, at least one of an access stratum (AS) context relocation operation or a path switch operation associated with the second network node.

2. The apparatus of claim 1, wherein at least one of the first network node or the second network node comprises a terrestrial network node.

3. The apparatus of claim 1, wherein at least one of the first network node or the second network node comprises a non-terrestrial network node.

4. The apparatus of claim 1, wherein the one or more processors, to cause the first network node to perform the AS context relocation operation, are configured to cause the first network node to:
provide, to the second network node, a UE context relocation request message;
obtain, from the second network node, a UE context relocation request acknowledgement message; and
provide, to the UE and based on obtaining the UE context relocation request acknowledgement, a radio resource control (RRC) release message.

5. The apparatus of claim 4, wherein the UE context relocation request message comprises at least one of an indication of a UE capability, an inactive radio network temporary identifier (RNTI) (I-RNTI) associated with the first network node, a second UE configuration, or a security parameter.

6. The apparatus of claim 5, wherein the security parameter comprises at least one of a security key, a physical cell identifier, a cell-RNTI (C-RNTI) associated with the first network node, or a downlink absolute radio frequency channel number associated with the first network node.

7. The apparatus of claim 4, wherein the UE context relocation request acknowledgement message comprises a cell-RNTI (C-RNTI) associated with the second network node or a second UE configuration.

8. The apparatus of claim 7, wherein the one or more processors, to cause the first network node to provide the RRC release message, are configured to cause the first network node to multiplex the RRC release message with an RRC reconfiguration message in at least one of an RRC layer, a service data adaptation protocol (SDAP) layer, a packet data convergence protocol (PDCP) layer, a radio link control (RLC) layer, a medium access control (MAC) layer, or a physical layer.

9. The apparatus of claim 4, wherein the UE context relocation request message comprises a configuration list request, wherein the UE context relocation request acknowledgment message comprises a cell identity associated with the second network node, and wherein the RRC release message includes a cell identity list comprising the cell identity associated with the second network node and a configuration list comprising a second UE configuration associated with the second network node.

10. The apparatus of claim 1, wherein the one or more processors, to cause the first network node to perform the AS context relocation operation, are configured to cause the first network node to provide a UE relocation complete message to the second network node.

11. The apparatus of claim 1, wherein the one or more processors, to cause the first network node to perform the path switch operation, are configured to cause the first network node to:
provide, to a core network, a path switch request message; and
obtain, from the core network, a path switch request acknowledgment message.

12. The apparatus of claim 11, wherein the one or more processors, to cause the first network node to provide the path switch request message, are configured to cause the first network node to provide the path switch request message based on a completion of the AS context relocation operation.

13. The apparatus of claim 11, wherein the path switch request message indicates at least one of a network node identifier associated with the second network node, a tunnel endpoint identifier, or a UE context relocation cause.

14. The apparatus of claim 1, wherein the one or more processors are further configured to cause the first network node to select the second network node based on a target selection parameter, wherein the target selection parameter is associated with at least one of a capability of the UE, a location of the UE, a connection history of the UE, a velocity of the UE, a type of the UE, a measurement report obtained from the UE, or a network load associated with the second network node.

15. The apparatus of claim 1, wherein the one or more processors, to cause the first network node to perform the AS context relocation operation, are configured to cause the first network node to perform the AS context relocation operation during an inactive state of the UE.

16. The apparatus of claim 1, wherein the one or more processors are further configured to cause the first network node to maintain a UE AS context associated with the UE subsequent to performing the AS context relocation operation.

17. The apparatus of claim 1, wherein the one or more processors are further configured to cause the first network node to maintain, subsequent to performing the AS context relocation operation, a first user plane interface, associated with the UE, between a core network and the first network node.

18. The apparatus of claim 1, wherein the one or more processors are further configured to cause the first network node to provide, to the UE, a reselection prohibition indication of at least one cell reselection prohibition associated with reselection of a first cell included in a first radio access network (RAN) notification area (RNA) based on the UE being camped on a first cell included in a second RNA.

19. The apparatus of claim 1, wherein the one or more processors are further configured to cause the first network node to provide, to the UE, configuration information indicative of a per-cell radio access network (RAN) notification area (RNA) timer, a per-cell-type RNA timer, or a per-orbit-type RNA timer.

20. An apparatus for wireless communication at a second network node, comprising:
one or more memories; and
one or more processors coupled with the one or more memories and configured to cause the second network node to:
perform, associated with a first network node and based on a determination to switch a connected user equipment (UE) to an inactive state, at least one of an access stratum (AS) context relocation operation or a path switch operation associated with the second network node; and
communicate with the UE based on the at least one of the AS context relocation operation or the path switch operation.

21. The apparatus of claim 20, wherein at least one of the first network node or the second network node comprises a non-terrestrial network node.

22. An apparatus for wireless communication at a user equipment (UE), comprising:
one or more memories; and
one or more processors coupled with the one or more memories and configured to cause the UE to:
communicate with a first network node during an active state of the UE in accordance with a first UE configuration; and
perform, associated with a second network node and based on an access stratum (AS) context relocation operation and a path switch operation associated with a second network node, a UE resume operation to connect to the second network node.

23. The apparatus of claim 22, wherein at least one of the first network node or the second network node comprises a non-terrestrial network node.

24. An apparatus for wireless communication at a core network, comprising:
one or more memories; and
one or more processors coupled with the one or more memories and configured to cause the core network to:
obtain, from a first network node and associated with a user equipment (UE), a path switch request message associated with a path switch operation; and
perform, based on the path switch request message, the path switch operation in association with a second network node.

25. The apparatus of claim 24, wherein at least one of the first network node or the second network node comprises a non-terrestrial network node.

26. An apparatus for wireless communication at a first network node, comprising:
one or more memories; and
one or more processors coupled with the one or more memories and configured to cause the first network node to:
communicate with a user equipment (UE) during an active state of the UE in accordance with a first UE configuration, wherein the first network node comprises a first non-terrestrial network (NTN) network node; and
perform, associated with a second NTN network node and based on a determination that the first NTN is moving out of a radio access network (RAN) notification area (RNA), an access stratum (AS) context relocation operation associated with the second NTN network node.

27. The apparatus of claim 26, wherein the second NTN network node comprises an anchor node configured to store a UE AS context associated with the UE for connection, by the UE, to a third NTN network node.

28. The apparatus of claim 27, wherein the anchor node comprises an NTN gateway node or a geostationary satellite.

29. The apparatus of claim 27, wherein the anchor node implements a full wireless communication protocol stack or a portion of a wireless communication protocol stack.

30. The apparatus of claim 29, wherein the portion of the wireless communication protocol stack includes only a radio resource control (RRC) layer and a packet data convergence protocol (PDCP)layer, or only an RRC layer, a PDCP layer, and a service data adaptation protocol (SDAP) layer.

31. The apparatus of claim 27, wherein the anchor node is associated with a RAN node address index.

32. The apparatus of claim 26, wherein the one or more processors are further configured to cause the first network node to maintain a UE AS context associated with the UE while the first network node is outside of the RNA.

33. The apparatus of claim 26, wherein the one or more processors, to cause the first network node to perform the AS context relocation operation, are configured to cause the first network node to forward the UE AS context to the second NTN network node via an inter-satellite link.

34. An apparatus for wireless communication at a second network node, comprising:
one or more memories; and
one or more processors coupled with the one or more memories and configured to cause the second network node to:
perform, associated with a first non-terrestrial network (NTN) network node and based on a determination that the first NTN is moving out of a radio access network (RAN) notification area (RNA), an access stratum (AS) context relocation operation associated with the second network node, the second network node comprising a second NTN network node; and
communicate, based on the AS context relocation operation, with at least one of a user equipment (UE) or a third NTN network node.

35. The apparatus of claim 34, wherein the second NTN network node comprises an anchor node configured to store a UE AS context associated with the UE for connection, by the UE, to a third NTN network node.
